(19) United States
(12) Patent Application Publication
(10) Pub. No.: US 2026/0197910 A1
(43) Pub. Date: Jul. 9, 2026

(54) ELECTROMAGNETIC REACTOR

(71) Applicant: Dwight Eric Kinzer, Sedgwick, KS (US)

(72) Inventor: Dwight Eric Kinzer, Sedgwick, KS (US)

(21) Appl. No.: 19/017,390

(22) Filed: Jan. 10, 2025

Related U.S. Application Data
(63) Continuation-in-part of application No. 17/662,791, filed on May 10, 2022, now Pat. No. 12,550,233.

(51) Int. Cl. H05B 6/78; H05B 1/02; H05B 6/64; H05B 6/80; H05B 7/20

(52) U.S. Cl. CPC H05B 6/78; H05B 1/023; H05B 6/6473; H05B 6/6482; H05B 6/80; H05B 7/20

(57) ABSTRACT

An apparatus and method for uniformly exposing a bulk volume of particles—including free-flowing, semi-flowable, or non-flowing materials such as grains, powders, biomass, or sewage—to an electromagnetic (EM) energy field. The system ensures consistent energy distribution to all particles, irrespective of orientation or surface exposure. An electromagnetic applicator, either metallic or plasma-based, transmits EM energy into a mechanical system that cycles particles through transportation and/or fluidization zones. The reactor enables precise control of EM energy across frequencies from 30 Hz to 30 EHz to regulate both the magnitude and rate of temperature or chemical reactions. Auxiliary systems, including fluid addition, air/gas circulation, and deagglomeration, enhance the reactor's versatility by supporting processes such as heating, drying, or material modification. These integrated features allow the reactor to efficiently process diverse materials, achieving uniform energy application and consistent reaction outcomes.

### CROSS REFERENCE TO RELATED APPLICATIONS

This application is a continuation-in-part of U.S. patent application Ser. No. 17/662,791, filed May 10, 2022, which is a continuation-in-part of U.S. patent application Ser. No. 16/786,999, filed Feb. 10, 2020, now U.S. Pat. No. 11,369,937, which claims the benefit of U.S. Provisional Application Ser. No. 62/803,588, filed Feb. 10, 2019.

### FIELD OF THE INVENTION

This invention relates to the field of electromagnetic heating, particularly in the context of inducing heating, biological, and chemical reactions in various substances. The focus is on achieving uniform electromagnetic energy transfer to moving bulk volumes of flowable or semi-flowable particles as they cycle in and out of a state of near-weightlessness in the fluidized zone or traverse the transportation zone within an electromagnetic reactor. The electromagnetic reactor features a mechanical movement system comprising counter-rotating twin shafts with mixing vanes, designed to promote consistent particle movement for near-uniform electromagnetic energy exposure.

### BACKGROUND OF THE TECHNOLOGY

Heat generation in a material arises from molecular agitation. Based on the method of agitation, heating methods can be broadly categorized into thermal (conduction/convection) and electromagnetic. In thermal conduction heating, an external heat source applies thermal energy, which transfers by conduction through the material from high-temperature regions to low-temperature regions. An example is a kitchen oven, where heating coils serve as the source, and heat conducts through the material due to the temperature gradient between the source and the load. Conventional thermal heating's drawbacks include uneven heating across the load due to the thermal conduction gradient and slow thermal transfer rates for certain substances.

Convection heating, by contrast, relies on the movement of a heated fluid—typically air—over the material to facilitate heat transfer. This method is common in industrial drying systems, such as fluidized bed dryers, which require airflow velocities of 1 m/s to 4 m/s to suspend and uniformly heat particles. Despite its advantages in surface heating, convection heating is energy-intensive, with fan electricity demands often reaching 20 horsepower per ton per hour of material processed. It also faces challenges in achieving uniform heating throughout a bulk material volume due to its reliance on external airflow.

Microwave and radio-frequency dielectric technologies heat non-conductive materials from the inside outward. Dielectric heating methods were first employed in food processing as early as 1940. Although microwaves have been utilized in various industrial applications, most existing systems are designed to heat loads to moderate temperatures, typically below 100° C. This is despite dielectric heating's theoretical capability to rapidly heat certain substances, such as hydrocarbons, to several hundred degrees Celsius.

Due to the relatively short wavelengths of infrared and higher-frequency microwave radiation, the penetration depth within materials is correspondingly shallow. Achieving even heating with these methods is challenging, as it depends on factors such as the uniformity of the electromagnetic field, material homogeneity, and edge effects. Equally critical to uniform heating is the penetration depth or the energy attenuation within the material. In many cases, products targeted for heating by infrared or microwaves must be arranged in a thin layer, often only one particle deep, to prevent uneven heating. Additionally, all sides, edges, and surfaces of each particle should receive near-equal exposure to avoid the risk of some particles within a bulk volume receiving excessive or insufficient dielectric heating.

A primary drawback of electromagnetic heating is its efficiency dependency on the material's dielectric characteristics. Consequently, non-uniform heating due to varying dielectric properties within a bulk volume can lead to inefficient overheating of some portions to achieve minimum average heating. Specific disadvantages of known dielectric heating methods include the potential for thermal runaway or hot spots in a heterogeneous medium, as dielectric losses often strongly depend on temperature. Another disadvantage is the potential for dielectric breakdown (arcing) if the electric field strengths are too high across the sample. Generally, these techniques are limited by the relatively low thermal and electrical conductivity of the bulk volume of interest.

Controlled or uniform temperature heating of a bulk volume is desirable, but existing methods often fail to achieve this goal. Instead, they typically result in non-uniform temperature distributions, necessitating inefficient overheating of portions of the bulk volume. Extreme temperatures in localized areas may cause damage to the material being processed, such as carbonization, skinning, and arcing between conductors.

Although dielectric heating systems have been used in the past, there is still a need for enhanced apparatuses and process techniques that can rapidly, efficiently, and uniformly heat all particulates within a bulk volume, including specific biological agents or chemical compositions. Additionally, there is a significant demand for methods and apparatuses that can integrate other electromagnetic spectrum bandwidths and facilitate various industrial processes—such as adding gases, liquids, or solids; mixing; deagglomeration; and applying vacuum or positive pressure—while ensuring even application of electromagnetic energy.

### DISCUSSION OF PRIOR ART—TWIN-SHAFT FORBERG MIXER AND MICROWAVE HEATING IN AN INDUSTRIAL MIXER

A fundamental aspect of this invention is the incorporation of a specialized industrial mixer—a counter-rotating twin-shaft mixer originally designed by Halvor Forberg in Larvik, Norway. This mixer was developed for faster and more precise mixing and even dispersion of liquids onto a volume of particles. It has now been adapted to expose these particles to electromagnetic energy.

In 1973, the engineering firm Halvor Forberg AS in Larvik, Norway, was tasked with developing a mixer that would offer greater production capacity per hour, higher precision, and a lower cost per mixed cubic meter per hour compared to existing mixers. Upon researching existing literature on mixing technology, Halvor Forberg identified a surprising gap—there was no clear definition of “mixing” beyond generalized statements like “to put two or more ingredients together.” To address this, Mr. Forberg defined mixing as: “Mixing is the transportation of a single particle and positioning it as precisely as possible in relation to all other particles while avoiding or reducing segregation in already mixed material.”

With this definition, the design of a double-shaft system was deemed essential to achieve the desired mixing process. Initial tests with a straight double-shaft system revealed that the material was merely transported forwards and backwards within the system without the necessary overlaps between the paddles (mixing vanes). This issue was resolved by adjusting the shafts closer to one another, allowing the paddle system to overlap as illustrated in FIG. 1C. This modification ensured that each particle experienced a randomized movement.

In 1978, Mr. Forberg adjusted the speed of the paddles, resulting in the development of the well-known fluidized zone mixing system. By reducing the influence of gravity within the mixer, this design achieved total freedom of particle movement, fluidization, and minimized segregation.

The difference in mixing times and the thoroughness of mixing between a conventional single-shaft convective mixer and a counter-rotating twin-shaft fluidized mixer is significant. While the conventional single-shaft mixer can take anywhere from several minutes to several hours to achieve a homogeneous mix, the twin-shaft fluidized mixer often requires only 5 to 30 seconds to produce the same results.

FIGS. 1A-1C and 2A-2B (prior art) illustrate a convection-style twin-shaft fluidized mixer (20), comprising a support structure system (22) for supporting the housing system above the ground, a housing system (23) for containing a process chamber with a mixing system, a mechanical movement system (24) for moving a volume of free-flowing or semi-flowable particles in the process chamber (180), a power transmission system (25) to provide rotational movement to the mechanical movement system (24), and a bottom gate discharge system (27) to empty the contents in the process chamber (180). The cross-sectional view in FIG. 1C illustrates the entire mixing zone (180), the transportation zone (181), and the fluidized zone (182) within mixer (20).

The support structure system (22) is designed to provide stable structural support for the mixer. This system comprises ground or earth (120), support structures (121) positioned between the ground and the housing system (23), and additional support structures (122) between the ground and the power transmission system (25). These components ensure the mixer's stability and alignment during operation.

The housing system (23) comprises a bottom half (130) comprising two rounded semicylindrical sections (134) adjoined to form a W-shaped trough. Each semicylindrical section (134) is specifically designed to align with the path of the mixing paddle tips (148). The top half (131) has outer walls (133) that may be either vertical or rounded (not shown) upward from where they join to the bottom section (130). The top half (131) typically includes a top cover (not shown) with an inlet (125) for introducing material into the process chamber (180). Additionally, the housing system (23) includes an end plate (132) at each end of the connected bottom half (130) and top half (131) sections, enclosing the process chamber structurally. For clarity in illustrating internal components like the mechanical movement (mixing) system, a cover lid is not shown.

The purpose of the mechanical movement system (24) is to transform a non-uniform bulk volume of particles into a uniform mixture. To achieve this, the mechanical movement system (24) comprises two shafts (141), each fitted with support shafts (146) connected to mixing vanes (paddles) (147). These shafts (141) are mounted on bearings (153) and are connected to a power transmission system (25) via coupling (151). The mechanical movement system (24) employs a double-shaft configuration, with each shaft (141) centrally positioned within the semicylindrical sections of the housing system (23). The mixing paddles (147), typically arranged in sets of diametrically opposed pairs, are designed so that half of the paddles are rotated 90 degrees relative to the others. This arrangement creates an aligned transport zone (181) that facilitates material movement within the mixing zones (181, 182). The shafts (141) rotate in opposite directions, causing the paddles (147) to move downward along the outer walls of the housing (130) and, to a lesser extent, along the upper wall (131). As a result, the primary mixing action occurs in the area between the shafts known as the transportation zone (181) and between and above the two shafts (141), known as the fluidized zone (182).

The power transmission system (25) provides rotational movement to the mechanical movement system (24). System (25) includes a motor (150) connected to a speed reduction gearbox (152), which is further connected to coupling (151) to provide rotational movement to the shafts (141) and mixing paddles (147). In FIG. 1C, the cut view shows arrows (156, 157) indicating the rotation directions of the shafts (141) within the mechanical movement system (24), with the right shaft rotating clockwise (157) around its axis (155), and the left shaft rotating counterclockwise (156) around its axis (154). The power transmission system (25) must ensure synchronized counter-rotation (156, 157) of the shafts (141) to prevent overlapping paddles (147) from colliding.

The bottom gate discharge system (27) is designed to enable the controlled release of particles from the process chamber (180). This system includes a gate door (170), which, when opened, allows product to discharge through an opening (126) located at the base of the semicylindrical sections (134). Although not depicted, the discharge system typically includes an actuator responsible for opening and closing the gate doors (170). This actuator is generally powered by air or electricity and can be optionally activated by a computer system for precise control.

Operation of Prior Art Twin-Shaft Mixing System (20): Typically, the power transmission system (25) is activated to initiate the mixing movement of the mechanical movement system (24) before the bulk volume of particles enters (arrow 96) the process chamber (180). The inlet (125) allows the bulk volume of particles to fill the process chamber (180). Once the desired volume or weight of particles has been introduced into the process chamber (180), the power transmission system (25) continues to provide rotational movement (156, 157) to the mechanical movement system (24) until the desired mixing outcome is achieved. At this point, the discharge gate system (27) is opened to release (arrow 97) the mixed bulk volume of particles from the process chamber (180).

Further testing of the Forberg twin-shaft fluidized mixer in the 1980s revealed that by spraying a liquid into the fluidized zone (182), a particle could receive near-even coating of the liquid. In a single-shaft mixer, the addition of a liquid would be dispersed through the rubbing of the particles. In a counter-rotating twin-shaft fluidized mixer, the liquid is applied directly onto the particle while they are cycling in and out of a state of near-weightlessness in the fluidized zone. Isometric FIG. 2A and cut view FIG. 2B show a liquid addition system (32) comprising a fluid storage container (174), piping (175), pump (176), fluid control valves (177), and a fluid distribution manifold (178).

Mr. Halvor Forberg later recognized that mechanical fluidization in the twin-shaft mixer allowed all particles to be enveloped by hot air, effectively utilizing it as a drying medium to ensure efficient convection energy transfer. This innovation became known as the Forberg Dryer. The Forberg Dryer (21), as depicted in FIGS. 2A and 2B (prior art), includes a support structure system (22), housing system (23), mechanical movement system (24), power transmission system (25), bottom gate discharge system (27), air movement system (29), and optional systems such as a liquid addition system (32) and deagglomeration system (33).

The air movement system (29) of Dryer (21), as depicted in FIGS. 2A and 2B, facilitates closed-loop airflow through a thermal air heating system (30), which directs heated air into the fluidized zone (182). This air is then captured by an air hood and filtration system (31), where it is filtered, passed through a chilling system (28) to remove moisture, and subsequently returned to fan (185) of the air movement system (29). The air movement system (29) comprises a fan (185) that provides the airflow and static pressure necessary to circulate air through the entire system. This system includes an air duct (186) connecting the fan (185) to the air heating system (30), air ducting (193) passing through the heating system (30), and baffled ducting (190) that directs airflow down both sides of the mixer and into the fluidized zone (182) of the process chamber (180). An air hood (184) captures the air/gas from the process chamber (180) and directs it to the chilling system (28). The air then passes through air ducting (191) within the chilling system (28) before being routed back to the fan (185) via return air ducting (194).

The chilling system (28) of Dryer (21), as depicted in FIGS. 2A and 2B, consists of air ducting (191), cooling coils (196), a cooling system (195) with pipes (197) connected to the coils, a condensate collection pan (198), and a drain (199) to remove condensate water from the system.

The heating system (30) of Dryer (21), as depicted in FIGS. 2A and 2B comprises air ducting or housing (193), a heat generator (187), and pipes (189) to transfer heat energy to coils (188) for heating the airflow. The air filtration system (31) includes an air capture hood (184) and filtration bags or medium (192).

The Forberg Drying System (21), as depicted in FIGS. 2A and 2B, also featured an optional de-agglomeration system (33). This system includes a motor (171) that provides rotational (direction arrow 169) mechanical energy to a shaft (172), positioned directly above the fluidized zone, which is equipped with extended bars (173). These bars (173) impact particles within the fluidized zone, effectively breaking up agglomerates. The de-agglomeration system (33) not only aids in breaking apart clumps of material but also enhances the efficiency of thermal convection drying. When particles are struck by the spinning bars (173), they are propelled sideways, increasing their exposure time to the heated airflow, thereby improving drying effectiveness.

In 2019, Crescend Technologies LLC, based in Schaumburg, Illinois, was commissioned to design, develop, and deploy a 400-kW microwave heating system for large-scale biomass drying. It is believed that the system developed by Crescend Technologies was similar to U.S. Pat. No. 4,856,203 to Wennestrum (1989) and U.S. patent application Ser. No. 13/950,402 by Timothy C. Scheurs et al. The microwave biomass dryer is powered by eight (8) Crescend PTL-50 (50 kW) solid-state microwave generator/amplifiers covering the 902-928 MHz band. Four pairs of 50 kW generators were combined with waveguides to produce four 100 kW open-ended outputs directed into the top of a 200-cubic-foot single-shaft horizontal mixer similar to FIGS. 3A-3E.

Reported in a whitepaper by Crescend Technologies in 2019, titled “High-Quality Biomass Material Drying Using 400 kW of CW RF Power,” it is stated that in a little over two hours, 3,600 pounds of hemp ground to 10 mm with 75% moisture was dried to 1,000 pounds with 10% moisture. The whitepaper asserts that the temperature of the hemp during drying remained at about 120 degrees Fahrenheit throughout the drying cycle, which is well below the vaporization temperature of essential oils and terpenes, so virtually no loss occurred. The hemp retained its natural color.

FIGS. 3A through 3E (prior art) depict a system (37), which includes a single-shaft convection mixing system (39) with microwave systems (38), similar to those described in prior art publications. System (37) comprises a single-shaft mixing system (39), four dual 50 kW 902 MHz microwave systems (38), a housing system (34), an incoming gate system (35), a power transmission system (not shown), a discharge gate system (36), and an air movement system (90).

As shown in FIGS. 3A through 3C (prior art), the single-shaft convection mixing system (39) includes a shaft (104) with ribbon mixing vanes (113), mounted on bearings (153), rotating in the direction indicated by arrow (105) around the axis (110) of shaft (104). Arrow (96) indicates product entering the process chamber (179), and arrow (97) shows product discharging from it. The ribbon-style mixing vanes (113) are enclosed within a housing system (34), which comprises a curved bottom (102), two upward side panels (101), two end plates (100), and a cover (103). The housing system (34) is supported by a support system (26) with four legs (121). The incoming gate system (35) includes a slide gate (108) for regulating product flow into the mixing process chamber (179) and a transition (109) connecting gate (108) to the mixer cover (103). The discharge gate system (36) includes an actuator (127) to operate slide gate (108) for regulating product flow out of the mixing process chamber (179) and a transition (128) connecting the curved bottom (102) to gate (108). FIG. 3A depicts the system with the cover (103) in place, while FIGS. 3B and 3C show the system without the cover (103). FIG. 3B illustrates the mixing system (39) without product in the mixing process chamber (179), and FIG. 3C shows the vanes (113) protruding above the product (183) within the chamber.

FIGS. 3D and 3E (prior art) illustrate the diffraction and outward expansion of electromagnetic fields at the open end of waveguide (168). The radiation pattern (107) is directional, influenced by the waveguide's geometry and mode of operation (e.g., TE10 mode). Acting as a simple electromagnetic applicator, the waveguide's open end transforms the guided wave into a free-space wave with defined beamwidth and directivity. The microwave system (38) consists of a 50 kW, 902 MHz microwave generator (167) transmitting its signal through a coaxial cable (111) to a dipole (112) positioned within the open-ended waveguide (168). Inside the waveguide, electromagnetic waves are confined and guided by the waveguide walls, which support specific propagation modes determined by the waveguide dimensions and signal frequency. The dipole (112) emits a signal (106) with wavelength dimensions matched to the waveguide (168), guiding the signal. Upon exiting the open waveguide, such as with a 902 MHz signal, the energy transitions from a confined guided wave to a radiated wave in free space. This transition removes the confinement of the waveguide walls, causing the electromagnetic energy to spread into free space. The resulting directional radiation pattern (107) typically features a main lobe perpendicular to the waveguide's open face.

An open-ended waveguide (168) used to transmit microwaves into a moving mass within a mixer can result in significant reflected power. This is because an open-ended waveguide (168) is not a matched load; when the microwaves exit the waveguide, they encounter a mismatch with the surrounding environment or load (in this case, the moving mass of particles). This mismatch can cause a portion of the transmitted power to reflect back into the waveguide, leading to standing waves and potential inefficiencies in power transfer.

While the approach of the biomass dryer by Crescend Technologies, where they used eight 50 kW 902 MHz generators (167) and directed their signals down four waveguides (168), can still be effective—especially if the system is designed to handle high levels of reflected power—it is not the most efficient way to couple microwave energy into a material. The inefficiencies arise because not all the power is absorbed by the biomass; a significant portion is reflected back or lost in the process.

Furthermore, an open-ended waveguide used as an electromagnetic applicator does not exhibit significant gain in radiating an electric field. In contrast, a well-designed slotted waveguide EM applicator can achieve a gain of approximately 15 dBi. This gain results in a 5.62-fold increase in electric field intensity and a corresponding 31.62-fold increase in effective radiated power. If the material can be effectively coupled to the radiated electric field, this leads to a 31.62-fold increase in heating efficiency or reaction rates, due to the substantial boost in power delivered to the particles.

The air movement system (90) highlights why most conventional industrial mixers are not ideal for effectively exposing their contents to thermal convection airflow. As illustrated in FIG. 3A, the air system (90) comprises an inlet duct (91) connected to a fan (92), which generates airflow directed through duct (93) and beneath the cover lid (103) of the mixer and then exits process chamber (179) through duct (95). Arrows (94) in FIGS. 3A and 3C indicate the airflow direction. In FIG. 3C, it can be observed that the airflow passes only above the product in the mixing chamber, limiting exposure primarily to the surface of the mass, which is a small proportion relative to the total mass. Unlike the Forberg mixer, the airflow (arrows 94) does not envelop or surround individual particles within the bulk.

### BACKGROUND OF THE INVENTION

Given the scientific capacity to measure a substance's electrical permittivity, absorption peaks, and calculate Debye and resonance frequencies for maximum electromagnetic energy transfer—coupled with the rapidity of electron transitions lasting only 20 to 200 femtoseconds—a compelling inquiry arises: Why hasn't a reactor been devised to uniformly deliver the optimal electric and/or magnetic and/or light energy (EM energy) field to all particles within a volume, enabling precise control for tasks such as temperature modulation, moisture reduction, biological reactions, or catalyzing chemical reactions?

Five key challenges are hypothesized to have prevented electromagnetic heating from replacing traditional thermal conduction and convection: 1. The absence of technology capable of uniformly radiating radio frequency, microwave electric and/or magnetic fields, or infrared, visible, invisible, and ultraviolet light with high efficiency, ensuring each particle in a bulk volume receives near-even exposure without preference for any particle side or edge. 2. Inefficiencies in electrically coupling electromagnetic energy to target particles, exacerbated by limitations in existing electromagnetic applicator technologies, such as open-ended waveguides without dBi gain. 3. The suboptimal efficiency of magnetrons, early solid-state microwave and radio-frequency generators, diverse radiating and impedance-matching requirements, and electromagnetic applicators lacking isotropic gain, which collectively constrain the effectiveness of electromagnetic heating. 4. The lack of extreme-duty, real-time sensors capable of withstanding high-energy electromagnetic environments, such as microwaves, limits the ability to dynamically control and optimize the heating process. 5. The absence of advanced computational methods, including artificial intelligence, restricts the potential to manage and optimize the complex variables required for efficient electromagnetic heating.

The foundation of this invention is to direct electromagnetic energy into the fluidized zone (FIGS. 1C, 182) of a counter-rotating twin-shaft mixer (FIGS. 1A through 1C, 2A & B), achieving a uniform application of EM energy similar to the even distribution achieved when applying a liquid directly onto individual particles within the fluidized zone (182). In contrast, a single-shaft paddle or ribbon vane mixing system, as shown in FIGS. 3A through 3D, cannot establish a near-weightless mixing zone where materials converge from two sides, enjoy total freedom of movement, and eliminate segregation.

The integration of electromagnetic energy into the fluidized zone (182) of a counter-rotating twin-shaft mixer facilitates direct and instantaneous interaction with particles at the molecular level. This method ensures a more precise and uniform energy distribution, thereby reducing processing times and enhancing the consistency of the final product. Unlike traditional thermal methods, which depend on the gradual transfer of heat, EM energy can penetrate deeply and uniformly into the material, offering more controlled and efficient processing.

While the fluidized zone represents the preferred embodiment of this invention, emitting electromagnetic energy into the space between the counter-rotating shafts as the product moves between troughs also constitutes an effective means of energy application. As particles traverse between the troughs, they experience consistent motion and redistribution, ensuring substantial exposure to electromagnetic fields. This approach leverages the natural transport dynamics of the counter-rotating twin-shaft mixer to achieve effective energy interaction. This aspect of the invention underscores its versatility and robustness, highlighting that both the fluidized zone and the transportation zone serve as critical energy application regions, forming a foundational principle of the invention.

The application of electromagnetic energy within a counter-rotating twin-shaft mixer, as described in this invention, marks a significant departure from conventional methods that rely on thermal energy transmission or inefficient EM energy transfer in standard single-shaft industrial convective mixers, as well as other traditional approaches such as radiating onto a conveyor or through a falling column. Conventional processes, particularly those utilizing convective heat transfer, depend on the indirect application of heat via a medium like air or steam to elevate the temperature of particles. This approach often proves inefficient, requiring prolonged periods to achieve uniform heating and risking uneven energy distribution, which can compromise product quality.

Achieving high-efficiency coupling of radiated energy to targeted substances necessitates a comprehensive approach. The first challenge involves the development of a high-gain EM applicator, with a preferred gain of at least 15 dBi and ideally reaching 25 dBi. Precise engineering of the EM applicator and EM circuitry is essential for impedance matching with the load in the transportation zone and/or fluidized zone, ensuring that the radiated power is optimally absorbed by the substance. Additionally, maximizing absorption requires careful calibration of the infrared, light, or electric and/or magnetic field strengths (EM energy) to align with the specific absorption characteristics of the target material, while dynamically adjusting parameters such as frequency and power as these characteristics evolve during the process. Techniques such as frequency dithering, sweeping across a range of frequencies, simultaneously radiating multiple frequencies, and applying vacuum can significantly enhance energy transfer efficiency.

### BACKGROUND OF THE INVENTION—OBJECTS AND ADVANTAGES

Accordingly, several objects and advantages of the present invention are:
(a) To provide an apparatus, system, or method for uniformly delivering optimal electromagnetic energy (EM energy) to all particles or substances within an operating electromagnetic reactor (EM Reactor) comprising a mechanical movement system with counter-rotating twin shafts and mixing paddles, by emitting EM energy into the fluidized zone and/or the transportation zone. This enables effective energy interaction with particles, facilitating biological or chemical reactions at the atomic or molecular level and enhancing process efficiency and uniformity.
(b) To provide an apparatus, system, or method utilizing an electromagnetic heating (EM heating) system that efficiently achieves substantially uniform heating of a bulk volume of particles in the process chamber of an operating electromagnetic reactor (EM Reactor) with at least one electromagnetic applicator (EM applicator) emitting EM energy into the fluidized zone and/or the transportation zone.
(c) To provide an apparatus, system, or method utilizing an EM heating system in such a manner that confines the electromagnetic signals (EM signals) to the process chamber or housing of an operating EM Reactor with at least one EM applicator emitting EM energy into the fluidized zone and/or the transportation zone, ensuring regulatory compliance and safe operation.
(d) To provide an apparatus, system, or method for efficiently heat-processing relatively large bulk volumes of particles with at least one EM applicator emitting EM energy into the fluidized zone and/or the transportation zone of an EM Reactor.
(e) To provide an apparatus, system, or method to heat specific elements and/or compositions within a bulk volume of particles in motion within an operating EM Reactor with at least one EM applicator emitting EM energy into the fluidized zone and/or the transportation zone, utilizing a variable-frequency EM applicator system.
(f) To provide an apparatus, system, or method of moving a mass of material in a uniform or near-uniform state for a period of time in an EM Reactor with at least one EM applicator emitting EM energy into the fluidized zone and/or the transportation zone so that all particles receive near-equal exposure to the EM energy.
(g) To provide an apparatus, system, or method of moving a mass of material in a uniform or near-uniform state for a period of time in an EM Reactor with at least one EM applicator emitting EM energy into the fluidized zone and/or the transportation zone so that no surface, edge, or side of any particle receives preferential exposure to the EM energy field.
(h) To provide an apparatus, system, or method of electrically isolating at least one EM applicator emitting EM energy into the fluidized zone and/or the transportation zone of an EM Reactor.
(i) To provide an apparatus, system, or method of placing at least one EM applicator in an optimum location within the process chamber of an EM Reactor for maximizing energy exposure in the fluidized zone and/or the transportation zone and subsequent absorption.
(j) To provide an apparatus, system, or method for sensing material properties within the process chamber of an EM Reactor, and for adjusting the frequency, phase, amplitude, and/or power of an EM applicator emitting EM energy into the fluidized zone and/or the transportation zone.
(k) To provide an apparatus, system, or method for real-time sensing of material properties within the process chamber of an EM Reactor, enabling real-time adjustments to the frequency, phase, and/or amplitude of EM energy emitted into the fluidized zone and/or the transportation zone.
(l) To provide an apparatus, system, or method for sensing the process chamber housing of an EM Reactor, enabling frequency, phase, amplitude, and/or power source adjustments to the EM applicator that emits EM energy into the fluidized zone and/or the transportation zone.
(m) To provide an apparatus, system, or method for sensing conditions outside the process chamber housing of an EM Reactor, facilitating adjustments in frequency, phase, amplitude, and/or power source to the EM applicator that emits EM energy into the fluidized zone and/or the transportation zone.
(n) To provide an apparatus, system, or method for sensing conditions outside the process chamber housing of an EM Reactor, enabling emergency power adjustments to the power source or EM circuitry supplying an EM signal to at least one EM applicator emitting EM energy into the fluidized zone and/or the transportation zone.
(o) To provide an apparatus, system, or method that leverages artificial intelligence to optimize the operation of EM circuitry and EM applicator systems, ensuring efficient emission of EM energy into the fluidized zone and/or the transportation zone of the reactor.
(p) To provide an apparatus, system, or method that utilizes at least one EM applicator to emit EM energy within the radio frequency or microwave spectrum into the fluidized zone and/or the transportation zone, thereby enabling effective dielectric heating.
(q) To provide an apparatus, system, or method for using at least one EM applicator emitting EM energy into the fluidized zone and/or the transportation zone, specifically within the infrared spectrum.
(r) To provide an apparatus, system, or method for using at least one EM applicator emitting EM energy into the fluidized zone and/or the transportation zone, specifically within the terahertz (THz) spectrum.
(s) To provide an apparatus, system, or method for using at least one EM applicator emitting EM energy into the fluidized zone and/or the transportation zone, specifically within the visible and invisible light spectra.
(t) To provide an apparatus, system, or method for using at least one EM applicator emitting ultraviolet (UV) energy into the fluidized zone and/or the transportation zone.
(u) To provide an apparatus, system, or method for using at least one EM applicator emitting X-ray or gamma-ray energy into the fluidized zone and/or the transportation zone.
(v) To provide an apparatus, system, or method for dithering microwave or radio-frequency signals emitted into the fluidized zone and/or the transportation zone of an EM Reactor.
(w) To provide an apparatus, system, or method to inject a fluid into the process chamber of an EM Reactor with at least one EM applicator emitting EM energy into the fluidized zone and/or the transportation zone.
(x) To provide an apparatus, system, or method to control impedance of a radio frequency and/or microwave electric and/or magnetic fields emitted into the fluidized zone and/or the transportation zone of an EM Reactor.
(y) To provide an apparatus, system, or method to adjust the frequency emitted into the fluidized zone and/or the transportation zone of an EM Reactor.
(z) To provide an apparatus, system, or method to adjust the distance between two or more EM applicators to correspond with the frequency, phase, or amplitude emitted into the fluidized zone and/or the transportation zone of an EM Reactor.
(aa) To provide an apparatus, system, or method to cool at least one EM applicator emitting EM energy into the fluidized zone and/or the transportation zone of an EM Reactor.
(bb) To provide an apparatus, system, or method to control the air temperature in the process chamber with controlled airflow through the process chamber of an EM Reactor while an EM applicator emits EM energy into the fluidized zone and/or the transportation zone.
(cc) To provide an apparatus, system, or method to create a vacuum in the process chamber of an EM Reactor with at least one EM applicator emitting EM energy into the fluidized zone and/or the transportation zone.
(dd) To provide an apparatus, system, or method to purge the process chamber of an EM Reactor of oxygen to create a pyrolysis chamber with at least one EM applicator emitting EM energy into the fluidized zone and/or the transportation zone.
(ee) To provide an apparatus, system, or method to add a gas to the process chamber of an EM Reactor with at least one EM applicator emitting EM energy into the fluidized zone and/or the transportation zone.
(ff) To provide an apparatus, system, or method to add a fluid to the process chamber of an EM Reactor with at least one EM applicator emitting EM energy into the fluidized zone and/or the transportation zone, recover said fluid, and pass the fluid through a heat exchanger.
(gg) To provide an apparatus, system, or method of an EM Reactor with a tripole EM applicator array emitting EM energy into the fluidized zone and/or the transportation zone.
(hh) To provide an apparatus, system, or method to heat specific elements and compositions within an operating EM Reactor utilizing a variable-frequency EM applicator emitting EM energy into the fluidized zone and/or the transportation zone.
(ii) To provide an apparatus, system, or method for integrating sensors that detect parameters such as temperature, EM power, color, color absorption, weight, humidity, motion, dielectric characteristics, pressure, electrical conductivity, and chemical composition, enabling real-time adjustments to reactor operation with at least one EM applicator emitting EM energy into the fluidized zone and/or the transportation zone.
(jj) To provide an apparatus, system, or method for an EM Reactor featuring a control system that optimizes processing conditions by coordinating the mechanical movement system with the EM applicator system, utilizing sensor data to regulate at least one EM applicator emitting EM energy into the fluidized zone and/or the transportation zone.
(kk) To provide an apparatus, system, or method for an EM Reactor that incorporates an electrical isolation system, which electrically isolates the housing system, mechanical movement system, power transmission system, and/or EM applicator system from ground potential, and/or electrically isolates these systems from each other.
(ll) To provide an apparatus, system, or method for an EM Reactor that utilizes a Joule heating EM applicator to create flash arcs within the fluidized zone and/or the transportation zone, rapidly heating particles through resistive heating mechanisms.
(mm) To provide an apparatus, system, or method for an EM Reactor employing plasma EM applicators capable of dynamically tuning and reconfiguring frequency, direction, bandwidth, gain, and/or beamwidth within the fluidized zone and/or the transportation zone.
(nn)To provide an apparatus, system, or method for an EM Reactor that employs a plasma generation system to form plasma in the fluidized zone and/or the transportation zone. This facilitates targeted heating, biological, or chemical reactions through controlled ionization and efficient energy transfer
(oo) To provide an apparatus, system, or method for an EM Reactor that employs a plasma generation system to form plasma in the fluidized zone and/or the transportation zone, using at least one radio frequency or microwave EM applicator to couple its EM energy into the plasma. This facilitates targeted heating, biological, or chemical reactions through controlled ionization and efficient energy transfer.
(pp) To provide an apparatus, system, or method that employs an EM system with at least one applicator emitting EM energy from infrared to gamma-ray spectra to couple energy with plasma in the fluidized zone and/or the transportation zone, enhancing chemical reactions and optimizing electromagnetic energy absorption and reaction rates.
(qq) To provide an apparatus, system, or method that employs an EM system with at least one applicator emitting EM energy from a permanent or rare-earth magnetic in the fluidized zone and/or the transportation zone, enhancing ferrous object removal.

### SUMMARY OF THE INVENTION

In accordance with this invention, an electromagnetic reactor apparatus, system, and method are provided for exposing bulk volumes of particles—such as free-flowing or semi-flowable grains, biomass, chemicals, pharmaceuticals, minerals, materials, or powders—to near-uniform electromagnetic energy across a wide frequency range. The reactor ensures that all particles receive near-uniform exposure without any preference to a surface, edge, or side of the particles. The electromagnetic reactor electrically isolates the electromagnetic applicator and electromagnetic energy from the earth ground and/or other systems, confining the energy to a prescribed area inside the reactor housing and supporting structures.

In one aspect, the invention relates to an electromagnetic reactor (EM Reactor) with an electromagnetic applicator (EM applicator) and a process for employing the EM applicator to transmit electromagnetic energy (EM energy) between 30 Hz and 30 exahertz (EHz) into the fluidized zone and/or the transportation zone created by the mechanical movement system of a counter-rotating twin-shaft mixer. The EM applicators are designed to emit EM energy at one or more physical locations along their length into these zones, where heating, a biological reaction, or a chemical reaction is desired. The EM Reactor is designed to produce the desired level of electromagnetic fields (EM fields) within the fluidized zone and/or the transportation zone. Embodiments of the design include the ability to vary the frequencies, amplitude, phase, duration, and/or power levels of EM energy to achieve different levels of process chamber heating or reactions, controlling either or both the magnitude of temperature rise and the rate of temperature rise, as well as the magnitude and rate of biological or chemical reactions.

The electromagnetic reactor (EM Reactor) described in this invention is designed to operate within a broad electromagnetic spectrum range from 30 Hz to 30 EHz. This extensive range encompasses a variety of frequencies, enabling the reactor to utilize multiple types of EM energy for specific applications. Within the lower frequency range, the reactor can employ radio-frequency and microwave dielectric heating, which are effective for heating non-conductive materials from the inside outward. Moving up the spectrum, the reactor can emit visible light and infrared radiation, which are useful for processes requiring precise thermal control and surface heating. Additionally, the reactor is capable of generating ultraviolet light and terahertz radiation, which are advantageous for sterilization, photochemical reactions, and material characterization. The upper end of the spectrum includes X-rays and gamma rays, which can be utilized for ionization, advanced imaging and high-energy processes. Joule heating occurs when high-voltage electrical pulses create a flash arc between electrodes (EM applicators), rapidly heating particles through resistive heating mechanisms. Permanent magnets or rare-earth magnets provide one means of generating a magnetic field for the system. This versatility makes the EM Reactor a highly adaptable tool for a wide range of food, industrial, scientific, and medical applications, far surpassing the traditional capabilities of dielectric heating alone.

The EM applicator receives excitation from an EM circuity, which delivers signals via an EM circuit. An electromagnetic circuitry (EM circuitry) (signal generator with a microwave or radio-frequency signal) supplies a harmonic time-varying sinusoidal waveform with either a single frequency (single mode) or multiple frequencies (multi-mode), enabling operation in either resonant or traveling wave conditions to achieve the desired EM energy. The EM circuitry generates signals that are converted into EM energy by the EM applicator, emitting an EM field that produces a reactive field in the fluidized zone and/or transportation zone. This field causes both conductive and dielectric heating, primarily due to the molecular oscillation of polar molecules in the bulk volume of particles within the fluidized zone and/or transportation zone. The application of EM energy continues until the desired temperature, biological reaction, or chemical reaction is achieved. In some embodiments, the power of the EM energy is varied during the heating process or intermittently cycled on and off to achieve a desired heating or reaction profile.

An EM Reactor comprises a support structure system positioned between the earth ground and a housing system, with a mechanical movement system primarily mounted within the housing and powered by an integrated power transmission system. The reactor utilizes a convective mechanical movement system that creates a fluidized zone and/or a transportation zone to ensure the uniform or near-uniform movement of bulk volumes of particles within the housing. An EM applicator system, typically comprising EM circuitry to generate signals that are sent through an EM circuit to an EM applicator to emit infrared, microwave, radio-frequency, visible light, ultraviolet light, Joule flash arcs, and/or other EM energy into the fluidized zone and/or the transportation zone of the reactor. The reactor includes an incoming gate system to regulate the entry of particles and an outgoing gate system to control their exit. The reactor is equipped with a sensing system that measures various properties at one or more locations and communicates this data to a computer system. An air or gas circulation system helps control the temperature of the process chamber and its contents by flowing air or process gas into the chamber. A process fluid system introduces gas into the process chamber to facilitate the flow of EM energy, support chemical reactions, or form a plasma. The computer system, interfacing with input sensors or operating based on a preprogrammed algorithm or sequence, and/or artificial intelligence, generates outputs to control the reactor. The term “electromagnetic reactor” encompasses both the apparatus and the methods employed within this system.

### BRIEF DESCRIPTION OF THE DRAWINGS

FIG. 1A (Prior Art): An isometric view of a counter-rotating twin-shaft fluidized mixer with the bottom gate discharge system in the open position. The cover lid is not shown to depict the internal components.

FIG. 1B (Prior Art): A top cross-sectional view of the area taken in the direction indicated by line 1B-1B of FIG. 1A, illustrating the internal components of the mixer, including the shafts, support bars, and mixing paddles within the process chamber. The figure also shows external components such as the bearings, coupling, gearbox, and motor, which are located outside the housing.

FIG. 1C (Prior Art): An end elevational cross-sectional view taken along line 1C-1C of FIG. 1A, illustrating the internal components of the mixer, including the shafts, support bars, and mixing paddles within the process chamber, along with the depiction of the transportation and fluidized zones.

FIG. 2A (Prior Art): An isometric view of a counter-rotating twin-shaft fluidized mixer configured as a Forberg Dryer. The figure also illustrates several integrated systems, including a fluid addition system, a deagglomeration system, a closed-loop air movement system, a thermal air heating system, an air filtration system, the bottom gate discharge system in the open position and an air-cooling system designed for moisture removal.

FIG. 2B (Prior Art): A front elevational cross-sectional view of the area taken in the direction indicated by view taken along line 2B-2B of FIG. 2A, providing a detailed illustration of the internal components within the Forberg mixer. These components include the shafts, support bars, and mixing paddles within the process chamber, as well as the power transmission motor, gearbox, and coupling outside the housing. Additionally, the figure shows integrated systems within the Forberg Dryer comprising fluid addition system, such as the spray manifold, valves, and piping, along with the filtration bags of the air filtration system, the heating coils of the thermal air heating system, and the cooling coils and condensate collection tray of the air-cooling system.

FIG. 3A (Prior Art): An isometric view of a single-shaft convective mixer featuring a cover lid, an incoming gate system, a discharge gate system, an airflow system, and four microwave open-ended waveguide systems.

FIG. 3B (Prior Art): An isometric view of the single-shaft convective mixer without the cover lid, revealing the internal ribbon mixing vanes and the four microwave EM applicator systems.

FIG. 3C (Prior Art): An isometric view of the single-shaft convective mixer, shown without the cover lid, illustrating the internal ribbon mixing vanes with the process chamber filled with product. The view also depicts airflow arrows above the product and the four microwave open-ended waveguide systems.

FIG. 3D (Prior Art): An end elevational cross-sectional view of the area taken in the direction indicated by view taken along line 3D-3D of FIG. 3C, illustrating a cross-section of one microwave open-ended waveguide system and the mixing system.

FIG. 3E (Prior Art): An enlarged cut view of the area taken in the direction indicated by line 3E in FIG. 3D, providing a clearer depiction of the microwave waveguide, the microwave signal traversing an open-ended waveguide, and the expansion of the microwave signal as it exits the waveguide and enters the mass being mixed within the mixer's process chamber.

FIG. 4A: An isometric view of an electromagnetic reactor (EM Reactor) according to the invention, featuring two different types of electromagnetic applicator (EM applicator) systems, each with at least one high-gain EM applicator emitting electromagnetic energy (EM energy) into the fluidized zone and/or the transportation zone of a counter-rotating twin-shaft mixer. These EM applicators are optimized for emitting either megahertz (MHz) radio-frequency or gigahertz (GHz) microwave electric and/or magnetic fields.

FIG. 4B: A front elevational cross-sectional view of the area taken in the direction indicated by line 4B-4B of FIG. 4A, illustrating a cross-section of the two microwave EM applicator systems and the mechanical movement system. One microwave EM applicator system comprises EM circuitry (signal generator) connected via an EM circuit to an EM applicator (high isotropic gain slotted waveguide), designed to deliver a high isotropic gain (dBi) for uniform EM energy distribution into the fluidized zone and/or the transportation zone. The second system includes three EM circuitries (signal generators), each paired with an EM applicator (high isotropic gain horn), enabling targeted energy delivery and enhanced control over electromagnetic field application. Both applicators are depicted with a radome material positioned between the applicator and the process chamber to ensure protection and consistent field performance.

FIG. 4C: An end elevational cross-sectional view of the area taken in the direction indicated by line 4C-4C of FIG. 4B, showing a detailed cross-section of the slotted waveguide microwave EM applicator system in relation to the fluidized zone and/or the transportation zone of the mechanical movement system. The EM applicator (slotted waveguide) is depicted with a radome material positioned between the applicator and the process zones to ensure protection and consistent field performance.

FIG. 4D: An end elevational cross-sectional view of the area taken in the direction indicated by line 4D-4D of FIG. 4B, depicting a detailed cross-section of the EM applicator (high isotropic gain horn) system in relation to the fluidized zone and/or the transportation zone of the mechanical movement system. The horn EM applicator is shown with a radome material positioned between the applicator and the process zones to ensure protection and consistent field performance.

FIG. 5A: An isometric view of an EM Reactor according to the invention, featuring three distinct types of EM applicator systems, each designed to emit EM energy into the fluidized zone and/or the transportation zone of a counter-rotating twin-shaft mixer. One of these systems emits infrared energy, while the second and third systems emit multi-spectral light, encompassing both visible and invisible wavelengths.

FIG. 5B: A front elevational cross-sectional view of the area taken in the direction indicated by line 5B-5B of FIG. 5A, illustrating a cross-section of the three EM applicator systems and the mechanical movement system. The first system comprises EM circuitry (control panel) connected to EM applicators (bulbs) designed to emit EM infrared or light energy into the fluidized zone and/or the transportation zone. The second system features EM circuitry (light generation) that transmits light energy through an EM circuit (fiber optic) for precise light delivery into the fluidized zone and/or the transportation zone. The third system, an EM applicator (multi-spectral light), includes EM circuitry (control panel) and an EM applicator capable of emitting light across visible and/or invisible wavelengths into the fluidized zone and/or the transportation zone.

FIG. 5C: An end elevational cross-sectional view of the area taken in the direction indicated by line 5C-5C of FIG. 5B, providing a detailed cross-section of the multi-spectral LED system in relation to the fluidized zone and the transportation zone of the mechanical movement system.

FIG. 5D: An end elevational cross-sectional view of the area taken in the direction indicated by line 5D-5D of FIG. 5B, providing a detailed cross-section of the EM applicator fiber optic system in relation to the fluidized zone and the transportation zone of the mechanical movement system.

FIG. 5E: An elevation cut view of the area taken in the direction indicated by line 5E-5E of FIG. 5B, providing a detailed cross-section of the EM applicator (bulb) system in relation to the fluidized zone and the transportation zone of the mechanical movement system.

FIG. 6A: An isometric view of an EM Reactor according to the invention, featuring three distinct types of EM applicator systems, each designed to emit EM energy into the fluidized zone and/or the transportation zone of a counter-rotating twin-shaft mixer. These systems are optimized for emitting either megahertz (MHz) radio-frequency or gigahertz (GHz) microwave electric and/or magnetic fields.

FIG. 6B: An end elevational cross-sectional view of the area taken in the direction indicated by line 6B-6B of FIG. 6A, illustrating a cross-section of the three EM applicator systems and the mechanical movement system. The first system comprises EM circuitry (microwave or RF signal generator) with an EM applicator (lossy cable) designed to emit eddy currents into the fluidized zone and/or the transportation zone. The second system includes EM circuitry (microwave or RF signal generator) equipped with an EM applicator (monopole antenna) focused on the fluidized zone and/or the transportation zone, with an additional EM circuitry (signal generator) and an EM applicator (monopole antenna) positioned at the bottom of the mixer, typically 180 degrees out of phase with the upper EM applicators, creating a dipole arrangement. The third system features EM circuitry (microwave or RF signal generator) with an EM applicator (Yagi directional) focused on the fluidized zone and/or the transportation zone, with a ground at the bottom of the mixer, also configured in a dipole arrangement.

FIG. 6C: An end elevational cross-sectional view of the area taken in the direction indicated by line 6C-6C of FIG. 6B, providing a detailed cross-section of the EM applicator (Yagi directional) in relation to the fluidized zone and the transportation zone of the mechanical movement system.

FIG. 6D: An end elevational cross-sectional view of the area taken in the direction indicated by line 6D-6D of FIG. 6B, providing a detailed cross-section of the upper EM applicator (monopole antenna) and the bottom EM applicator (monopole antenna) in relation to the fluidized zone and/or the transportation zone of the mechanical movement system.

FIG. 6E: An end elevational cross-sectional view of the area taken in the direction indicated by line 6E-6E of FIG. 6B, providing a detailed cross-section of the EM circuitry (signal generator) and EM applicator (lossy cable) in relation to the fluidized zone and the transportation zone of the mechanical movement system.

FIG. 7A: An isometric view of an EM Reactor according to the invention, featuring three distinct types of EM applicator systems, each designed to emit EM energy into the fluidized zone and/or the transportation zone of a counter-rotating twin-shaft mixer. These systems are optimized for delivering EM energy under the control of a computer system that processes input signals from the reactor and generates corresponding output signals.

FIG. 7B: An end elevational cross-sectional view of the area taken in the direction indicated by line 7B-7B of FIG. 7A, illustrating a cross-section of the three EM applicator systems and the mechanical movement system. The first system utilizes a dipole arrangement with EM applicators (plasma), optionally supported by EM circuitry (microwave or RF signal generator), to transmit additional frequencies into the fluidized zone and/or the transportation zone. The second system, also computer-controlled, employs a light-based EM applicator (infrared, visible, ultraviolet) to focus and direct EM light energy into the fluidized zone and/or the transportation zone. The third system integrates computer-controlled hardware and an EM applicator (emission device) to project a laser beam into the fluidized zone and/or the transportation zone.

FIG. 7C: An enlarged sectional cut view taken along line 7C-7C of FIG. 7B, providing a detailed cross-section of the EM applicators (plasma). The first system comprises two similar subsystems: one positioned above the fluidized zone and the transportation zone to emit downward and another embedded in the bottom of the mixer housing to create two dipoles that direct electric and/or magnetic fields through these zones. Each subsystem includes a transparent tube or container filled with a noble gas or gas suitable to form a plasma, an ionizer to generate plasma, and an optional EM circuitry that produces a microwave or RF signal coupled to the plasma. The plasma then functions as an EM applicator, emitting energy into the fluidized zone and/or the transportation zone. Both subsystems are managed by the computer system, which uses an input bus and output bus to communicate sensor data and operating signals.

FIG. 8A: An isometric view of an EM Reactor according to the invention, featuring a Forberg Drying System with a closed-loop airflow design and an integrated deagglomeration system. The reactor includes EM circuitry (radio-frequency signal generator) connected to an EM applicator, which is configured to focus its electric and/or magnetic field into the fluidized zone and/or the transportation zone of a counter-rotating twin-shaft mixer. The system is managed by a computer control system, which oversees and optimizes the operation of all subsystems within the reactor.

FIG. 8B: An isometric view of the EM Reactor, as described in FIG. 8A, with the air movement, chilling, and heating systems removed to provide a clearer view of the internal components, including the mixing paddles, EM applicator systems, and mechanical movement system.

FIG. 8C: A side elevational cross-sectional view of the area taken in the direction indicated by line 8C-8C of FIG. 8A, providing a detailed cross-section that illustrates the arrangement and interaction of all the systems within the reactor, including the mechanical movement system, EM applicator, and other internal components.

FIG. 8D: An enlarged cut view of the area taken in the direction indicated by line 8D-8D of FIG. 8C, offering a detailed cross-section of the EM applicator in relation to the mixing paddles, the spinning bars of the deagglomeration system, and the spray manifold of the liquid addition system.

FIG. 9A: An isometric view of an EM Reactor according to the invention, featuring a counter-rotating twin-shaft mixer equipped with external EM circuitry and two types of variable-frequency EM applicators positioned at the ends of the mixer. The distance between these EM applicators can be adjusted to match the signal wavelength, phase, or amplitude, thereby optimizing impedance matching and enhancing the absorption of EM energy by the particulate within the fluidized zone and/or the transportation zone of the process chamber. The reactor comprises a support structure system connecting the housing system to the earth ground, along with a mechanical movement system that mixes the bulk volume of particles within the housing, powered by an external power transmission system. The EM system includes EM circuitry (microwave or RF signal generator) connected to two types of adjustable or tunable EM applicators: one mechanically adjustable and the other adjustable by altering the length of a plasma. A third system, a variable frequency EM applicator system positioned between the EM applicators positioned at each end of the mixer. The reactor also features a positive airflow system that channels air through baffles into the fluidized zone, facilitating the absorption of moisture released from the particles. Complementing this is a negative airflow system, which draws air from the positive system to lower static pressure, assist in fluidization, remove moisture and heat from the reactor, and separate particulates from the airstream via a cyclone separator. The separated particulates can be either returned to the reactor or discharged from the system. A computer control system oversees and optimizes the operation of all subsystems within the reactor.

FIG. 9B: A side elevational cross-sectional view of the area taken in the direction indicated by line 9B-9B of FIG. 9A, providing a detailed cross-section that illustrates the arrangement and interaction of all the systems within the reactor, including the mechanical movement system, tunable EM applicators, and other internal components.

FIG. 9C: An enlarged cut view of the area taken in the direction indicated by line 9C-9C of FIG. 9B, offering an enlarged detailed cross-section of the two types of tunable EM applicators in relation to the mixing paddles, the spinning bars of the deagglomeration system, and the spray manifold of the liquid addition system.

FIG. 9D: An enlarged cut view of the area taken in the direction indicated by line 9D-9D of FIG. 9C, offering a detailed cross-section of the mechanical tunable EM applicator with EM applicator cooling heat exchanger, incoming and outgoing coolant lines, a mechanical actuator with incoming and outgoing power lines, a sensor in the EM applicator heat exchanger with cable, and a sensor on the EM applicator with cable.

FIG. 9E: An enlarged cut view of the area taken in the direction indicated by line 9E-9E of FIG. 9C, offering a detailed cross-section of the plasma tunable EM applicator with EM applicator cooling heat exchanger, incoming and outgoing coolant lines, a plasma chamber with a gas suitable for ionization, and incoming and outgoing gas lines, a plasma ionizer in the chamber with cable, an EM applicator with cable, a sensor in or near the EM applicator heat exchanger with cable, and a sensor in or near the EM applicator with cable.

FIG. 10A: An isometric view of an EM Reactor according to the invention, featuring a counter-rotating twin-shaft mixer equipped with a mechanical fluid system to supply fluid, pressure, and/or vacuum to the process chamber. The various systems can be electrically isolated from earth ground using electrical standoffs in the support structure system. An inlet system controls the input of material into the process chamber, and a discharge system controls the output of material. The reactor includes high-voltage EM circuitry and/or a capacitor connected to EM applicators (electrodes), configured to focus a Joule flash arc into the fluidized zone and/or the transportation zone of the counter-rotating twin-shaft mixer. The system is managed by a computer control system that oversees and optimizes the operation of any or all subsystems within the reactor.

FIG. 10B: A side elevational cross-sectional view of the area taken in the direction indicated by line 10B-10B of FIG. 10A, providing a detailed cross-section that illustrates the arrangement and interaction of all systems within the reactor, including the mechanical movement system, EM applicators (Joule electrodes), and components of the mechanical fluid system in relation to the fluidized zone and the transportation zone.

FIG. 10C: An enlarged cut view of the area taken in the direction indicated by line 10C-10C of FIG. 10B, offering a detailed cross-section of the positioning of the EM applicators (Joule electrodes) in relation to the fluidized zone and the transportation zone, as well as various sensor locations.

FIG. 11A: An isometric view of an EM Reactor according to the invention. In this view, the EM applicator (permanent magnet) and optical sensor are concealed by the upper wall and cover lid.

FIG. 11B: An isometric view of the EM Reactor, as described in FIG. 11A, with the upper wall and cover lid of the housing system removed. This view provides a clearer depiction of the internal components, including the mixing paddles (vanes), EM applicator system (permanent magnet), and an optical sensor. In this embodiment, the mixing vanes do not overlap, and a fluidized zone is not created. Instead, the EM applicator directs EM energy into the area between the parallel shafts, referred to as the transportation zone.

FIG. 11C: A front elevational cross-sectional view taken along line 11C-11C of FIG. 11B, providing a detailed illustration of the internal components within the reactor, including the mixing paddles, EM applicator system (permanent magnet), and the optical sensor, in relation to the fluidized zone and/or the transportation zone.

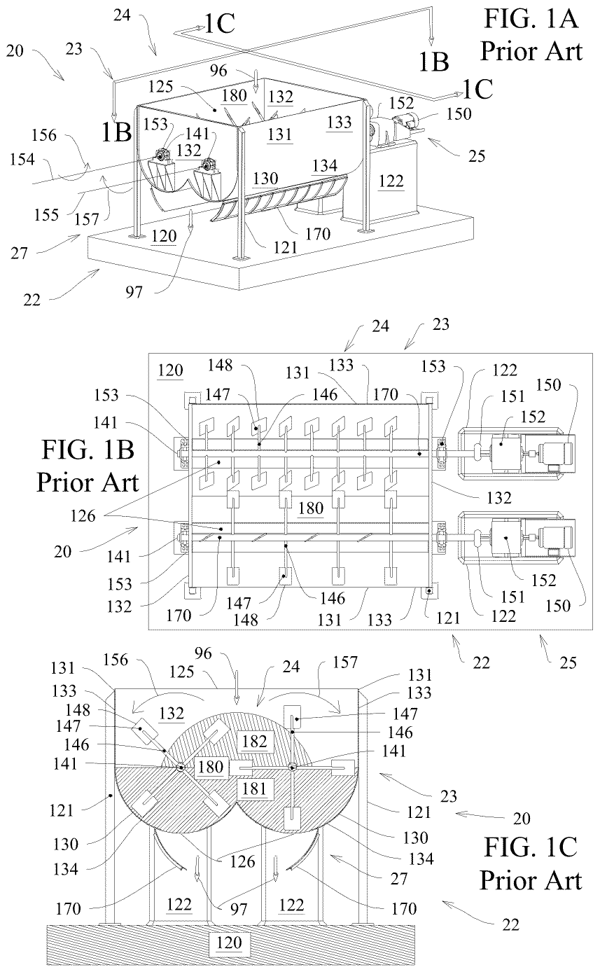

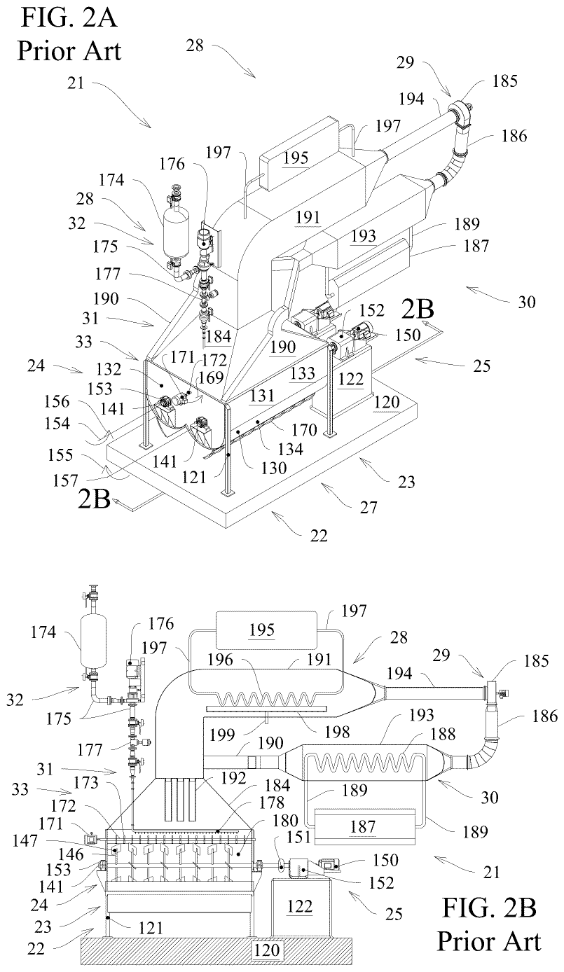

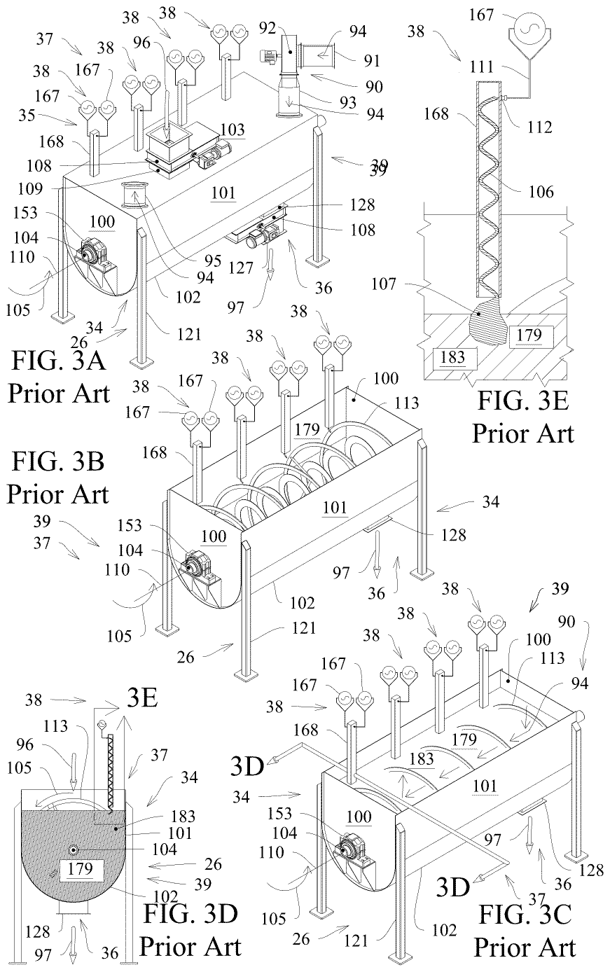

### DETAILED DESCRIPTION

An electromagnetic applicator (EM applicator) (62, 168, 236, 264, 267, 285, 288, 293, 297, 302, 307, 308, 317, 341, 343, 724, 725, 788, 792, 795, 830, 831, 835, 836) is a device that converts electrical energy into electromagnetic energy (EM energy), which is partly radiated as electromagnetic (EM) waves and partly forms a reactive EM field near the EM applicator. An EM applicator within the EM applicator system, operating in the microwave or radio frequency spectrum, can be either metallic or plasma-based. It can take various forms such as, but not limited to, a closed electrical loop, monopole, dipole, tri-wave with three or more EM applicators each with a phase difference, horn, slotted waveguide, or parabolic dish. Generally, an EM applicator is a conducting element sized to emit radiation at one or more selected frequencies.

Efficient transfer of microwave and radio frequency EM energy is achieved when the maximum signal strength sent to the EM applicator (62, 168, 236, 264, 267, 285, 288, 293, 297, 302, 307, 308, 317, 341, 343, 724, 725, 788, 792, 795, 830, 831, 835, 836) is expended into the propagated wave, minimizing reflection. This occurs when the EM applicator is an appreciable fraction of the transmitted frequency's wavelength. The EM applicator geometry must match the incident or transmitted frequencies, allowing the EM applicator to resonate with EM energy at some multiple of its length. Due to this, metallic EM applicators are somewhat limited in the frequency bands they can radiate or receive, as their length is not easily or accurately adjusted. Often, EM applicators designed to transmit or receive across a range of signals have a geometry that matches the center frequency of the intended operating range. To maximize effective radiation, the distance between two EM applicators is adjusted to correspond to a resonant multiple of the wavelength of the frequency to be transmitted. Typical EM applicator configurations include quarter, half, and full wavelengths of the desired frequency.

As used herein, the terms “EM applicator,” “antenna,” “electrode,” “radiator,” and “transducer” (62, 168, 236, 264, 267, 285, 288, 293, 297, 302, 307, 308, 317, 341, 343, 724, 725, 788, 792, 795, 830, 831, 835, 836) may broadly refer to any structure from which EM energy may radiate (emit) and/or be received, regardless of its original design purpose or additional functions. An EM applicator (62, 168, 236, 264, 267, 285, 288, 293, 297, 302, 307, 308, 317, 341, 343, 724, 725, 788, 792, 795, 830, 831, 835, 836) can be as simple as a permanent or rare earth magnet positioned to expose its magnetic field to the particles cycling in and out of the fluidized zone. An EM applicator (62, 168, 236, 264, 267, 285, 288, 293, 297, 302, 307, 308, 317, 341, 343, 724, 725, 788, 792, 795, 830, 831, 835, 836) may include an aperture/slot EM applicator or an EM applicator with multiple terminals transmitting in unison, either simultaneously or with a controlled dynamic phase difference (e.g., a phased array EM applicator). Consistent with some exemplary embodiments, EM applicators (62, 168, 236, 264, 267, 285, 288, 293, 297, 302, 307, 308, 317, 341, 343, 724, 725, 788, 792, 795, 830, 831, 835, 836) that feed energy into an EM energy application zone (referred to herein as the “fluidized zone” or “transportation zone”) are described. In some embodiments, one or more EM applicators may serve both as receivers and transmitters. In other embodiments, EM applicators may serve dual or single functions. For instance, a single EM applicator may be configured to both deliver and receive EM energy within the chamber, while others may only deliver. Additionally, EM applicators may be adjusted to affect the field pattern, with properties such as position, location, orientation, and temperature being variable to create different EM field patterns within the energy application zone, thus affecting energy absorption in the object.

An aperture refers to a region void of material with high electrical conductivity, such as a gap or perforation in the coaxial line forming the coaxial EM applicator, particularly in the outer conductor of the coaxial line.

An EM circuit (111, 255, 258, 263, 266, 284, 287, 292, 296, 301, 304, 306, 322, 342, 344, 721, 722, 731, 732, 741, 742, 744, 745, 771, 772, 787, 791, 831, 832, 851) refers to the line used to deliver the EM energy signal from the EM circuitry to the EM applicator. The EM circuit may consist of parallel conductors, coaxial conductors, or other suitable conductor arrangements for transmitting the signal from the signal generator to the excitation point of the EM applicator. The EM circuit can be a rigid conductor assembly or a flexible cable assembly and may include features for cooling to maintain suitable operating temperatures for the conductors and surrounding dielectric material. In this disclosure, an EM circuit represents a path and can be an open or closed circuit. The EM circuit can be a rectangular or round waveguide and may transmit electrical signals such as Bluetooth, Wi-Fi, or other means of EM energy or signal transmission and reception.

Color absorption characteristics refer to the ability of a material to absorb certain wavelengths of visible and invisible light, which determines the material's color appearance. In the context of EM processing, these characteristics are relevant when materials absorb specific wavelengths of EM energy, including infrared, visible, invisible, and ultraviolet light, influencing heating patterns, reaction rates, and material transformations during processing.

The computers (240, 250, 320, 760, 820), utilized in computer systems (804, 69, 76, 703, 99), serve as the core control units for the EM Reactor, incorporating essential components such as a microprocessor and digital data storage. The microprocessor executes control algorithms and processes real-time data from various sensors monitoring key parameters, including, but not limited to, temperature, pressure, EM field intensity, dielectric characteristics, color absorption, and material behavior within the fluidized zone and/or the transportation zone. Digital data storage retains operational settings, historical sensor data, and pre-programmed instructions, enabling real-time adjustments to the reactor's operation. These computers communicate with subsystems, including the EM applicators, power transmission systems, and auxiliary components, through input and output buses. This communication ensures precise control over variables such as frequency, phase, and energy levels, optimizing the reactor's performance for uniform energy distribution and enhanced process efficiency.

In some embodiments, the computers may also integrate artificial intelligence (AI) algorithms to further enhance operational efficiency. The AI can analyze complex data patterns from sensors in real-time, learning from historical data to predict optimal operational adjustments. It can dynamically adjust the energy parameters, flow rates, and processing conditions, improving reaction consistency and reducing energy waste. The AI-driven system can autonomously respond to changing material properties and environmental factors, fine-tuning the reactor for specific biological or chemical reactions, thereby further increasing process efficiency and effectiveness.

A conductor is an object or material that permits the flow of electric charges in one or more directions, characterized by a high value of electrical conductivity. Metals are typical examples of materials with high electrical conductivity.

Convective mixing is the bulk transfer of particle groups using mixing vanes, i.e. blades, ribbon blades, or paddles. Examples include ribbon blenders, paddle mixers, and screw mixers.

Dielectric characteristics refer to the properties of a material that determine how it interacts with an electric field, particularly its ability to store and dissipate electrical energy. Key dielectric characteristics include relative permittivity (dielectric constant), dielectric loss factor, and dielectric strength. These properties influence how materials respond to EM energy, especially in processes involving dielectric heating, where materials absorb EM energy and convert it into heat due to their dielectric properties.

A dielectric material is intended to function as an electrical insulator or is the material subjected to EM heating in the process chamber. Dielectric materials are characterized by their relative electrical permittivity, which may vary with frequency and temperature. Examples of solid dielectric materials include alumina, porcelain, glass, glass-resin composites, glass-ceramic composites, PEEK, glass-filled PEEK, ceramic-filled PEEK, PPS, glass-filled PPS, ceramic-filled PPS, PEI, polyethylene terephthalate (PET), glass-filled PEI, ceramic-filled PEI, and foamed polymers like foamed Nylon 6. Liquid dielectric materials include hydrocarbon liquids such as paraffinic waxes and oils, synthetic crude oil, Fischer-Tropsch liquids and solids, purified and refined crude oil, biodegradable materials, and mixtures thereof. Gaseous dielectric materials include CO2, nitrogen, oxygen, sulfur hexafluoride (SF₆), air, and mixtures thereof.

The electrical power source generates electrical power, which may be alternating current (AC) or direct current (DC).

An electrical standoff is a structural and insulating component designed to electrically isolate one or more conductive parts from a ground potential or other conductive elements. In the context of the electromagnetic reactor, the electrical standoff provides a physical barrier and dielectric insulation between the housing system, mechanical movement system, power transmission system, or electromagnetic applicator system and the reactor's support structure or earth ground. Constructed from high-dielectric materials such as ceramics, polymers, or composite materials, electrical standoffs are engineered to withstand the electromagnetic, thermal, and mechanical stresses encountered during reactor operation. By preventing unwanted electrical pathways or grounding, the standoff ensures safe operation, maintains the integrity of electromagnetic fields, and enhances the efficiency and performance of the reactor system.

The invention involves applying EM energy to a bulk volume of flowable or semi-flowable particles. EM energy from the EM circuitry (167, 253, 256, 262, 265, 269, 283, 286, 291, 295, 300, 303, 305, 318, 720, 730, 770, 790, 811) includes EM energy across the spectrum, such as radio frequencies, infrared (IR), near-infrared, visible light, invisible light, ultraviolet, THz, X-Ray, and Gamma Ray. Applying energy in the radio frequency (RF) portion is also referred to as applying EM energy. Microwave and ultra-high frequency (UHF) energy are within the RF range.

The electromagnetic circuitry (EM circuitry) (167, 253, 256, 262, 265, 269, 283, 286, 291, 295, 300, 303, 305, 318, 720, 730, 770, 790, 811) controls, converts, and/or generates EM signals that are delivered via an EM circuit (111, 255, 258, 263, 266, 284, 287, 292, 296, 301, 304, 306, 322, 342, 344, 721, 722, 731, 732, 741, 742, 744, 745, 771, 772, 787, 791, 831, 832, 851) to an EM applicator (62, 168, 236, 264, 267, 285, 288, 293, 297, 302, 307, 308, 317, 341, 343, 724, 725, 788, 792, 795, 830, 831, 835, 836) within an EM applicator system (47, 48, 51, 52, 53, 56, 57, 58, 61, 67, 68, 71, 89, 702, 710, 711, 712, 803, 805). The EM circuitry (167, 253, 256, 262, 265, 269, 283, 286, 291, 295, 300, 303, 305, 318, 720, 730, 770, 790, 811) is typically positioned near the EM Reactor and between the incoming power (290) and the EM circuit (111, 255, 258, 263, 266, 284, 287, 292, 296, 301, 304, 306, 322, 342, 344, 721, 722, 731, 732, 741, 742, 744, 745, 771, 772, 787, 791, 831, 832, 851) or applicator (62, 168, 236, 264, 267, 285, 288, 293, 297, 302, 307, 308, 317, 341, 343, 724, 725, 788, 792, 795, 830, 831, 835, 836). The EM circuitry (167, 253, 256, 262, 265, 269, 283, 286, 291, 295, 300, 303, 305, 318, 720, 730, 770, 790, 811) controls, converts, or generates the incoming electrical power for use by the EM applicator (62, 168, 236, 264, 267, 285, 288, 293, 297, 302, 307, 308, 317, 341, 343, 724, 725, 788, 792, 795, 830, 831, 835, 836). A simple embodiment of EM circuitry (167, 253, 256, 262, 265, 269, 283, 286, 291, 295, 300, 303, 305, 318, 720, 730, 770, 790, 811) may include a switch, potentiometer, rheostat, AC to DC converter, or DC to AC converter. In some embodiments, the EM circuitry includes electronic components such as a microwave or radio frequency signal generator, multi-frequency synthesizer, signal output control, power amplifier, impedance matching system, power supply, power meter, oscillator, inverter, pulse synthesizer, transformer, and frequency tuning circuitry. The circuitry may include components that measure properties of the generated signal and attached loads, such as power, frequency, and reflection coefficient from the load.

The EM circuitry (167, 253, 256, 262, 265, 269, 283, 286, 291, 295, 300, 303, 305, 318, 720, 730, 770, 790, 811) generates an electric signal with power ranging from about 2 watts to 2 megawatts. Other embodiments may generate different power levels. In some embodiments, the EM circuitry (167, 253, 256, 262, 265, 269, 283, 286, 291, 295, 300, 303, 305, 318, 720, 730, 770, 790, 811) may produce or receive signals across the EM spectrum, including extremely high frequency (EHF), super high frequency (SHF), ultra-high frequency (UHF), very high frequency (VHF), high frequency (HF), medium frequency (MF), amplitude modulation (AM), frequency modulation (FM), digital spread spectrum signals, low frequency (LF), very low frequency (VLF), ultra-low frequency (ULF), super low frequency (SLF), extremely low frequency (ELF), and others. Both continuous wave and pulsed signals can be transmitted or received using this system.

The EM circuitry (167, 253, 256, 262, 265, 269, 283, 286, 291, 295, 300, 303, 305, 318, 720, 730, 770, 790, 811) can be manual or automatic, such as a digital signal processor. The operating signal source can be any EM wave emitter, including the plasma device itself. Ionization mechanisms for controlling the plasma frequency include direct and external excitation with EM energy like lasers and EM circuitry.

The EM circuitry (167, 253, 256, 262, 265, 269, 283, 286, 291, 295, 300, 303, 305, 318, 720, 730, 770, 790, 811) can include a transmitter and an impedance matching coupler. The coupler may comprise transformers, resonating capacitors, inductors, and other components to match and manage the dynamic impedance changes of the bulk volume of particles as they heat. The transmitter can be an electromechanical device such as a multiple-pole alternator or a variable reluctance alternator with a slotted rotor that modulates coupling between inductors. The EM circuitry (167, 253, 256, 262, 265, 269, 283, 286, 291, 295, 300, 303, 305, 318, 720, 730, 770, 790, 811) may also be realized using vacuum tube devices or an array of solid-state devices, offering multiple options to implement the EM circuitry. EM energy can be high-frequency alternating current, alternating voltage, current waves, or voltage waves, and may have sinusoidal, square, or other waveforms. The high-frequency signal can include harmonics of the fundamental frequency.

In some embodiments, the EM circuitry (167, 253, 256, 262, 265, 269, 283, 286, 291, 295, 300, 303, 305, 318, 720, 730, 770, 790, 811) produces more than one frequency simultaneously, and the frequency and shape of the high-frequency signal may change over time. “High-frequency alternating current” refers to a periodic, high-frequency EM power signal, which can be a voltage signal in some embodiments. Lower-frequency EM power provides more efficient and cost-effective options for EM circuitry (signal generators). Low-frequency RF sources can utilize gallium nitride (GaN) on silicon carbide (SiC) transistors, which provide high power output and excellent efficiency. SiC transistors are effective at high temperatures (over 200° C.) but not in high-frequency ranges (megahertz). The EM circuitry can include an inverter, pulse synthesizer, transformer, switches, low-to-high frequency converter, oscillator, amplifier, or any combination thereof.

In some embodiments, the EM circuitry (167, 253, 256, 262, 265, 269, 283, 286, 291, 295, 300, 303, 305, 318, 720, 730, 770, 790, 811) forms plasma from the gas composition and transmits or receives signals to and from the plasma. An EM circuitry (167, 253, 256, 262, 265, 269, 283, 286, 291, 295, 300, 303, 305, 318, 720, 730, 770, 790, 811) matches the plasma frequency to the operating frequency, optimizing EM applicator (788, 795) aperture. The EM circuitry can couple EM signals (both receiving and transmitting) to the plasma.

An electrical isolation system is a set of components and configurations designed to electrically isolate certain parts of a system from others, preventing undesired current flow and potential hazards. In the EM Reactor system, the electrical isolation system ensures that the housing system, mechanical movement system, power transmission system, and EM applicator systems are electrically isolated from ground (earth potential) and from each other. This prevents electrical currents from inadvertently passing through the support structure or other unintended paths, enhancing safety and system performance.

In the context of this patent application, the term “fluid” refers to any substance that can flow and conform to the shape of its container. This includes liquids, gases, and granular solids in motion. For the purposes of the EM Reactor, “fluid” encompasses both traditional liquids and gases as well as free-flowing or semi-flowable particulate materials, such as powders or grains, that exhibit fluid-like behavior under certain conditions, such as within a fluidized zone. A fluid in this system can be manipulated using various techniques, including EM energy, mechanical mixing, pressure, and airflow, to enhance processes such as heating, drying, or facilitating chemical and biological reactions. The fluid's behavior is crucial in ensuring uniform exposure to EM energy and optimizing the reactor's performance.

The fluidized zone refers to a near-weightless region within the process chamber of the electromagnetic reactor, created by the precise agitation of particles using counter-rotating twin shafts and overlapping mixing vanes or paddles. This zone is achieved when the tip speed of the paddles meets or exceeds 1.43 m/sec (281 ft/min) with a tolerance of no more than ±2%, as determined by the design specifications for creating fluidization. The overlapping motion and controlled speed ensure the suspension and randomization of particles, enabling uniform exposure to electromagnetic (EM) energy. Achieving and maintaining this fluidized state may also require controlled air or gas flow to assist in particle suspension. The fluidized zone facilitates optimal interaction between particles and EM fields, enhancing uniform heating, energy absorption, and consistency in biological, chemical, or thermal processes. This zone represents the preferred embodiment for maximizing process efficiency in the electromagnetic reactor.

An input bus (251, 321, 323, 326, 328, 330, 332, 334, 336, 338, 726, 761, 796, 815, 823, 828, 838, 852) transfers sensor (298, 345, 728, 736, 776, 850, 950, 951, 952, 953) data signals to at least one computer (240, 250, 760, 804, 820), controller, microprocessor, and/or digital storage from EM circuitry (167, 253, 256, 262, 265, 283, 286, 291, 295, 300, 303, 305, 318, 720, 730, 740, 770, 784, 830) and/or auxiliary systems (78, 79, 80, 81, 82, 83, 84, 708, 709, 710, 713, 716, 717, 806, 809). Although illustrated with an input bus, many systems'circuitry can connect to a microprocessor through other methods, such as direct connections. The term “input bus” refers broadly to any connection facilitating the transfer of incoming data to a computer (240, 250, 760, 804, 820), controller, microprocessor, and/or digital storage.

In-situ infrared thermal sensing can be used directly inside the process chamber to measure the emitted infrared radiation from the materials in real-time. This provides direct and continuous temperature measurements, enabling immediate feedback to the control system. Adjustments to the EM energy can then be made in real time to ensure optimal processing conditions within the fluidized zone.

Joule heating, also known as resistive heating or ohmic heating, is the process by which the passage of an electric current through a conductor releases heat. The heat generated is proportional to the square of the current multiplied by the electrical resistance of the conductor (P=I²R). In the context of the EM Reactor system, Joule heating occurs when high-voltage electrical pulses create a flash arc between EM applicators (electrodes), rapidly heating particles in the fluidized zone through resistive heating mechanisms. A flash arc is a sudden, high-intensity electrical discharge between two EM applicators (electrodes) separated by a gap, typically occurring when a high-voltage difference overcomes the dielectric breakdown strength of the intervening medium (e.g., air or gas). This results in a rapid release of energy in the form of light, heat, and EM energy. In the EM Reactor system, a flash arc is used within the Joule EM applicator system to generate localized, intense EM energy fields that heat particles in the fluidized zone.

Mixing refers to any operation used to transform a non-uniform system into a uniform one by random distribution of initially separated phases. In the context of the reactor, the mechanical movement system (including mixing paddles) creates two distinct zones: the fluidized zone and the transportation zone. The fluidized zone is a near-weightless region where particles are suspended and thoroughly mixed, ensuring uniform exposure to EM energy. In contrast, the transportation zone facilitates the movement and redistribution of particles between the shafts, enabling adequate mixing and consistent interaction with EM energy during the transition. The two major types of convection mixers are batch mixers and continuous mixers. A continuous mixer processes ingredients proportionally, mixes them with intense agitation, and discharges the mixture continuously. A batch mixer loads all ingredients, agitates them until homogeneous, and then discharges the mixture. Batch and continuous mixers can have internal rotating agitators or rotate the vessel itself. Batch mixers are categorized by the shear they apply during mixing. Low-shear mixers suit free-flowing materials, while mid-to high-shear mixers handle more cohesive materials.

An optical pyrometer can be employed in-situ or outside of the process chamber to measure the color or brightness of samples extracted from the material. Due to the fast movement of materials within the counter-rotating twin-shaft mixer, real-time in-chamber optical measurements may not be reliable. By periodically taking samples and using the optical pyrometer to assess their color, the EM energy settings—such as intensity or frequency—can be adjusted accordingly to optimize the reactor's processing conditions, ensuring accurate energy distribution and reaction efficiency.

An output bus (252, 324, 325, 327, 329, 331, 333, 335, 337, 340, 727, 738, 762, 779, 797, 816, 824, 829, 839, 853) transmits control signals from at least one computer (240, 250, 320, 760, 820), controller, microprocessor, or digital storage unit to the EM circuitry (167, 253, 256, 262, 265, 269, 283, 286, 291, 295, 300, 303, 305, 318, 720, 730, 770, 790, 811) and/or auxiliary systems (78, 79, 80, 81, 82, 83, 84, 708, 709, 710, 713, 716, 717, 806, 809). Although illustrated with an output bus, many systems'circuitry can connect to a microprocessor through other methods, such as direct connections. The term “output bus” broadly refers to any connection facilitating the transfer of outgoing data from a computer (240, 250, 760, 804, 820), controller, microprocessor, and/or digital storage to a primary or auxiliary system of an EM Reactor.

The term “particles,” as used herein, refers to discrete units of flowable or semi-flowable solid materials that can vary in size, shape, and composition but are characterized by their ability to be suspended, redistributed, or fluidized within a process chamber. Particles include, but are not limited to, powders, granules, grains, pellets, flakes, and aggregates. For the purposes of this invention, particles specifically exclude continuous solids and liquids, as the reactor and its fluidization zone are optimized for materials that exhibit particulate behavior during mechanical agitation and electromagnetic energy application. Particles typically have moisture levels that allow for effective fluidization and processing within the system.

The term “bulk volume of particles,” as used herein, refers to a collection of discrete particles occupying a defined spatial region within the process chamber. This volume represents the aggregate of the particles, including the interstitial spaces between them, and encompasses flowable or semi-flowable solid materials that can be moved, fluidized, or redistributed by the mechanical movement system. The bulk volume is characterized by the collective behavior of the particles as they are subjected to processes such as mixing, heating, or electromagnetic energy application. For the purposes of this invention, the term excludes continuous solids and liquids, as the reactor is optimized for processing particulate materials that exhibit dynamic, fluid-like behavior during operation.

Permanent magnets (236) are materials that produce a consistent magnetic field without the need for an external power source. They are commonly made from materials like ferrite, alnico, or rare-earth elements. Rare-earth magnets (236), such as neodymium (NdFeB) and samarium-cobalt (SmCo), are a specialized subset of permanent magnets that exhibit exceptionally high magnetic strength due to their composition of rare-earth elements. In many applications, permanent magnets (236) are paired with spacers—often made of non-magnetic materials like wood—that help to focus and extend the magnetic field for deeper penetration, enhancing their ability to attract and capture ferrous objects. These spacers, along with the magnets, are typically encased in housings to protect the components from wear and environmental exposure, ensuring durability and optimal performance. Rare-earth magnets are particularly valued for their resistance to demagnetization and their ability to generate powerful magnetic fields in compact configurations, making them indispensable in demanding industrial applications.

Permittivity, often denoted by the symbol ε, is a measure of how much electric field (electric flux) is permitted to pass through a material. It quantifies a material's ability to store electrical energy in an electric field. Relative permittivity, or dielectric constant (εᵣ), is the ratio of a material's permittivity to the permittivity of free space (ε₀). Materials with high permittivity can store more electrical energy, which is significant in applications involving EM energy absorption and dielectric heating.

A plasma EM applicator (788, 795) uses plasma instead of the metal elements found in traditional EM applicators. Plasma EM applicators (788, 795) can be used for both transmission and reception. Although practical plasma EM applicators have only recently become feasible, the concept dates back to a patent granted to J. Hettinger in 1919.

The plasma EM applicator's (788, 795) characteristics can be optimized by adjusting the plasma frequency, allowing for flexibility across a range of frequencies. Plasma EM applicators (788, 795) can be dynamically tuned and reconfigured for frequency, direction, bandwidth, phase, amplitude, gain, and beamwidth, eliminating the need for multiple EM applicators. A plasma device has an ionizable substance within a chamber with electrodes or other mechanisms to pass an ionizing current to form the plasma. During operation, the plasma frequency and operating frequency are selected to maximize efficiency and aperture given the EM applicator geometry. The plasma device can be any size and shape, with optimal EM applicator characteristics achieved by adjusting the plasma frequency. Plasma EM applicator (788, 795) reconfigurability, including length or size adjustments of elements, can yield various desired results. The size of the EM applicator elements affects the frequency selectivity of the system's surface. Plasma generation within EM applicators can reflect certain frequencies while allowing others to pass. Increased plasma in elements reduces space between plasma elements.

Plasma devices can include plasma EM applicators (788, 795), arrays of plasma EM applicators, nested plasma EM applicators, plasma frequency selective surfaces, plasma filters, plasma reflectors, plasma shields, plasma lamps, plasma limiters, plasma switches, plasma windows, plasma screens, and plasma phase shifters.

Plasma devices have two resonances: one matching the corresponding metal device resonance and another when the operating frequency equals the plasma frequency times a geometric factor. Continuous or afterglow operation reduces noise when the plasma frequency matches the operating frequency. Pulsing with alternating polarity reduces noise. Matching plasma frequency to operating frequency optimizes performance. Electric field gradients change plasma shape and density, affecting gain and directivity. An inner plasma tube radiates, while an outer tube changes radiation and reflects signals. Instrumentation measures plasma density, regulating radiation frequency. Plasma transparency and reflection depend on unbound electron density. If the incident EM frequency exceeds the plasma frequency, EM energy passes through. Otherwise, plasma acts as a metal, transmitting and receiving microwave radiation. Plasma layers can reflect microwaves, steering and focusing beams.

The process chamber (180, 200, 238) refers to the internal area within the housing where product is held and mixing occurs. This chamber includes two key mixing zones: the fluidized zone, where particles enter a state of near-weightlessness, cycling in and out as EM energy is applied, and the transportation zone, where particles move between the parallel shafts of the counter-rotating twin-shaft mixer, enabling consistent redistribution and exposure to EM energy. The process chamber may be designed to hold various mediums, including liquids, solids, gases, or combinations thereof, and also encompasses the space between the product and the overhead cover lid.

Radio propagation refers to the behavior of radio waves as they travel from one point to another, affected by reflection, refraction, diffraction, absorption, polarization, and scattering. Understanding these effects and the varying conditions of the EM heating environment and the material exposed to the waves is crucial for designing a bulk volume dielectric heating device.

A radome (234) is a structural, weatherproof enclosure protecting an EM applicator, constructed from materials that minimally attenuate the transmitted or received EM signal. A radome (234) protects the EM applicator (62, 168, 236, 264, 267, 285, 288, 293, 297, 302, 307, 308, 317, 341, 343, 724, 725, 788, 792, 795, 830, 831, 835, 836) from weather and conceal electronic equipment. They can be constructed in various shapes and materials, such as but not limited to fiberglass, fused quartz, Pyrex, or PTFE-coated fabric.

A ribbon mixer is a batch, convective, low-shear mixer with an internal rotating ribbon creating convection currents within a stationary trough. The shaft has arms and helical blades (ribbons) moving ingredients for mixing.

Segregation is defined as the separation of particles into distinct zones due to physical properties. Particles presented to an EM energy field while segregated typically do not receive similar exposure, even if moving.

A sensor (298, 345, 728, 736, 776, 850, 950, 951, 952, 953) is a device that detects information related to the contents in the process chamber (200, 238), EM applicator (62, 168, 236, 264, 267, 285, 288, 293, 297, 302, 307, 308, 317, 341, 343, 724, 725, 788, 792, 795, 830, 831, 835, 836), housing system (42, 86), mechanical movement system (43, 87), power transmission system (44, 88), or auxiliary process equipment (78, 79, 80, 81, 82, 83, 84, 708, 709, 710, 713, 716, 717, 806, 809). Sensors may detect information related to the bulk volume of particles, the energy application process, or the energy application zone. Sensor (298, 345, 728, 736, 776, 850, 950, 951, 952, 953) generates a signal that correlates to a measurement property comprising one or more selected from the group of: temperature, radio frequency, color absorption, dielectric characteristics, resonance frequency, pressure, electrical conductivity, voltage, current, electrical permittivity, magnetic permeability, electrical field intensity, magnetic field intensity, magnetic flux density, infrared, electron density, EM power, color, weight, humidity, motion, dielectric characteristics, pressure, electrical conductivity or chemical composition of the environment in process chamber, or one or more substances residing in bulk volume of particles located in process chamber, outside of the reactor, or of another EM Reactor system, or combination thereof.

The gathered data of measurement properties from sensors (298, 345, 728, 736, 776, 850, 950, 951, 952, 953) enables real-time adjustments to EM Reactor operation, ensuring precise control over the EM applicator systems and other reactor functions. EM applicators may serve as sensors to detect EM power, temperature, weight, humidity, motion, etc., for purposes including process verification, automation, authentication, and safety.

In the context of EM applicators, “transparent” means a material transmits EM energy without significantly altering the amplitude or phase to degrade system performance.

The transportation zone refers to the region within the process chamber of the EM Reactor where particles move between the parallel shafts of a counter-rotating twin-shaft mixer. Unlike the fluidized zone, the transportation zone does not rely on overlapping mixing vanes or near-weightless suspension. Instead, the motion of the particles is guided by the mechanical interaction of the paddles or vanes, which redistribute the material between the shafts. This zone enables consistent particle flow and redistribution, ensuring adequate exposure to EM energy as particles traverse through the chamber. The transportation zone offers an effective alternative for energy application, facilitating targeted heating or reaction processes even in the absence of a fluidized state. It supports processing adaptability across various materials and configurations while maintaining EM energy distribution and process uniformity.

The transportation zone should not be mistaken for the operation of a twin-shaft screw conveyor, which employs solid auger flights rather than paddle or ribbon mixing vanes. In a twin-shaft screw conveyor, the auger flights are primarily designed for slower, continuous forward movement of bulk material, with minimal mixing between shafts. Conversely, the twin-shaft mixer utilized in the transportation zone of the EM Reactor is equipped with paddle vanes or ribbon mixing vanes. These vanes facilitate multidirectional motion, with the central ribbon vane driving product in one direction and the outer ribbon vane moving material in the opposite direction, transferring it to the neighboring trough and shaft. This design ensures dynamic mixing and redistribution of particles, enabling uniform EM energy exposure and efficient processing within the transportation zone.

A counter-rotating twin-shaft mixer is a batch, convective, low-shear mixer with mixing vanes on twin shafts in a ‘W’-shaped trough. Counter-rotating mixing vanes transport particles from one trough to the other as well as lift particles between the shafts for mixing. With the correct overlap of mixing vanes and speed, the particles will lift and be cycled in and out of a near-weightless state for precision mixing.

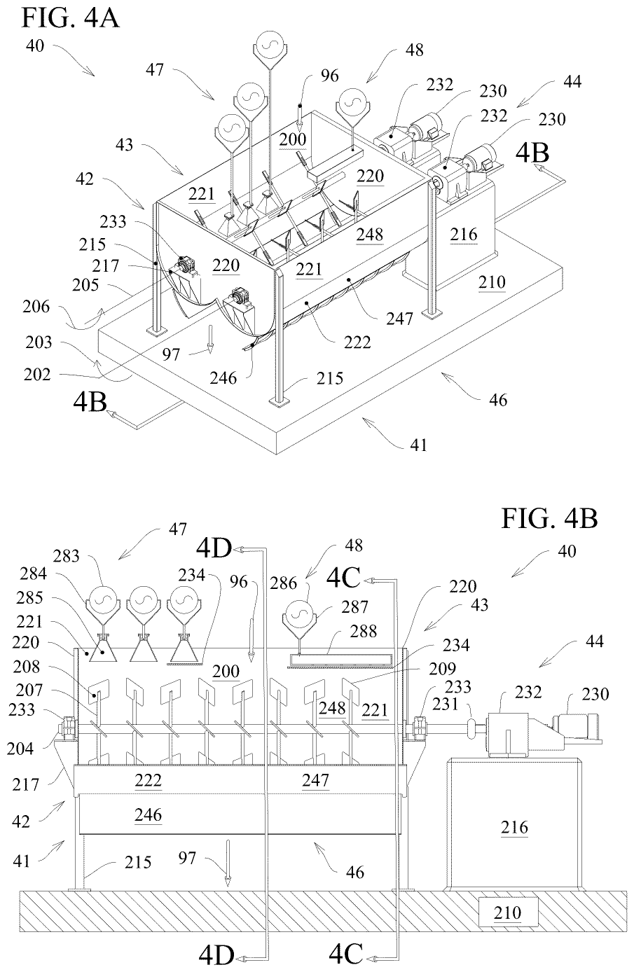

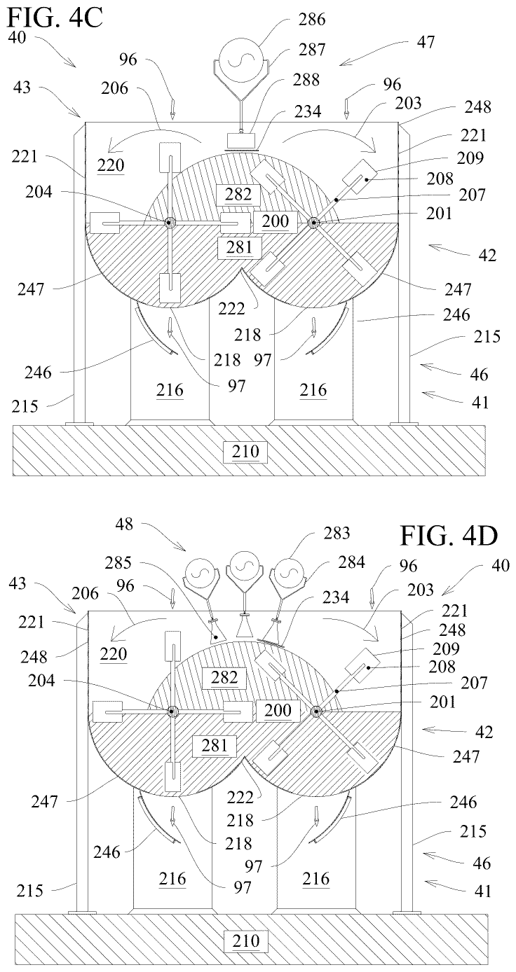

### Electromagnetic Reactor System 40 (FIGS. 4A-4D)

FIGS. 4A, 4B, 4C, and 4D present a detailed example of an electromagnetic reactor (40) according to the invention, featuring two distinct types of electromagnetic applicator systems—each equipped with at least one high-gain electromagnetic applicator (EM applicator) designed to radiate microwave energy into the fluidized zone and/or transportation zone of a twin-shaft fluidizer mixer.

FIG. 4A is an isometric view of the electromagnetic reactor system (40), showing two distinct types of EM applicator systems (47, 48) that emit EM energy into the fluidized zone (282) and/or the transportation zone (281) of a counter-rotating twin-shaft mixer (illustrated without the cover to expose internal components). FIG. 4B provides a front elevational cross-sectional view to more clearly depict the systems and their components. The end elevational cross-sectional views in FIGS. 4C and 4D illustrate the entire process chamber (200), including the transportation zone (281) and the fluidized zone (282) within the reactor (40), as well as the positioning of EM applicators (285, 288) in relation to both the fluidized zone (282) and the transportation zone (281).

The electromagnetic reactor (EM Reactor) (40) includes a ground and support structure system (41) to provide stable structural support for the housing, mechanical, and power systems; a housing system (42) to define and enclose the process chamber; a mechanical movement system (43) for moving a volume of flowable or semi-flowable particles; a power transmission system (44) to provide rotational movement to the mechanical movement system (43); a bottom gate discharge system (46) for discharging materials from the process chamber (200); and at least one of the two EM applicator systems (47, 48) designed to emit EM energy into the fluidized zone (282) and/or the transportation zone (281) of the counter-rotating twin-shaft mixer.

The purpose of the support structure system (41) of reactor (40), as depicted in FIGS. 4A through 4D, is to provide stable structural support, ensuring proper alignment, operation, and, when necessary, electrical isolation of the reactor system (40) from the ground. This system includes a ground or earth (210) and support structures (215, 216) positioned between the earth ground (210) and the housing system (42) and power transmission system (44). The supports (215, 216) may comprise any suitable structures and materials required to maintain stability between the housing system (42) and the earth (210). Additionally, the system can be designed to electrically isolate the reactor from the ground when such isolation is required for operation.

The housing system (42) of reactor (40), as depicted in FIGS. 4A through 4D, is designed to contain and protect the internal components while ensuring the controlled movement and processing of materials within the reactor. The system comprises a bottom half (222) with two adjoining rounded-bottom semicylinders (247), shaped to match the path of the mixing paddle tips (209). These semicylindrical sections (247) are adjoined to form a W-shaped trough. The top half (248) includes outer walls (221), which may be either vertical or rounded adjoining each semicylindrical section (247) of the bottom half (222). In these figures, the inlet and cover lid are omitted to better illustrate the internal EM system; however, they are shown in a subsequent figure (10A, 11A). The housing system (42) includes two end plates (220) positioned at each end of the adjoined bottom half (222) and top half (248) to fully enclose the process chamber (200). Additionally, the end plates (220) can have supports (217) for externally mounted bearings (233).

Various embodiments for the housing system depend on the application. For food products, the bottom half (222), top half (248), and end plates (220) must meet sanitation requirements. For abrasive or hard particles, suitable materials such as abrasion resistant steel or ceramics would be selected for the inner housing. The housing system could also be reflective, porcelain, or feature a liquid or gas jacket for absorption or reflection of EM energy, or for heating or cooling the process chamber.

The purpose of the mechanical movement system (43) of reactor (40), as depicted in FIGS. 4A through 4D, is to transform a non-uniform bulk volume of particles into a uniform mixture. The mechanical movement system (43) comprises two counter-rotating shafts (201, 204), each fitted with mixing paddles (208) connected via support arms (207). These shafts are mounted on bearings (233) and connected to the power transmission system (44) via couplings (231), allowing the paddles (208) to overlap effectively. Each shaft is centrally positioned within the semicylindrical sections (247) positioned within the bottom half portion (222) of the housing system (42) for rotation about the lengthwise axis of the shafts (201, 204). The outer periphery (209) of the mixing paddles (208) is close to the inside surface of their assigned semicylindrical section (247) of the bottom half (222), facing the process chamber (200), which promotes efficient mixing.

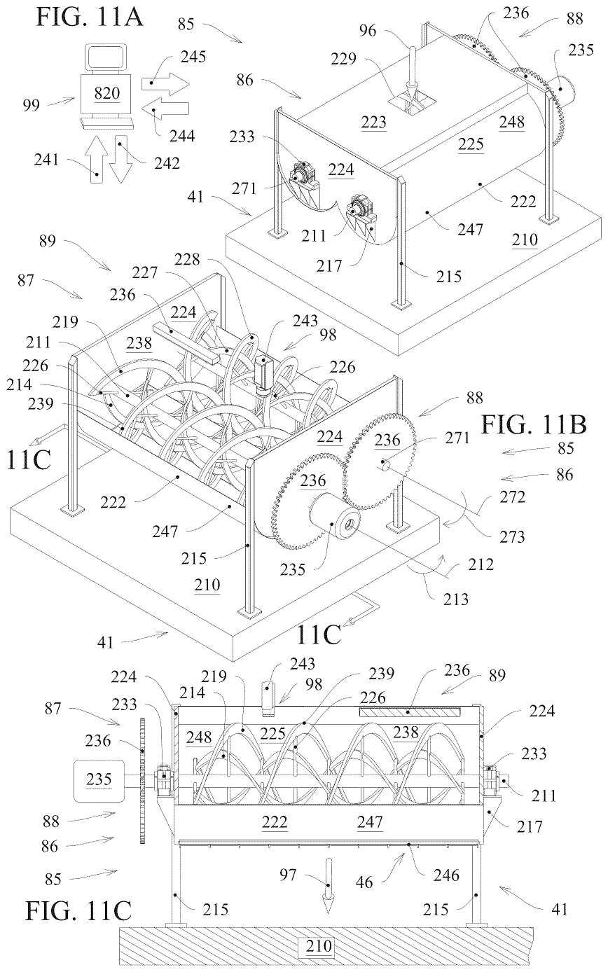

The angle of the paddles (208) is designed to promote movement, agitation, mixing, or a combination thereof of the bulk volume of particles within the chamber (200). The mixing paddles (208) are typically arranged in sets of diametrically opposed pairs, with half of the paddles rotated 90 degrees relative to the others. This arrangement creates an aligned transportation zone (281) that facilitates material movement from one trough to the other trough within the process chamber (200). The shafts (201, 204) rotate in opposite directions (203, 206) around axes (202, 205), causing the paddles (208) to move downward along the semicylindrical sections (247) of the lower housing (222) and, to a lesser extent, along the upper wall (221) of the upper half (248). As a result, the paddles (208) lift particles between and above the two shafts (201, 204), thereby creating and maintaining a transportation zone (281) and/or a fluidized zone (282), where the primary mixing action occurs. Alternatively, spiral ribbon mixing vanes, whose outside tips match the shape of the inside surface of their assigned semicylindrical sections but do not overlap, can be used instead of mixing paddle vanes, as shown in FIGS. 11B and 11C, to create only a transportation zone (281).

The power transmission system (44) of reactor (40), as shown in FIGS. 4A and 4B, provides rotational movement to the mechanical movement system (43). This system includes a motor (230), which may connect to an optional speed reduction gearbox (232), enabling precise adjustment of rotational speed. The gearbox (232), in turn, connects to coupling (231), which drives shafts (201, 204) along with the support arms (207) and mixing paddles (208).

FIGS. 4A, 4C, and 4D depict the rotation directions of the shafts, with arrows (203, 206) indicating clockwise rotation of the right shaft (201) and counterclockwise rotation of the left shaft (204) within the mechanical movement system (43). Mounted on bearings (233), the shafts (201, 204) rotate under the power transmission system (44), creating movement that facilitates near-uniform particle distribution within the process chamber (200).

The power transmission system (44) must ensure synchronized counter-rotation of the shafts to prevent overlapping paddles from colliding when a fluidized zone is required. If a separate motor is used for each shaft (201, 204), these motors (230) must be synchronized to maintain coordinated shaft rotation. Alternatively, a single motor may drive one of the shafts, with mechanical power transmission elements, such as gears, mounted on both shafts to ensure synchronous rotation (FIG. 11B). The gearbox (232) and coupling (231) are optional, as certain configurations may incorporate a variable frequency motor or a fixed-speed motor directly integrated with at least one of the two shafts (201, 204), eliminating the need for a coupling or speed reduction (FIG. 11B). While an electric motor (230) is depicted and described, the motor could be any device capable of providing rotational power to the shafts. This includes, but is not limited to, pneumatic motors, hydraulic motors, or any other suitable power source designed to achieve the desired rotational effect and support the creation of a fluidized zone or a transportation zone.

The purpose of the bottom gate discharge system (46) of reactor (40), as depicted in FIGS. 4A through 4D, is to enable the controlled release of the bulk volume of particles from the process chamber (200). This system (46) consists of a gate door (246) that, when opened, facilitates the discharge (arrow 97) of product through opening (218) at the bottom of the semicylindrical sections (247) comprising the lower half (222) of the housing system (42). Although not depicted, the discharge system (46) typically includes an actuator system responsible for opening and closing the gate door. This actuator is generally powered by air or electricity and can be activated by a computer system for automated control.

The purpose of the EM applicator systems (47, 48) of reactor (40), as depicted in FIGS. 4A to 4D, is to efficiently radiate EM energy into the fluidized zone (282) of the reactor, ensuring uniform exposure of particles within the process chamber (200). These EM applicator systems (47, 48) operate in coordination with the rotation of the mechanical movement system (43) to enhance the uniformity of particle exposure to the EM energy. One EM applicator system (47) achieves this by utilizing EM circuitry (microwave or RF) (286) connected to an EM applicator (slotted waveguide) (288) via EM circuit (287), emitting microwave electric and/or magnetic fields into the fluidized zone (282). The second system (48) employs an EM circuitry (RF or microwave) unit (283) connected to an EM applicator (horn) (285) through EM circuit (284), radiating radio frequency or microwave electric and/or magnetic fields into the fluidized zone (282) to further ensure near-uniform exposure of the particles within the process chamber (200).

The EM applicator (288) of system (47) demonstrates one potential candidate for optimally transmitting 400 MHz to 2.45 GHz EM energy into a moving mass of particles within a convective horizontal mixer: a slotted waveguide. This design provides uniform field distribution along its length, reducing hot spots and arcing risks while ensuring even energy penetration into the transportation zone (281) and/or fluidized zone (282). By carefully designing the slots, the waveguide's impedance can be matched to the load, minimizing reflections and improving efficiency. Additionally, the waveguide functions as a shielded enclosure that contains energy, reducing interactions with nearby metal surfaces. Its design can be scaled to match the size and shape of the mixer, with the slots oriented to direct energy at controlled angles, further decreasing arcing risks compared to other EM applicator designs.

FIGS. 4B, 4C, and 4D depict both EM applicators, each equipped with a radome (234) positioned between EM applicators (285, 288) and the fluidized zone (282) or transportation zone (281). The radome (234) is a structural, weatherproof enclosure designed to protect the EM applicator, constructed from materials that minimize attenuation of the transmitted or received EM signal. An optional air knife or wipers, not shown, may be included to prevent product contact or buildup on the radome (234) or EM applicators (285, 288).

### Operation of the EM Reactor System 40 (FIGS. 4A-4D)

To effectively utilize the electromagnetic reactor system (40) depicted in FIGS. 4A through 4D, it is essential to understand the dielectric characteristics of the bulk volume of particles exposed to electric or magnetic fields within the system. When designing a radio frequency dielectric heating system, careful consideration must be given to the individual and combined properties of the particles—such as conductivity and dielectric properties, including electrical permittivity—which are inherently frequency- and temperature-dependent.

To enable precise programming and operation of the electromagnetic reactor (EM Reactor) system (40), it is essential to conduct dielectric property characterization tests across various states of matter. This process involves measuring the dielectric properties of base elements, individual molecules, and complex compounds at incremental 1-degree (or other predetermined interval) temperature intervals from frozen to solid, liquid, and gas phases. Such detailed characterization allows for an understanding of how each substance interacts with electromagnetic energy (EM energy) across these states. These data-driven profiles are crucial for optimizing the reactor's control algorithms, enabling the EM Reactor to adapt its frequency, amplitude, phase, and power energy distribution in real-time based on the specific dielectric response of the material being processed. This comprehensive approach ensures that the EM Reactor can operate with high precision across a wide range of materials and conditions, maximizing efficiency and minimizing energy loss or risk of arcing.

At least one frequency should be selected based on the dielectric characteristics to excite specific atoms or molecules within the particles. The power level radiated from the radio frequency sources (283, 286) should be sufficient to excite the bulk volume within the process chamber (200) and should be determined prior to operation. The electromagnetic circuitry (EM circuitry) units (283, 286) are configured to apply signals at a predetermined power level to electromagnetic applicators (EM applicators) (285, 288), creating an electric and/or magnetic field primarily directed into the transportation zone (281) and/or fluidized zone (282).

Understanding the physical properties of the ingredients to be treated helps determine the appropriate speed of the mixing paddles (208), ensuring proper mixing and selecting adequately sized components such as motor (230), coupling (231), power transmission system (232), and bearings (233). The speed of the mechanical movement system (43) plays a critical role in establishing and maintaining the transportation zone and fluidized zone.

The power transmission system (44) activates the mechanical movement system (43), rotating shafts (201, 204) in sync—one clockwise and the other counterclockwise—about their respective rotational axes (202, 205). The bulk volume of particles enters (arrow 96) the process chamber (200), and the EM circuitry units (283, 286) begin generating EM signals, which are delivered to EM applicators (285, 288) through circuits (284, 287). These EM signals are converted into EM energy and emitted from EM applicators (285, 288) as an EM field, producing a reactive field primarily focused on the fluidized zone (282) and/or the transportation zone (281) within the process chamber (200).

The electromagnetic (EM) field induces both conductive and dielectric heating, primarily through the molecular oscillation of polar molecules within the bulk volume in the process chamber (200). The EM treatment continues until the desired temperature, biological, or chemical reaction is achieved. In some embodiments, the frequency of the EM energy delivered may be dithered, varied, or multiple frequencies may be applied during the heating or reaction process, or intermittently cycled on and off to achieve a specific heating or reaction profile.

After processing, the bulk volume of particles exits the reactor (40) (arrow 97) through a gate door (246), discharging through the opening (218) at the bottom of their semicylindrical sections (247) of the bottom half (222) of the housing system (42). Once the process chamber (200) has discharged its contents, the actuator closes the door securely, either against the semicylindrical sections (247) or against seals positioned between the gate (246) and the housing sections (247). Ideally, the power transmission system (44) and the mechanical movement system (43) should be activated before the bulk volume of particles enters the process chamber (200) (arrow 96). If particles are present in the process chamber before the activation of the mechanical movement system (43), additional energy (torque) is required to start under load.

For microwave and radio frequency applications, it is crucial to focus on the internal properties of the material rather than just the surface. To optimize the EM energy settings, material samples can be periodically extracted and physically split open to measure key internal parameters such as temperature, moisture content, and dielectric characteristics at the center of the particles. Since dielectric heating, particularly in the radio frequency and microwave spectrum, heats the material from the inside out, assessing internal conditions provides vital insights into the uniformity and efficiency of the heating process. By monitoring core temperature and moisture levels, adjustments to the EM energy—such as power output, frequency, amplitude, phase, or waveform—can be made to ensure thorough dielectric heating throughout the bulk material. This process improves heating efficiency and maintains desired reaction conditions within the reactor, fully utilizing the advantage of dielectric heating, which directly targets the material's interior rather than depending solely on surface measurements.

EM Reactor (40) exemplifies the core advantages and functionalities of the EM Reactor system, capable of operating as an apparatus, means, or method. This EM Reactor (40) design enables the precise emission of radio frequency or microwave electric and/or magnetic fields through one or more high-gain EM applicators, which can be strategically placed within the fluidized zone and/or transportation zone to achieve optimized electrical coupling and uniform energy distribution. By confining EM signals to the process chamber, EM Reactor (40) ensures safe, efficient heating while achieving near-uniform energy exposure across all particles in the bulk volume. This design is engineered for processing substantial bulk volumes efficiently, moving the material through a uniform state under optimal EM application. With the flexibility to position EM applicators (285, 288) in the ideal locations for maximum efficiency, EM Reactor (40) fully embodies the desired operational capabilities and innovative features of the EM Reactor system.

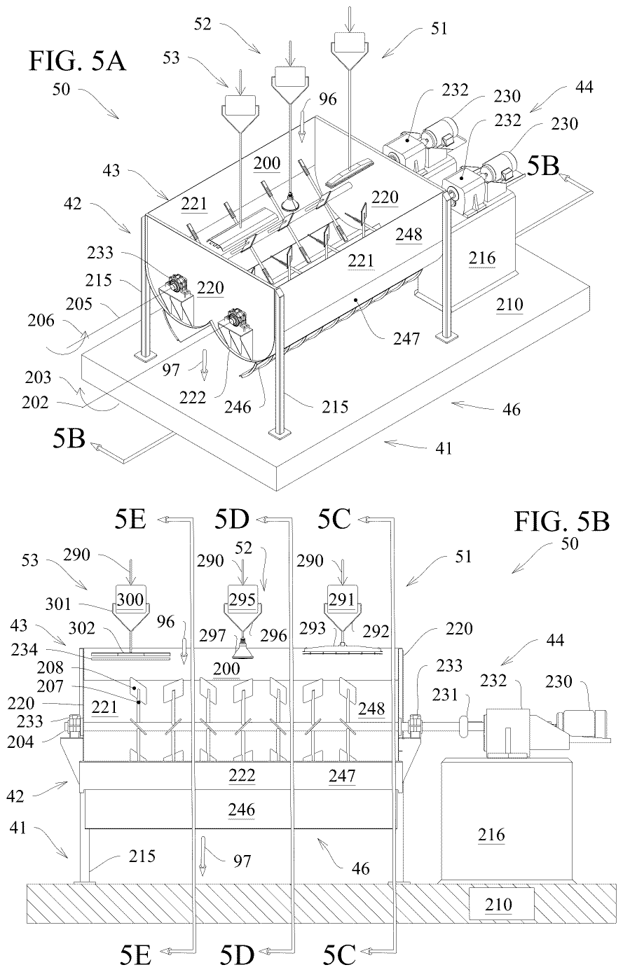

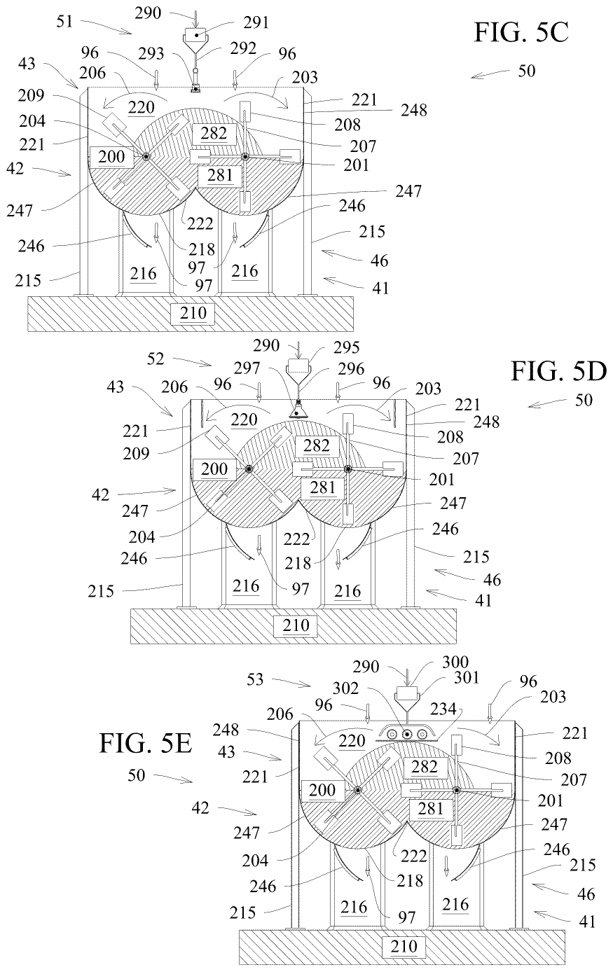

### Electromagnetic Reactor System 50 (FIGS. 5A-5E)

FIGS. 5A, 5B, 5C, 5D, and 5E present a detailed example of an electromagnetic reactor (50) according to the invention, featuring three distinct types of electromagnetic applicator systems, each designed to efficiently radiate energy in the visible, invisible, ultraviolet, or X-ray spectrum into the fluidized zone of a counter-rotating twin-shaft fluidizer mixer.

The electromagnetic reactor (EM Reactor) (50), as illustrated in FIGS. 5A through 5E, includes a support structure system (41) to provide stable structural support, a housing system (42) to define and enclose the process chamber, a mechanical movement system (43) for moving a volume of flowable or semi-flowable particles, a power transmission system (44) to provide rotational movement to the mechanical movement system (43), a bottom gate discharge system (46) for discharging materials from the process chamber, and at least one of the three electromagnetic applicator (EM applicator) systems (51, 52, 53), each designed to emit EM energy into the fluidized zone (282) and/or the transportation zone (281) of the twin-shaft mixer. The support structure system (41), housing system (42), mechanical movement system (43), power transmission system (44), and bottom gate discharge system (46) of reactor (50) are similar in structure and function to those described for EM Reactor (40).

FIG. 5A is an isometric view of the EM Reactor system (50), showcasing three distinct types of EM applicator systems (51, 52, 53). FIG. 5B provides a front elevation cross-sectional view to more clearly depict the systems and their components. The end elevational cross-sectional cutaway views in FIGS. 5C through 5E illustrate the entire process chamber (200), the transportation zone (281), and the fluidization zone (282) within reactor (50), as well as the positioning of the EM applicator (bulbs emitting infrared, visible light, invisible light, ultraviolet, and/or X-ray spectrum) (302), EM applicator (fiber optic) (297), and the EM applicator (multi-spectral light) (293) in relation to the transportation zone (281) and the fluidized zone (282).

The purpose of the EM applicator systems (51, 52, 53) of reactor (50), as depicted in FIGS. 5A through 5E, is to efficiently emit EM energy within the visible, invisible, infrared (IR), and ultraviolet (UV & UVA) spectra into the fluidized zone (282) and/or the transportation zone (281) of the counter-rotating twin-shaft mixer. EM applicator system (51) comprises an incoming power feed (290) that supplies electrical energy to an EM circuitry (291). This EM circuitry (291) may control, convert, or generate the voltage, power, phase, frequency, and/or duration of time that the energy is supplied via EM circuit (292) to an EM applicator (such as an LED emitter, bulb, or another device that emits energy in the IR, visible, invisible, or UV spectrum) (293). The second system (53) consists of three EM applicators (bulbs) (302), which emit light EM energy and are connected to an EM circuitry (control panel) (300) through EM circuits (301). EM applicator system (53) comprises an incoming power feed (290) that supplies electrical energy to an EM circuitry (300).

The EM Reactor system (50) may incorporate a fiber optic light EM applicator system (52) designed to deliver precise and controlled light energy into the transportation zone (281) and/or fluidized zone (282) of the process chamber (200). EM applicator system (52) comprises an incoming power feed (290) that supplies electrical energy to an EM circuitry (295). This system comprises an EM circuitry (light generator/controller) (295) that generates EM energy across a wide range of wavelengths, including infrared, visible, invisible, and/or ultraviolet light. The EM circuitry (295) may include components such as solid-state or diode lasers, light-emitting diodes (LEDs), or broad-spectrum light sources that can be modulated to produce specific wavelengths and intensities as required by the application.

The generated light is transmitted through an EM circuit (high-quality optical fibers) (296), which are strategically positioned to direct light energy into the transportation zone (281) and/or fluidized zone (282). These fibers can be configured in arrays or as individual strands to ensure uniform energy delivery to the bulk volume of particles. The EM circuit (296) may deliver light directly, but an optional EM applicator (297) can be used at the fiber optic endpoint to enhance or modify the emitted light. This configuration allows for versatility in controlling light distribution and emission characteristics to achieve precise and uniform energy delivery.

The EM applicator (fiber optic light) system (52) in the EM Reactor system (50) is designed to deliver light into the transportation zone (281) and/or fluidized zone (282) with high precision and versatility. At its simplest, the EM circuit (fiber optic) (296) can emit light directly from its end without the need for additional components. This direct emission method ensures minimal light loss and enables precise targeting of particles or specific areas within the transportation zone (281) and/or fluidized zone (282). Alternatively, the EM circuit (fiber optic) can be equipped with a terminal device (297), such as a lens, diffuser, or prism, to manipulate the light for specific applications. These devices can focus the light for high-intensity targeting, diffuse it for uniform distribution across a broader area, or split the beam for multi-angle or multi-wavelength applications. Whether used in its simplest form or with an added terminal device (297), the EM applicator system (fiber optic light) (52) provides a flexible solution for delivering controlled light energy, enabling applications ranging from heating and chemical activation to real-time particle analysis and contamination detection.

The EM applicator (fiber optic) system (52) offers several advantages, including precise control over light delivery, reduced risk of interference with other EM fields, and the ability to position the fiber ends in optimal locations within the transportation zone (281) and/or fluidized zone (282). Additionally, the fiber optic system can be coupled with multi-spectral light sources, enabling advanced applications such as fluorescence imaging, real-time reaction monitoring, and selective excitation of specific materials or compounds. The EM circuitry (295) can dynamically adjust the wavelength, intensity, and timing of the emitted light based on data received from the sensing system, ensuring that the energy delivery is continuously optimized for the specific processing requirements. This design enhances the reactor's versatility and capability to process a wide range of materials while maintaining high efficiency and precision.

### Operation of the EM Reactor System 50 (FIGS. 5A-5E)

To effectively use electromagnetic reactor system (50), depicted in FIGS. 5A through 5E, it is crucial to understand the optical characteristics of the bulk volume of particles that will be exposed to various light fields within the system. When designing a light-based heating or treatment system, factors like color, reflectivity, and absorption properties—each influenced by particle composition and structure—must be carefully considered to ensure optimal energy transfer and uniform exposure across the material.

To enable precise programming and operation of the Electromagnetic Reactor (EM Reactor) System (50), it is essential to conduct color and absorption characterization tests across various material states. This involves measuring the specific absorption spectra, reflectance, and transmissivity of base elements, individual molecules, and complex compounds at incremental 1-degree (or other predetermined interval) temperature intervals across frozen, solid, liquid, and gas phases. These detailed profiles inform the reactor's control algorithms, allowing adjustments to light intensity, wavelength, and distribution in real-time based on the unique optical response of the material being processed.

An optical pyrometer is one sensor that can be utilized outside the process chamber to measure the color or brightness of samples extracted from the material. Given the rapid movement of materials within the twin-shaft mixer, real-time in-chamber optical measurements may not always provide reliable data. As a result, periodic sampling using a plunger-style extraction mechanism (not shown) is conducted, allowing the optical pyrometer to assess the color characteristics of the material. Based on these measurements, adjustments to the EM energy settings—such as intensity, duration, position of the applicator, and wavelength—can be made to fine-tune the reactor's processing conditions. These adjustments ensure optimal energy distribution across the fluidized zone (282) and/or the transportation zone (281), enhancing the efficiency of the desired reactions within the process chamber (200).

Understanding the physical properties of the ingredients to be treated helps determine the appropriate speed of the mixing paddles (208), ensuring proper mixing and selecting adequately sized components such as motor (230), coupling (231), power transmission system (232), and bearings (233). The length and speed of the mechanical movement system (43) influence the residence time, which correlates to the exposure time to the EM energy field.

The power transmission system (44) is activated to rotate the mechanical movement system (43) about rotational axes (202, (205). The bulk volume of particles enters (arrow 96) the process chamber (200), and the EM circuitry (control panels) (291, 295, 300) begin converting, generating, and/or controlling EM energy, which is delivered to the EM applicators—such as bulbs or ceramic radiators—(293, 297, 302) through EM circuits (292, 296, 301). EM applicators (293, 297, 302) emit visible light, invisible light, infrared, and/or ultraviolet light, producing a reactive field within the process chamber (200). The treatment continues until the desired temperature, biological, or chemical reaction is achieved. These EM applicator systems operate in coordination with the rotation of the mechanical movement system to enhance the uniformity of particle exposure to the EM energy. In some embodiments, the power of the EM energy delivered is varied during the heating process (or intermittently cycled on and off) to achieve a desired heating or reaction profile.

The bulk volume of particles then exits (arrow 97) reactor (50) through the discharge gate (246). Ideally, the power transmission system (44) and mechanical movement system (43) are activated before the bulk volume of particles enters (arrow 96) the process chamber (200). If particles are present in the process chamber (200) before the activation of the mechanical movement system (43), additional energy (torque) is required to start under load.

EM Reactor (50) introduces additional novel features to the EM Reactor system, specifically tailored to advanced light-based applications. This reactor is designed to emit precise infrared, visible, invisible, ultraviolet, and/or x-ray light fields directly into the transportation zone (281) and/or fluidized zone (282), enhancing the versatility and precision of the EM heating process. Unlike previous configurations, EM Reactor (50) utilizes specialized EM applicator devices such as high-intensity bulbs, fiber-optic systems, and multi-spectral LEDs, which can be strategically positioned for maximum coupling efficiency and even distribution across a broader EM spectrum. This configuration allows for finely tuned EM energy application, capable of targeting specific frequencies and wavelengths that align with the absorption properties of various materials, thereby maximizing EM energy transfer and minimizing waste.

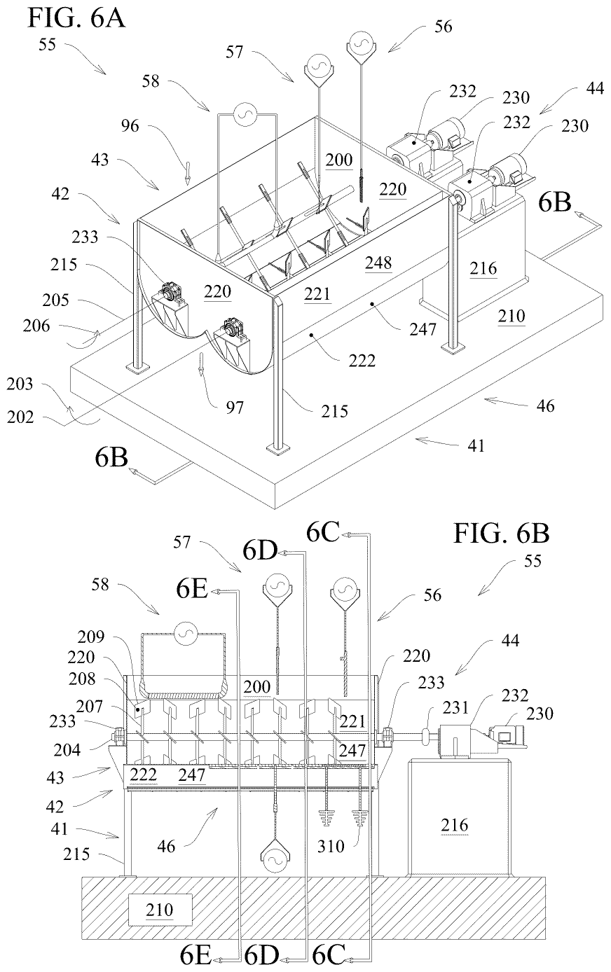

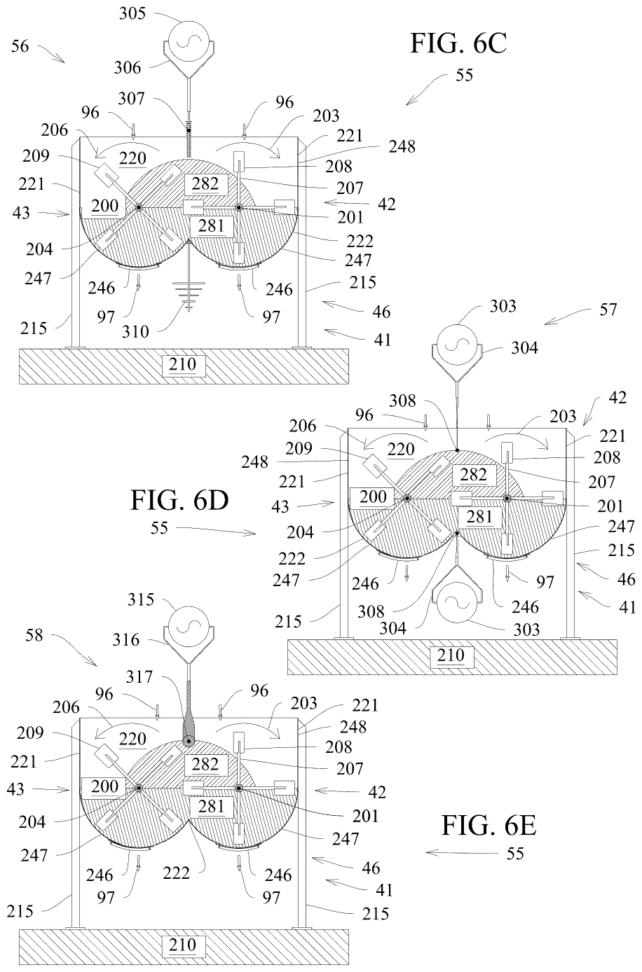

### Electromagnetic Reactor System 55 (FIGS. 6A-6E)

FIGS. 6A, 6B, 6C, 6D, and 6E present a detailed example of an electromagnetic reactor (55) according to the invention, featuring three distinct types of electromagnetic applicator systems, each designed to radiate microwave or radio frequency electric and/or magnetic fields into the fluidized zone and/or transportation zone of a counter-rotating twin-shaft mixer.

The electromagnetic reactor (EM Reactor) (55), as illustrated in FIGS. 6A through 6E, includes a support structure system (41) to provide stable structural support for the housing, mechanical, and power systems; a housing system (42) to define and enclose the process chamber; a mechanical movement system (43) for moving a volume of flowable or semi-flowable particles; a power transmission system (44) to provide rotational movement to the mechanical movement system (43); a bottom gate discharge system (46) for discharging materials from the process chamber; and at least one of the three EM applicator systems (56, 57, 58), which emit electromagnetic energy (EM energy) into the transportation zone (281) and/or the fluidized zone (282) of the counter-rotating twin-shaft mixer. The support structure system (41), housing system (42), mechanical movement system (43), power transmission system (44), and bottom gate discharge system (46) of reactor (55) are similar in structure and function to those previously described for EM Reactor (40) in FIGS. 4A through 4D.

FIG. 6A is an isometric view of the EM Reactor system (55), showcasing three distinct types of EM applicator systems (56, 57, 58) that radiate a microwave and/or radio frequency electric and/or magnetic field into the transportation zone (281) and/or fluidized zone (282) of the counter-rotating twin-shaft mixer (illustrated without the cover to expose internal components). FIG. 6B provides an end elevational cross-sectional view to more clearly depict the systems and their components. The cross-sectional views in FIGS. 6C through 6E illustrate the entire process chamber (200), the transportation zone (281), and the fluidized zone (282) within reactor (55), as well as the positioning of the EM applicators (307, 308, 317) in relation to the transportation zone (281) and fluidized zone (282).

The purpose of the electromagnetic applicator (EM applicator) systems (56, 57, 58) of reactor (55), as depicted in FIGS. 6A through 6E, is to efficiently emit microwave and/or radio frequency electric and/or magnetic fields into the transportation zone (281) and/or fluidized zone (282) of reactor (55), ensuring uniform exposure of particles within the process chamber (200). These EM applicator systems (56, 57, 58) operate in coordination with the rotation (203, 206) of the mechanical movement system (43) to enhance the uniformity of particle exposure to EM energy. Applicator system (56) achieves this by utilizing EM circuitry (RF or microwave signal generator) (305) connected to an EM applicator (Yagi directional) (307) via an EM circuit (306), with a ground (310) connected to the bottom of the mixer housing to promote the propagation of the signal from above the fluidized zone (282) to the bottom of the mixer. The second applicator system (57) includes EM circuitry (microwave or radio frequency) (303) connected via an EM circuit (304) to EM applicators (monopole antenna) (308) positioned both above and below the transportation zone (281) and fluidized zone (282), operating 180 degrees out of phase to ensure the signal penetrates effectively through both zones. The third applicator system (58) includes EM circuitry (radio frequency) (315) connected via an EM circuit (316) to an EM applicator (lossy cable) (317), positioned above the transportation zone (281) and/or fluidized zone (282) to emit eddy currents into the process chamber (200), enhancing the uniformity of EM energy distribution.

### Operation of the EM Reactor System 55 (FIGS. 6A-6E)

The operation of EM Reactor (55) is substantially similar to that of EM Reactor (40), as described in its operation section. It utilizes dielectric property characterization to optimize RF and microwave energy application, ensuring efficient and uniform heating of particles within the fluidized zone. All core processes, including EM energy emission, mechanical movement, particle transport, and heating, follow the principles outlined for EM Reactor 40.

FIGS. 6A through 6E illustrate distinct embodiments of the EM Reactor system (55), showcasing specialized EM applicator configurations designed to maximize EM energy efficiency and control within the transportation zone (281) and/or fluidized zone (282). The Yagi directional EM applicator (307), positioned to emit radio frequency and microwave energy into the transportation zone (281) and/or fluidized zone (282), pairs with an earth-grounded insulated metallic object at the base of the chamber. This setup confines and channels energy along a directed path, ensuring focused application rather than dispersing into free space. The design also includes a monopole EM applicator (308) configuration, with EM applicators positioned above and below the transportation zone (281) and fluidized zone (282) to facilitate EM energy communication between two dipoles, enabling consistent energy transfer and controlled particle exposure. Additionally, a lossy cable EM applicator (317), mounted above the transportation zone (281) and/or fluidized zone (282), introduces low-frequency eddy currents. Although less efficient, this arrangement allows controlled low-frequency energy application, providing versatility in treating materials with specific conductive or dielectric properties. Collectively, these configurations offer a broad range of energy application options tailored to meet diverse processing requirements within the EM Reactor.

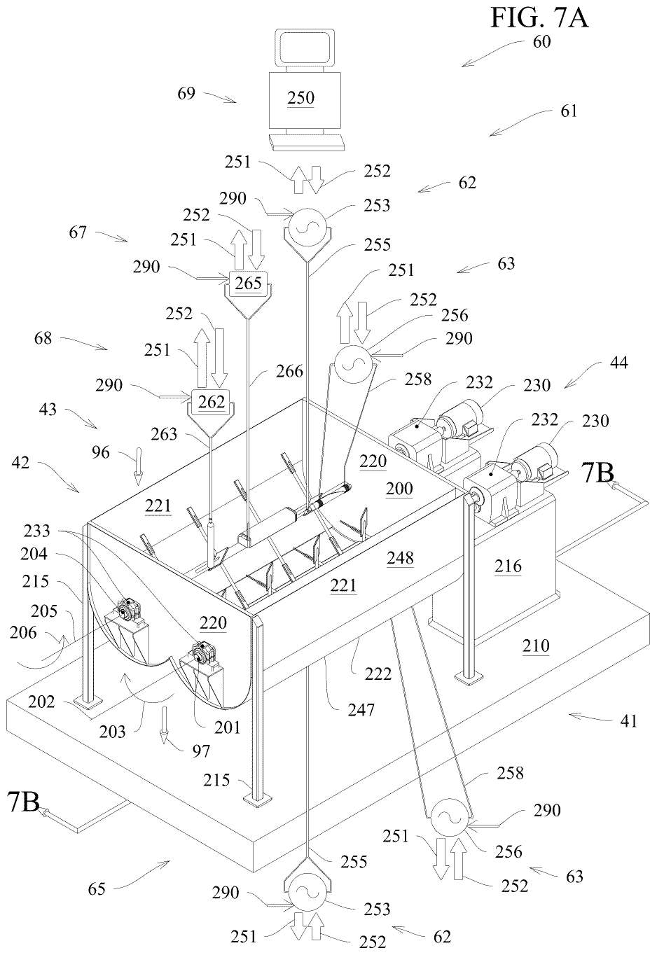

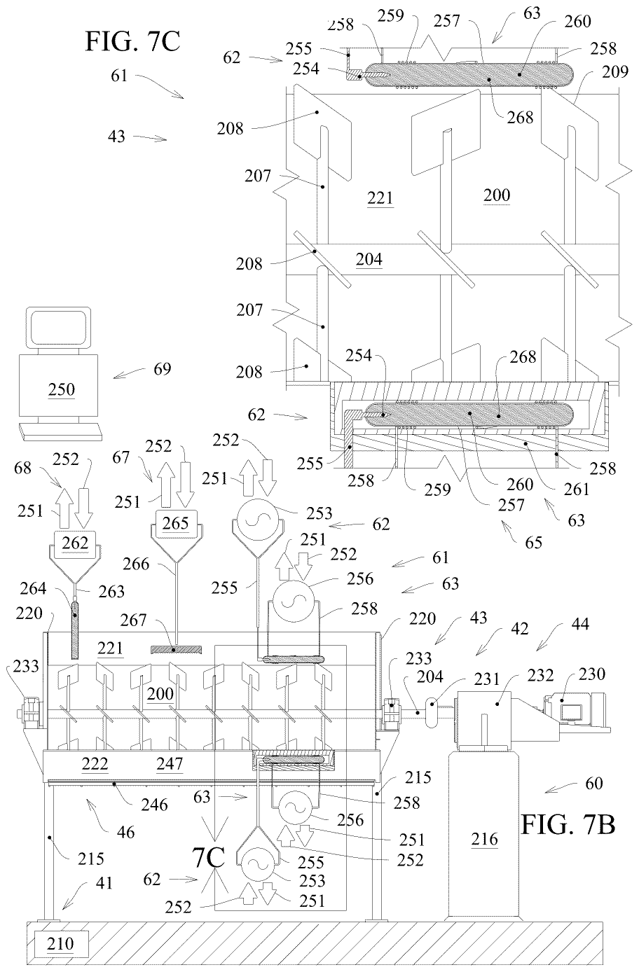

### Electromagnetic Reactor System 60 (FIGS. 7A-7C)

FIGS. 7A, 7B, and 7C illustrate a detailed embodiment of an electromagnetic reactor (60) according to the invention, featuring three distinct types of electromagnetic applicator systems. These systems are designed to expose a bulk volume of particles within the transportation zone and/or fluidized zone of a counter-rotating twin-shaft mixer to electric and/or magnetic fields, as well as to infrared, visible, invisible, and/or ultraviolet light. Each electromagnetic applicator system operates in coordination with the mechanical movement system to ensure precise control of the EM energy emitted into the transportation zone and/or fluidized zone.

The electromagnetic reactor (EM Reactor) (60), as illustrated in FIGS. 7A through 7C, includes a support structure system (41) to provide stable structural support for the housing, mechanical, and power systems; a housing system (42) to define and enclose the process chamber (200); a mechanical movement system (43) for moving a volume of flowable or semi-flowable particles; a power transmission system (44) to provide synchronized rotational movement to the mechanical movement system (43); a bottom gate discharge system (46) for discharging materials from the process chamber; and at least one of the three electromagnetic applicator systems (61, 67, 68), which emit EM energy into the transportation zone and/or the fluidized zone of the counter-rotating twin-shaft mixer. The support structure system (41), housing system (42), mechanical movement system (43), power transmission system (44), and bottom gate discharge system (46) of reactor (60) are similar in structure and function to those described for EM Reactor (40). The transportation zone and fluidized zone have been previously described and referenced in earlier figures.

FIG. 7A is an isometric view of the EM Reactor system (60), showcasing three distinct types of electromagnetic applicator (EM applicator) systems (61, 67, 68) that emit radio frequency (3 kHz to 300 GHz, wavelengths from 100 km to 1 mm), microwaves (300 MHz to 300 GHz, wavelengths from 1 m to 1 mm), infrared (300 GHz to 400 THz, wavelengths from 1 mm to 750 nm), visible (430 THz to 770 THz, wavelengths from 700 nm to 390 nm), invisible (covering both the infrared and ultraviolet spectrums outside visible light), or ultraviolet (750 THz to 30 PHz, wavelengths from 400 nm to 10 nm) EM energy into the transportation zone and/or fluidized zone of a counter-rotating twin-shaft mixer (illustrated without the cover to expose internal components). FIG. 7B provides a front elevational cross-sectional view to more clearly depict the systems and their components. FIG. 7C provides an enlarged elevational cutaway view to more clearly depict the plasma EM applicator (260) of system (61) and the optional EM applicator system (63).

The purpose of the EM applicator systems (61, 67, 68) of EM Reactor (60), as depicted in FIGS. 7A through 7C, is to efficiently radiate EM energy into the transportation zone and/or fluidized zone, ensuring uniform exposure of particles within the process chamber (200). These EM applicator systems (61, 67, 68) operate in coordination with the rotation (203, 206) of the mechanical movement system (43) to enhance the uniformity of particle exposure to the EM energy.

The EM applicator system (microwave/radio frequency) (61) comprises an EM applicator (plasma) system (62) designed to emit electromagnetic energy into the fluidized zone and/or the transportation zone. The EM applicator system (62) includes a transparent tube (257) (typically made of fused quartz) filled with a noble gas (268) or a gas suitable for ionization to form a plasma EM applicator (260). An ionizer (254) is inserted into the tube and connected via an EM circuit (255) to an EM circuitry (253), which provides the necessary electrical energy to ionize the gas (268), forming the plasma EM applicator (260). The plasma EM applicator system (62) can optionally include additional circuitry (63), comprising EM circuitry (256), circuit (258), and coupler (259). The signal is transmitted from the circuitry (256) via the EM circuit (258) to the coupler (259), which is connected to the plasma EM applicator (260), enabling it to emit additional frequencies into the fluidized zone and/or the transportation zone. Additionally, a second similar system (65) can be installed at the bottom of the mixer to create a dipole effect with two plasma EM applicators, directing energy through both the fluidized zone and transportation zone of the mixer. The plasma EM applicator (260) in the second system (65) may require insulation (261) to ensure electrical isolation from the housing system (42). Alternatively, the circuitry (63) can be configured as a laser that emits energy into the plasma EM applicator (260).

The second EM applicator system (67) of reactor (60), as depicted in FIGS. 7A and 7B, includes an EM circuitry (energy converter or controller) (265) connected to an EM applicator (light radiator) (267) via an EM circuit (266). An incoming power feed (290) supplies electrical energy to the EM circuitry (265), which converts and regulates the electricity as necessary. The EM circuitry (265) delivers the processed energy through the EM circuit (266) to the EM applicator (light radiator) (267), which emits light—infrared, visible, invisible, or ultraviolet—into the transportation zone and/or fluidized zone of the counter-rotating twin-shaft mixer.

The third EM applicator system (68), as depicted in FIGS. 7A and 7B, includes an EM circuitry (pump light generator) (262) connected to a gain medium (264) via an EM circuit (263) to produce a laser beam directed into the fluidized zone and/or transportation zone of the twin-shaft mixer. The system comprises an incoming power feed (290) that supplies electrical energy to the EM circuitry (262). The EM circuitry (262) energizes the gain medium (264), which emits coherent light at specific wavelengths. This laser EM energy, typically within a narrow range of visible, infrared, or ultraviolet wavelengths, enables precise and focused energy delivery into the transportation and/or fluidized zone.

Emitting a laser into the fluidized zone and/or transportation zone of the process chamber (200), with or without the presence of plasma, offers significant benefits in terms of energy precision, particle-level control, and processing efficiency. When used without plasma, a laser—especially a pulsed laser—delivers highly localized energy to individual particles, achieving precise, rapid surface treatment with minimal bulk heating, thus preserving material integrity. In the presence of plasma, whether within the process chamber or in an EM applicator like (63), the laser's interaction is amplified. The plasma acts as an energy-carrying medium that surrounds each particle, enhancing uniform energy distribution and optimizing chemical or molecular transformations. This dual-mode capability, with the option of plasma amplification, enables the reactor to perform finely controlled reactions and selective treatments, achieving efficient energy transfer with reduced overall power requirements.

The purpose of the computer system (69) in reactor (60), as depicted in FIGS. 7A and 7B, is to provide precise control and optimization of the EM applicator systems (61, 63, 67, 68) and other operational components within the reactor. The computer system (69) includes one or more computers (250) equipped with an input bus (251) and an output bus (252), or combinations thereof. The computer (250) is designed to receive and store multiple property data measurements in its memory, analyze these measurements, and determine relationships between them. By processing this data, the computer (250) can generate output control signals based on sensed measurement data, stored data, programmed algorithms, or recently sensed measurement input signals. These control signals are then sent to systems such as the EM circuitry systems (61, 63, 67, 68), the power transmission system (44), discharge system (46), or combinations thereof, to ensure the efficient and effective operation of the EM Reactor system (60).

### Operation of the EM Reactor System 60 (FIGS. 7A-7C)

The operation of electromagnetic reactor (60) is substantially similar to that of Reactors 40 and 50, as described in its operation section. It utilizes dielectric property and color characterization to optimize RF, microwave, infrared, and light energy application, ensuring efficient and uniform heating of particles within the transportation zone and/or fluidized zone. All core processes, including EM energy emission, mechanical movement, particle transport, and heating, follow the principles outlined for Reactors 40 and 50.

The electromagnetic reactor (EM Reactor) (60) represents an advanced embodiment of the EM Reactor, incorporating four distinct EM applicator systems (61, 63, 67, 68), designed for enhanced versatility and precision in energy delivery. The first system (61) utilizes a plasma electromagnetic applicator (EM applicator) (260), where a noble or ionizable gas (268) within a transparent quartz tube (257) is energized to create a formed plasma (260). This plasma EM applicator (260) emits variable electromagnetic frequencies throughout the fluidized zone and/or transportation zone, with an optional dipole configuration for targeted, bidirectional energy flow. The second system (67) employs an EM applicator (light radiator) (267) that emits a range of light frequencies—including infrared, visible, invisible, and ultraviolet—into the fluidized zone and/or transportation zone, facilitating diverse photonic reactions for applications such as sterilization, surface treatment, and photochemical reactions. The third system (68) introduces a laser beam generator (264) that directs a narrow spectrum of coherent light at specific wavelengths into the fluidized zone and/or transportation zone, allowing highly targeted energy application for processes requiring extreme precision, such as material modification at the particle level. Altogether, the integrated systems of EM Reactor (60) enable multi-spectral energy delivery, maximizing process adaptability and precision, and creating a versatile environment that can accommodate a wide array of chemical, biological, and material processing needs.

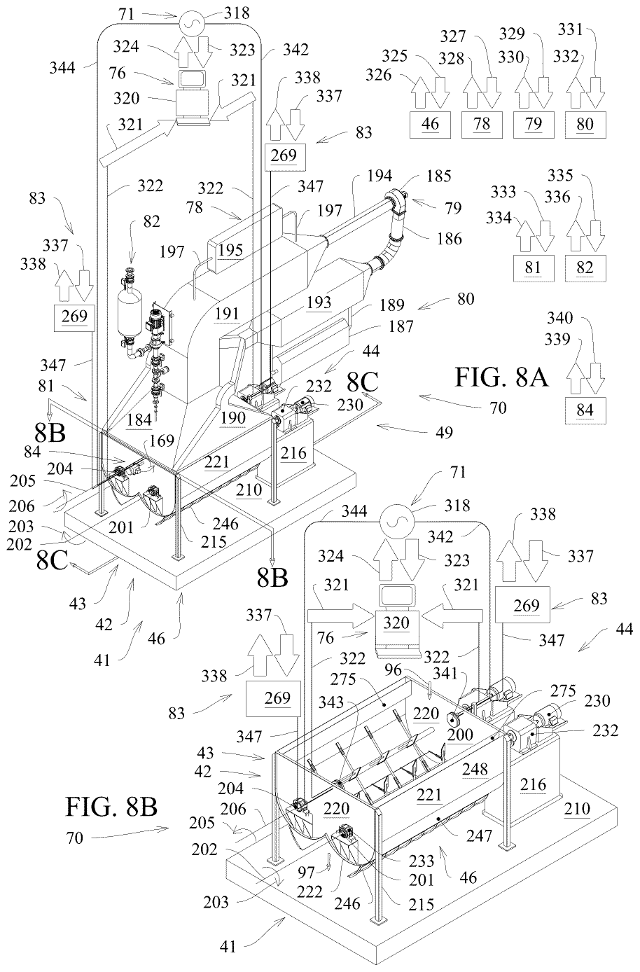

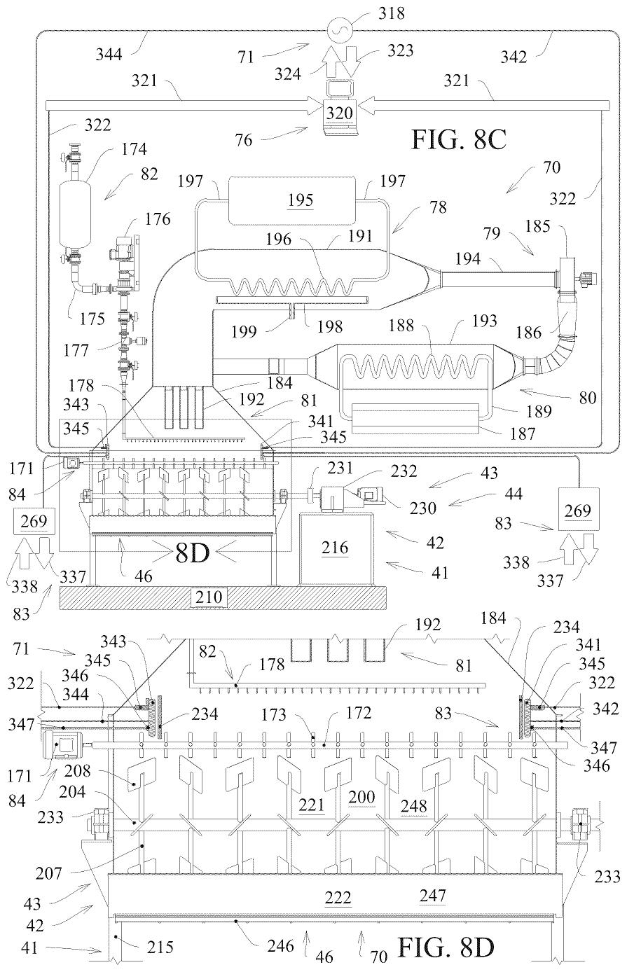

### Electromagnetic Reactor System 70 (FIGS. 8A-8D)

FIGS. 8A, 8B, 8C, and 8D illustrate a detailed example of an electromagnetic reactor (70) according to the invention, designed to radiate radio frequency and microwave electric and/or magnetic fields (EM energy) into the transportation zone and/or fluidized zone of a counter-rotating twin-shaft mixer. This reactor incorporates various auxiliary systems, including thermal airflow heating for moisture removal, cooling air for moisture condensation and extraction, a closed-loop air system, electromagnetic applicator cooling mechanisms, fluid addition capabilities, deagglomeration, and computer control systems, ensuring efficient and controlled processing.

The electromagnetic reactor (EM Reactor) (70), as illustrated in FIGS. 8A through 8D, includes a support structure system (41) to provide stable structural support for the housing, mechanical, and power systems; a housing system (42) to define and enclose the process chamber; a mechanical movement system (43) for moving a volume of flowable or semi-flowable particles; a power transmission system (44) to provide rotational (203, 206) movement to the mechanical movement system (43); a bottom gate discharge system (46) for discharging materials from the process chamber (200); and one electromagnetic applicator (EM applicator) system (71), which emits radio frequency (3 kHz to 300 GHz, wavelengths from 100 km to 1 mm) or microwave (300 MHz to 300 GHz, wavelengths from 1 m to 1 mm) EM energy into the transportation zone and/or fluidized zone of the counter-rotating twin-shaft mixer. The support structure system (41), housing system (42), mechanical movement system (43), power transmission system (44), and bottom gate discharge system (46) of reactor (70) are similar in structure and function to those previously described for reactor (40). The transportation zone and fluidized zone have been previously described and referenced in earlier figures.

Auxiliary systems of EM Reactor (70) include an airflow cooling system (78) to cool hot air and remove moisture; an air movement system (79) that facilitates closed-loop airflow through the process chamber (200) and auxiliary systems; an air heating system (80) to heat air before entering the process chamber (200); an air filtration system (81) to remove particulates from the airstream; a fluid addition system (82), allowing fluids to be introduced into the process chamber (200), the transportation zone, and/or the fluidized zone, sometimes during the operation of EM applicator system (71); an EM applicator cooling system (83) that regulates the temperature of EM applicators (341, 343); and a deagglomeration system (84) incorporated to break apart particulate matter forming lumps or agglomerates, or to impact particles while the EM applicator system (71) emits EM energy into the transportation zone and/or fluidized zone. Direction arrow (169) shows the rotational direction of the deagglomeration system.

FIG. 8A presents an isometric view of the EM Reactor (70), specifically designed to expose a bulk volume of particles to a microwave or radio frequency electric and/or magnetic field within the transportation zone and/or fluidized zone of a counter-rotating twin-shaft mixer. FIG. 8B provides a similar isometric view but with the air movement system (79), air heating system (80), air duct (190), collection hood (184), fluid addition system (82), air chilling system (78), and deagglomeration system (84) removed, revealing the EM applicators (341, 343) of the EM applicator system (71) within the housing system (42). FIG. 8C offers an enlarged front elevational cross-sectional view of FIG. 8A, providing a clearer view of the internal components across the various systems. FIG. 8D further enlarges the cross-sectional view of FIG. 8C, highlighting the mechanical movement system (43), EM applicators (341, 343), and sensors (345) of the EM applicator system (71), as well as the EM applicator cooling system (83), the spray manifold (178) of the fluid addition system (82), and the entirety of the deagglomeration system (84).

The purpose of the EM applicator system (71) in reactor (70), as depicted in FIGS. 8A through 8D, is to efficiently radiate EM energy into the transportation and/or fluidized zone, ensuring uniform exposure of particles within the process chamber (200). This EM applicator system (71) operates in coordination with the rotation (203, 206) of the mechanical movement system (43) to enhance the uniformity of particle exposure to the RF or microwave electric and/or magnetic fields (EM energy). The system includes an EM circuitry (microwave/RF signal generating) (318) with a forward EM circuit (342) connected to EM applicator (341) and a reverse EM circuit (344) connected to EM applicator (343), arranged in a dipole configuration. System (71) transmits sensory information through input bus (323) to the computer system (76) and receives control signals from output bus (324). Additionally, system (71) may include a sensor (345) positioned on or near EM applicators (341, 343), with EM circuit (322) connected to the input bus (321), providing feedback for precise control of the radiated energy.

The computer system (76) in reactor (70), as depicted in FIGS. 8A through 8C, is designed to provide precise control and optimization of the EM applicator system (71) and other operational components within the reactor. The computer system (76) includes one or more computers (320) with multiple input buses (321, 323, 326, 328, 330, 332, 334, 336, 338, 339) and output buses (324, 325, 327, 329, 331, 333, 335, 337, 340), or combinations thereof. The computer (320) receives and stores multiple property data measurements in its memory and determines relationships between these measurements. By operating the computer (320), relationships between sensed measurement data, stored data, a programmed algorithm, or recently sensed measurement signals are used to generate output control signals to systems selected from EM applicator system (71), power transmission system (44), gate discharge system (46), air chiller system (78), air movement system (79), air heating system (80), air filtration system (81), fluid addition system (82), EM applicator cooling system (83), and/or deagglomeration system (84), or combinations thereof, to control and optimize the operation of the EM Reactor system (70).

The air movement system (79) in reactor (70), as depicted in FIGS. 8A and 8C, is designed to provide the necessary airflow and static pressure to circulate air throughout the entire system, ensuring efficient operation. This air movement system (79) comprises an input bus (329), an output bus (330), at least one fan (185), an air duct (186) that connects the fan (185) to the air heating system (80), air ducting (193) that passes through the heating system, and baffled ducting (190) that directs airflow down a baffle (275 FIG. 8B) on both sides of the mixer and into the transportation zone and/or fluidization zone of the process chamber (200). The air is then captured by an air hood (184) of the air filtration system (81), where it is filtered, passed through the chilling system (78) to remove moisture, and subsequently returned to the fan (185) by passing through ducting (194) of the air movement system (79). The system facilitates closed-loop airflow through the thermal air heating system (80), directing heated air into the transportation zone and/or fluidization zone.

The heating system (80), as depicted in FIGS. 8A and 8C, is designed to elevate the airflow temperature for efficient processing within the process chamber (200). This system (80) includes an input bus (331), an output bus (332), air ducting or housing (193), and a heat generator (187). Pipes (189) transfer heat energy to coils (188), which then heat the airflow in air ducting (193) and then the heated airflow passes through baffled ducting (190) that directs airflow down a baffle (275 FIG. 8B) on both sides of the mixer and into the transportation and/or fluidization zone of the process chamber (200). Alternatively, the coils (188) can be directly heated using electrical resistance within the coils, bypassing the need for heat transfer through pipes (189).

Additionally, the air filtration system (81), as depicted in FIGS. 8A, 8C, and 8D, is integrated to ensure clean air circulation within the EM Reactor (70). It consists of an air capture hood (184) and filtration bags or media (192), which remove particulate matter from the air. Air movement created by fan (185) moves air through the filtration media (192), effectively removing airborne particulates. The air is captured from the process chamber (200) by an air hood (184), filtered (192), and directed to the chilling system (78) to remove moisture before being returned to the fan (185) through ducting (194).

The fluid addition system (82), as depicted in FIGS. 8A, 8C, and 8D, ensures precise and uniform distribution of liquids or fluids onto particles within the transportation zone and/or fluidization zone. This system includes an input bus (335), an output bus (336), a fluid storage container (174), a fluid pump (176), piping (175), fluid controls (177), and a spray manifold (178). These components evenly disperse fluids onto particles in near-weightlessness within the fluidized zone, or less effectively in the transportation zone. Fluids may be added before, during, or after EM energy is applied to the transportation zone and/or fluidization zone, depending on the desired processing outcome.

### Operation of the EM Reactor System 70 (FIGS. 8A-8D)

The operation of electromagnetic reactor (EM Reactor) (70) is substantially similar to that of Reactor (40), as described in its respective operation section. EM Reactor (70) utilizes dielectric property characterization to optimize the application of microwave and radio frequency electric and/or magnetic fields, ensuring efficient and uniform heating of particles within the fluidized zone and/or transportation zone. All core processes, including electromagnetic (EM) energy emission, mechanical movement, particle transport, and heating, adhere to the principles established for Reactor (40).

The computer system (76) of Reactor (70) processes input from various sensors, including temperature, EM power, color, weight, humidity, motion, dielectric characteristics, pressure, electrical conductivity, and chemical composition, enabling real-time adjustments to reactor operation. Based on this information, the computer system adjusts the power output, frequency, phase, amplitude, waveform, duration, and other parameters of the EM applicator system (71) to maintain optimal processing conditions. The computer system (76) controls other primary systems such as power transmission system (44) and gate discharge (46) as well as also controlling auxiliary systems such as the air movement system (79), air chilling and water removal system (78), air heating system (80), air filtration system (81), fluid addition system (82), EM applicator cooling system (83), and deagglomeration system (84).

The air movement system (79) circulates heated air through the thermal air heating system (80) into the fluidized zone, assisting in moisture removal by carrying away evaporated water vapor, which is condensed and extracted by the air chilling and condensate removal system (78). Air movement created by the fan (185) of system (79) moves air through filtration media, effectively removing airborne particulates. The air is captured from the process chamber (200) by an air hood (184) of the air filtration system (81), where it is filtered and directed to the chilling system (78) to remove moisture before being returned to the fan (185) via ducting (194).

Alternatively, the heating system (80) may be configured as an air-cooling system, with the air movement system (79) circulating cooled air through the transportation zone and/or fluidization zone for heat-sensitive products. The air filtration system (81) captures airborne particulates, preventing contamination and maintaining a clean processing environment.

The fluid addition system (82) introduces specific fluids into the transportation zone and/or fluidization zone through a spray manifold (178). Fluids may be added before, during, or after EM energy, depending on processing needs. The computer system (76) regulates the volume and pressure of the fluid, ensuring even distribution across particles.

The EM applicator cooling system (83) is continuously monitored and adjusted by the computer system (76) to maintain the optimal temperature of the EM applicators (341, 343). Cooling fluid circulated through piping (347) and a manifold (346) dissipates heat from the EM applicators, preventing overheating and ensuring consistent performance.

The deagglomeration system (84) ensures particles remain fluidized and uniformly exposed to EM energy and airflow by breaking apart clumps. Rotating bars (173) strike particles to improve drying and heating efficiency. Direction arrow (169) shows the rotational direction of the deagglomeration system.

The EM treatment continues until the desired temperature, moisture level, biological, or chemical reaction is achieved. The frequency of the EM energy may be dithered, varied, or intermittently cycled on and off to achieve specific heating or reaction profiles. The computer system (76) dynamically adjusts the EM energy output of EM circuitry (38), primary systems (44, 46), and auxiliary systems (78, 79, 80, 81, 82, 83, 84), and other parameters in response to real-time data, optimizing the process.

Once treatment is complete, the discharge gate (246) of system (46) is opened, allowing the bulk volume of particles to exit (arrow 97) through an opening in the bottom of the semicylindrical sections (247) of the lower housing (222). After discharge, the actuator securely closes the door against a semicylindrical section (247) or seals positioned between the gate (246) and the housing sections (247). Activating the power transmission system (44) and mechanical movement system (43) before particles enter the process chamber (200) is optimal, as starting under load may require additional torque. The computer system (76) ensures all systems are properly shut down, preparing the reactor for the next cycle.

EM Reactor (70) represents an advanced embodiment of the EM Reactor system, combining electromagnetic and thermal systems to deliver tailored radio frequency and microwave electric and/or magnetic fields into the transportation zone and/or fluidized zone of a counter-rotating twin-shaft mixer. This ensures maximum energy coupling and uniform particle exposure for optimal treatment. With integrated auxiliary systems—including closed-loop airflow (79), air cooling and heating (78), fluid addition (82), deagglomeration (84), and advanced computer control (76)—Reactor (70) maintains precise environmental conditions and processing efficiency. Its modular EM applicator configurations and sensing capabilities provide versatility for diverse applications, including industrial drying, chemical reactions, and pathogen control, achieving precise energy delivery across various scales and processing needs.

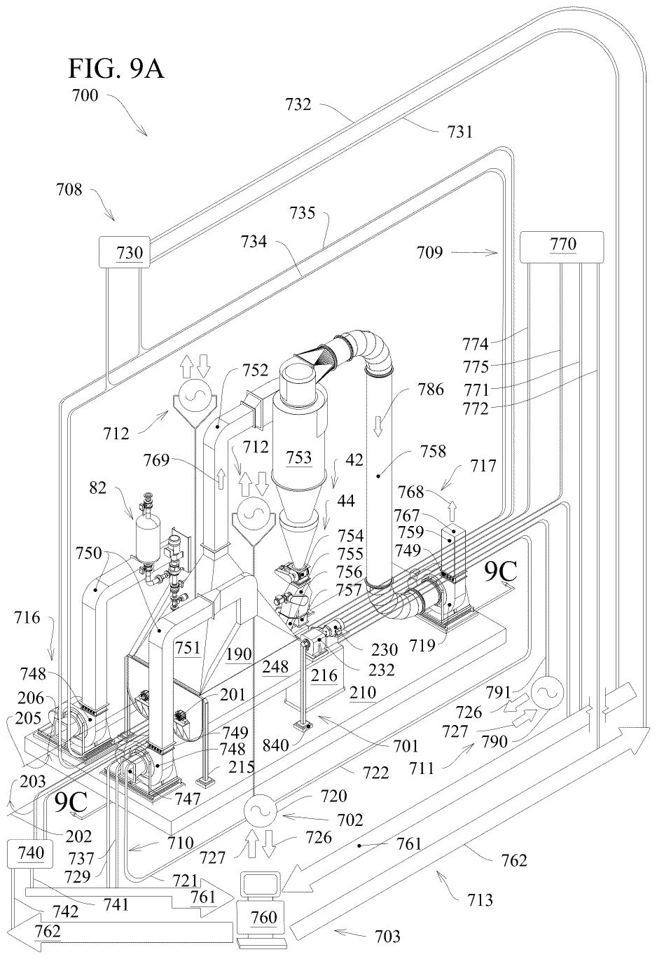

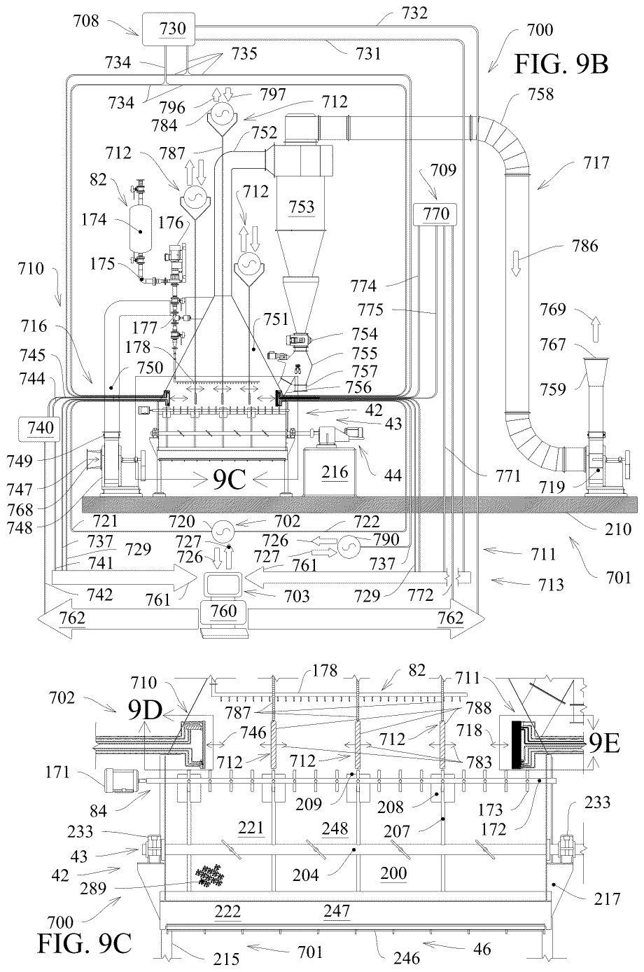

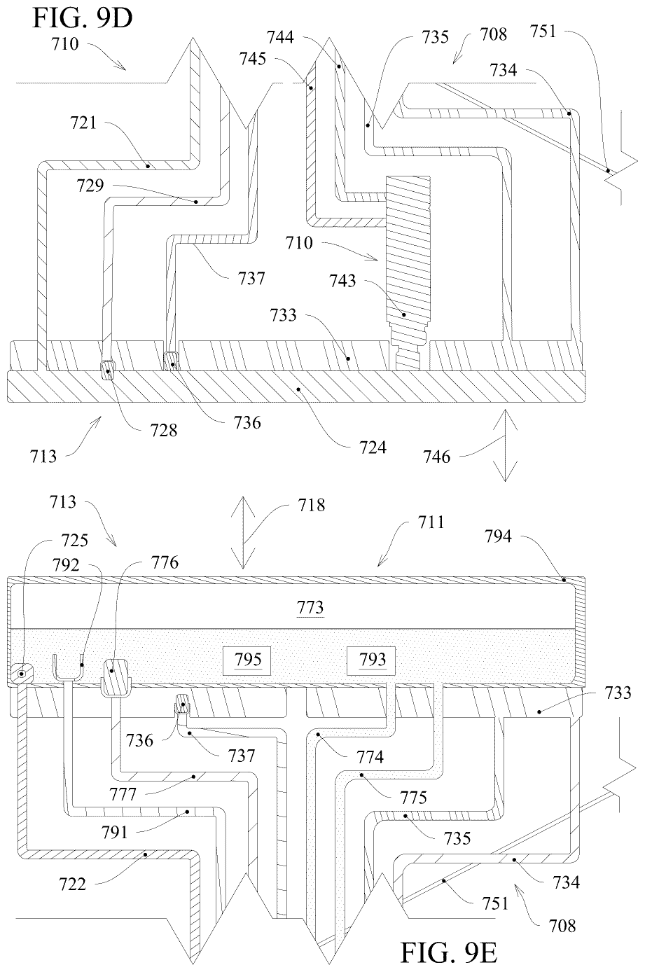

### Electromagnetic Reactor System 700 (FIGS. 9A-9E)

FIGS. 9A, 9B, 9C, 9D, and 9E provide a detailed example of an electromagnetic reactor (EM Reactor) (700) according to the invention. This reactor features a variable-frequency electromagnetic applicator system designed to radiate microwave and/or radio frequency (RF) electric and/or magnetic fields (EM energy) into the transportation zone and/or fluidized zone of a counter-rotating twin-shaft mixer. Reactor (700) is equipped with a computer system that controls the variable-frequency electromagnetic applicator, a sensing system, positive and negative air movement systems, an air heating system, an air filtration system, an air chilling and condensate removal system, a fluid addition system, a deagglomeration system, and an electromagnetic applicator cooling system.

FIG. 9A is an isometric view of the electromagnetic reactor (700), illustrating a variable-frequency EM applicator system (702), which comprises one or more of the three distinct embodiments of electromagnetic applicator (EM applicator) systems: (710, 711, 712). These systems generate EM energy with electromagnetic circuitry (EM circuitry) (signal generating) (720, 784, 790) and can function either as standalone EM circuitry units or in combination. The variable-frequency EM applicator system (702) is designed to adjust the distance between EM applicators (724, 788, 795) to correspond with the amplitude, frequency, and/or phase being transmitted, ensuring optimal impedance matching for variable-frequency signals.

FIG. 9B is a front elevation cross-sectional view of FIG. 9A, providing a clearer view of the internal components of EM Reactor (700). FIG. 9C is an enlarged cutaway view of FIG. 9B, focusing on the mechanical movement system (43), variable-frequency EM applicator systems (710, 711, 712), EM applicator cooling system (708), spray manifold (178) of the fluid addition system (82), and the deagglomeration system (84). FIG. 9D offers an enlarged cutaway view of FIG. 9C, highlighting the metallic EM applicator (724) of the EM applicator system (710), sensors (728, 736) of the sensing system (713), actuator (743) for the mechanical adjustment of the EM applicator (724), and coolant lines (734, 735) of the EM applicator cooling system (708). FIG. 9E presents an enlarged cutaway view of FIG. 9C, focusing on the plasma EM applicator (795) of the EM applicator system (711), along with sensors (736, 776) of the sensing system (713), plasma chamber gas (793), ionizer (792) of the EM applicator (ionizer electrode) system (711), coolant lines (734) and (735) of the EM applicator cooling system (708), and coupler (725) connected to the plasma EM applicator (795).

EM Reactor (700), as depicted in FIGS. 9A to 9E, includes a support structure system (701) positioned between the earth ground (210) and housing system (42). The housing system (42) defines the size and shape of the process chamber (200), which contains the bulk volume of particles. The reactor's mechanical movement system (43) is responsible for moving the bulk volume of particles and is partially mounted within housing system (42) and powered by the power transmission system (44). Housing system (42), mechanical movement system (43), power transmission system (44), and bottom gate discharge system (46) of reactor (700) are similar in structure and function to those previously described for EM Reactor (40). The transportation zone and fluidized zone have been previously described and referenced in earlier figures.

The support structure system (701) of reactor (700), as depicted in FIGS. 9A through 9C, provides stable structural support, ensuring proper alignment and reliable operation of reactor (700). This system includes a ground or earth (210) and support structures (215, 216) positioned between earth ground and housing system (42). These supports consist of any necessary structures and materials to maintain stability between housing system (42) and earth (210). An electrical standoff (840) is positioned between structure (215) and earth ground (210).

EM Reactor (700) includes a variable-frequency EM applicator system (702) that comprises at least one of EM applicator systems (710, 711), and optionally system (712), or a combination thereof. System (710), as depicted in FIG. 9D, includes a mechanically adjustable metallic EM applicator (724) on one end of the mixer. System (711), as depicted in FIG. 9E, employs ionization to form a plasma EM applicator (795) on the opposite end of the counter-rotating twin-shaft mixer.

Positioned between systems (710, 711), one or more additional EM applicator systems (712) may optionally be included, each configured with appropriate amplitude, frequency, phase, and/or power to ensure optimal energy transmission and distribution. The EM applicator (788) of system (712) is typically located between EM applicators (724, 795) of systems (710, 711), with its initial phase set relative to the spacing of the EM applicators (724, 795) and operating frequency. Additional embodiments of system (712) can be strategically positioned between EM applicators (724, 795), with phase and location adjustments made as frequency changes to efficiently deliver energy into the electric and/or magnetic fields.

The fluid addition system (82) of reactor (700), as depicted in FIGS. 9A through 9C, is designed to ensure precise and uniform distribution of liquids or fluids onto particles within the transportation zone and/or fluidized zone. The fluid addition system (82) comprises a fluid storage container (174), a fluid pump (176), piping (175), fluid controls (177), and a spray manifold (178) engineered to evenly disperse liquids or fluids onto the particles. Fluids can be added before, during, or after the application of EM energy to the transportation zone and/or fluidized zone of the counter-rotating twin-shaft mixer. The fluid is transported from the storage container (174) through piping (175) by the fluid pump (176) and is evenly distributed onto the particles by the spray manifold (178).

The deagglomeration system (84) of reactor (700), as depicted in FIGS. 9B and 9C, is designed to break apart particulate matter forming lumps or agglomerates, or to impact particles while EM applicators (710, 711, 712) radiate EM energy into the transportation zone and/or fluidized zone. This system (84) includes a motor (171) that provides rotational (arrow 169) mechanical energy to a shaft (172), positioned directly above the transportation zone and/or fluidized zone and equipped with extended bars (173). These bars (173) impact particles within the transportation zone and/or fluidized zone, effectively breaking up agglomerates. The deagglomeration system (84) not only aids in disintegrating clumps of material but also enhances the efficiency of thermal convection or EM radiant drying. As the spinning bars (173) strike the particles, they are propelled sideways, increasing their exposure time to the heated airflow and/or radiated energy, thereby improving the overall drying effectiveness. Rotational direction of system (84) is shown in a previous figure (FIG. 8A).

The computer system (703) in reactor (700), depicted in FIGS. 9A and 9B, is designed to provide precise control and optimization of the variable-frequency EM applicator system (702), including EM applicator subsystems (710, 711, 712), as well as other operational components within the reactor. The computer system (703) includes one or more computers (760) with an input bus (761) and an output bus (762). The computer (760) stores property measurements, determines relationships, and generates control signals to systems such as the EM circuitry of the EM applicator system (702) or the power transmission system (44). This enables reactor (700) to control temperature, heating rate, or the rate of biological or chemical reactions in response to stored relationships, pre-programmed algorithms, or recently sensed data signals. The computer system (703) communicates with the sensor system (713) or follows a preprogrammed algorithm to generate outputs, controlling various reactor components, including systems (43, 44, 46, 84, 702, 708, 709, 710, 711, 712, 716, 717).

The EM applicator cooling system (708) of reactor (700), as depicted in FIGS. 9A, 9B, 9D, and 9E, is designed to manage and reduce EM applicator heat, dynamically adjusting the coolant flow based on sensor input to maintain optimal operating temperatures. The system includes mechanical equipment and a controller (730), coolant fluid circuits (731, 732), a heat exchanger (733), and coolant lines (734, 735).

The gas system (709) of reactor (700), as depicted in FIGS. 9A, 9B, and 9E, comprises mechanical equipment and a controller (770), gas circuits (771, 772), a plasma chamber (793), and gas lines (774, 775). This system supplies gas to the plasma chamber (793) and adjusts the electron density based on sensor input to fine-tune the plasma EM applicator (795) and/or control the plasma depth in correlation with the radiated frequency.

The EM applicator system (710) is mechanically adjustable, while system (711) employs ionization to form a plasma EM applicator (795). The intermediate system (712) can be either manually or dynamically adjusted and operates in synchronization with the EM applicator (724) of mechanical system (710) and plasma EM applicator (795) of system (711). Together, these three systems (710, 711, 712) work to provide an optimized balance between frequency, phase, and EM applicator location to ensure uniform and efficient EM energy distribution across the transportation zone and/or fluidized zone. These EM applicator systems (710, 711, 712) operate in coordination with the mechanical movement system (43) and power transmission system (44) to enhance the uniformity of particle exposure to the EM energy.

The purpose of the EM applicator system (702) in reactor (700), as depicted in FIGS. 9A through 9E, is to efficiently radiate microwave or radio-frequency energy into the transportation zone and/or fluidized zone, with the capability to vary the frequency of the emitted EM energy. This is achieved by adjusting both the frequency, phase and the distance between EM applicators (724, 795) and any intermediate EM applicators (788), ensuring more uniform exposure of particles within the transportation zone and/or fluidization zone in process chamber (200).

The variable-frequency EM applicator system (702) includes at least one EM circuitry (microwave or RF signal generating) (720), which is connected to system (710) via a forward EM circuit (721) leading to the metallic EM applicator (724), and connected to system (711) via a reverse EM circuit (722) leading to the plasma EM applicator (795). The plasma EM applicator (795), when energized by the EM circuitry (720) and operating in coordination with the microwave or RF signals radiated from EM applicator (724) and any intermediate EM applicators (788), transmits the frequency signal into the transportation zone and/or fluidized zone of the process chamber (200).

The purpose of the EM applicator (ionizer) subsystem 711 of the variable-frequency EM applicator system (702) in the EM Reactor (700) as depicted in FIGS. 9A, 9B, 9C, and 9E, is to generate, form, and control the plasma EM applicator (795), enabling efficient transmission of EM energy into the transportation zone and/or fluidized zone. The EM applicator (ionizer) system (711) includes EM circuitry (ionizer) (790), EM circuit (791), and EM applicator (electrodes) (792) for igniting the gas (795) in the plasma chamber (773), thereby forming the plasma EM applicator (795). The plasma EM applicator (795) transmits the frequency of the plasma into the transportation zone and/or fluidized zone of the process chamber (200). This ionizer circuitry system (711) can adjust its power, phase, amplitude, or frequency to modify the depth (indicated by arrow (718)) of the ionized gas (795) within the plasma chamber (793), aligning with either a quarter, half, or simple multiple of the wavelength, thereby supporting variable-frequency EM signals. A system (not illustrated) can regulate the pressure and/or gas concentration to further enhance plasma control.

The variable-frequency EM applicator subsystem 712 of the variable-frequency EM applicator system (702) in the EM Reactor (700), as depicted in FIGS. 9A through 9C, is designed to enhance the EM field by introducing additional energy and adjusting the positions of intermediate EM applicators (788). This adjustment enables the system to optimize the distance between EM applicators and vary the frequency by controlling both phase and spacing, thereby maximizing energy coupling efficiency. This capability is particularly beneficial when the dielectric properties of the product change with temperature or exhibit high absorption characteristics. The variable-frequency EM applicator system (712) includes at least one EM circuitry (signal generator) (784), connected via an EM circuit (787) to the EM applicator (788). When the EM applicator (788) is coupled with a microwave or RF signal emitted by EM applicators (724) and/or (795), and/or additional intermediate EM applicators (788) phased differently, it transmits the frequency signal into the transportation zone and/or fluidized zone of the process chamber (200).

The EM circuitry (microwave/RF signal generating) (784) of subsystem (712) in variable frequency EM applicator (702) in EM Reactor (700) may include various components such as a microwave or RF signal generator, multi-frequency synthesizer, RF signal output control, wave generator, RF generator with silicon carbide (SiC) transistors, power amplifier, broadband power amplifier, directional coupler, impedance matching system, power supply, power meter, oscillator, inverter, pulse synthesizer, transformer, low-to-high frequency converter, or RF tuning circuitry. This EM circuitry (784) can dynamically adjust its power, amplitude, phase, or frequency, aligning with either a quarter or half wavelength, or simple multiple, to support variable-frequency RF signals.

The sensor system (713) of reactor (700), as depicted in FIGS. 9A, 9B, 9D, and 9E, is designed to measure a wide range of properties at one or more locations within the reactor and transmit the data to the computer system (703) for analysis and control. Sensor system (713) includes sensors (728, 736, 776), which are often connected to at least one computer (760) via input bus (761). The system may also include one or more sensors (728) located on or near the metallic EM applicator (724), connected via EM circuit (729), as well as sensors (736) positioned on or near the heat exchanger (733) of the metallic EM applicator (724) within the coolant system (708). Additionally, sensors (736, 776) are positioned on or near the plasma EM applicator (795) and are connected via circuits (737, 777) to the input bus (761). These sensors measure a comprehensive range of parameters, including temperature, RF characteristics, dielectric properties, resonance frequency, pressure, electrical conductivity, voltage, current, electrical permittivity, magnetic permeability, electric field intensity, magnetic field intensity, magnetic flux density, infrared radiation, electron density, chemical composition, moisture content, pH level, particle size distribution, optical properties, thermal conductivity, magnetic susceptibility, viscosity, electrostatic charge, and/or ion concentration.

The positive air/gas system (716) of reactor (700), as depicted in FIGS. 9A and 9B, introduces air or gas into the reactor through an intake (747) (arrow (768)), where it enters a fan (748). The fan (748) propels the air or gas under positive pressure through a louver (749), which regulates the airflow into duct (750) and then into baffled duct (190). The airflow is directed along both sides of the upper walls (221) of the upper half (248) of the mixer housing (42) and into the transportation zone and/or fluidized zone of the process chamber (200).

The negative air/gas system (717) of reactor (700), as depicted in FIGS. 9A and 9B, extracts air or gas from the process chamber (200) through a hood (751), then channels it via air duct (752) to a cyclone (753) for particulate separation. After the air or gas passes through the cyclone (753), it continues through duct (758) and is drawn by fan (719), following the direction of arrows (769, 786). The air or gas exits the system (717) at the duct discharge (767), as indicated by arrow (768). Particulate matter captured from the bulk volume within the air or gas stream is removed by the cyclone (753) and discharged through a rotary valve (754) into a two-way diverter valve (755). This valve can direct the particulate either back into the reactor (700) through spout (756) or out of the reactor through spout (757). The positive air system (716) and the negative air system (717) can function as standalone systems or be combined, as shown.

The EM Reactor system (700) described in FIG. 9C is capable of generating flameless heat by leveraging particles (289) within the process chamber (200) that exhibit a high dielectric constant relative to the transmitted EM frequency. These particles (289) effectively absorb EM energy, rapidly converting it into thermal energy. The heat generated is then efficiently transferred to the airflow of the positive (716) and negative air systems (717), providing a consistent source of flameless heat. This approach eliminates the need for traditional combustion, reducing emissions and simplifying safety considerations. By enabling the EM Reactor (700) to operate at elevated temperatures while maintaining precise control, this system is ideally suited for applications requiring superheated air or controlled high-temperature environments without a flame. The exact selection of particle materials (289) will depend on achieving the optimal balance of dielectric properties, thermal performance, and durability under operating conditions.

### Operation of the EM Reactor System 700 (FIGS. 9A-9E)

Effective operation of the Electromagnetic Reactor System (700), as shown in FIGS. 9A through 9E, requires a comprehensive understanding of the dielectric properties of particles within the transportation zone and/or fluidized zone. This system features variable-frequency electromagnetic applicators (710, 711, 712) that can adjust the position and length of both metallic and plasma-based electromagnetic applicators in real-time, optimizing the distance between dipoles to suit the transmitted frequency. Accurate data on dielectric properties—particularly frequency-dependent parameters such as conductivity, temperature, and permittivity—facilitates efficient energy coupling and uniform heating of the particle mass.

To precisely program and optimize electromagnetic reactor (EM Reactor) System (700), it is essential to conduct detailed dielectric property characterization tests. These tests should cover base elements, individual molecules, and complex compounds at 1-degree (or other predetermined interval) temperature increments across frozen, solid, liquid, and gas states. This level of characterization enables the reactor's control algorithms to fine-tune power, frequency, and energy distribution based on the material's specific dielectric response, maximizing processing efficiency while minimizing energy losses.

With dielectric properties as a guide, the variable-frequency applicator system (702) dynamically adjusts its frequency, phase, and the spatial relationship between electromagnetic applicators (EM applicators) to maintain optimal impedance matching and energy transfer. Power levels from the radio frequency and microwave sources are calibrated to excite the bulk volume in the process chamber (200) effectively. The reactor's design allows for real-time adjustments of the EM applicator's distance and phase to counteract any potential energy loss or uneven distribution. Together, the variable-frequency applicator, real-time adjustable EM applicator positioning, and robust auxiliary systems make EM Reactor System (700) highly adaptable for various materials and operational requirements, ensuring consistent and efficient processing outcomes.

To support precise EM application, EM Reactor System (700) integrates dual air systems (716, 717) and a fluid addition system (82) as auxiliary support. These systems provide heated or cooled airflow and enable moisture management and fluid introduction, enhancing control over processing conditions.

System Calibration: Begin by initializing the reactor's control system via the computer system (703). The system analyzes the dielectric properties of the bulk particles to select the optimal EM frequency for processing. Adjust the distance between EM applicators (724, 795) to ensure impedance matching with the selected frequency, thereby optimizing energy transfer efficiency.

Temperature and Flow Configuration: Set the desired temperature and airflow parameters using the air movement systems (716, 717). Activate the EM applicator cooling system (708) to maintain stable operating temperatures for EM applicators (724, 795) throughout the process.

Mechanical System Activation: The power transmission system (44) is activated to initiate the counter-rotation (203, 206) of shafts (201, 204) within the mechanical movement system (43). This rotation drives the support shafts (207) and their attached mixing paddles (208), generating a transportation zone and/or fluidized zone within the process chamber (200), where particles are suspended, agitated, and thoroughly mixed.

Material Preparation: Load the bulk volume of particles into the process chamber (200) through the designated inlet. If fluid addition is required, prime the fluid addition system (82) to introduce fluids at the appropriate stage during operation.

Electromagnetic Energy Application: Engage the EM circuitry (signal generating) (720, 784, 790) in systems (702, 711, 712). The generated RF signals are transmitted through circuits (721, 722, 787, 791) to EM applicators (724, 795, 788). If utilizing the plasma EM applicator (795), the ionizer system (711) ignites the plasma by ionizing gas supplied by the process gas system (709) within the plasma chamber (793). This plasma EM applicator (795) radiates the RF signal into the fluidized zone and/or transportation zone. These EM applicator systems operate in coordination with the rotation of the mechanical movement system to enhance the uniformity of particle exposure to the EM energy. The computer system (703) continuously monitors real-time sensor data from the sensing system (713), dynamically adjusting power, frequency, phase, EM applicator (metallic) location, and/or formed plasma depth as necessary to maintain optimal frequency and impedance matching.

Material Processing: As the mechanical movement system (43) mixes particles within the fluidized zone and/or transportation zone, the applied EM energy heats the particles through molecular oscillation and dielectric heating. If fluid addition is required, activate the fluid addition system (82) to disperse fluids through the spray manifold (178) onto the particles in the transportation and/or fluidized zone, coordinating this with the EM energy application. The deagglomeration system (84) may be engaged to break apart agglomerated particles, ensuring uniform exposure to the EM energy.

Management and Thermal Regulation: The positive air/gas system (716) introduces air into the fluidized zone and/or transportation zone, while the negative air/gas system (717) extracts air, facilitating moisture and heat removal from the process chamber (200). Airborne particles are captured by the air filtration system (81) and separated in the cyclone (753). The particulate matter can either be returned to the reactor or removed from the system.

Monitoring and Control: The computer system (703) continuously receives data from the sensing system (713), allowing for real-time adjustments to RF signal power, frequency, EM applicator (710, 711, 712) positioning, airflow systems (716, 717), auxiliary systems (82, 84), and other parameters. This ensures that the reactor operates under optimal conditions, achieving the desired processing outcomes.

Completion and Material Discharge: The EM treatment continues until the desired temperature, biological, or chemical reaction is achieved. In some embodiments, the frequency of the EM energy delivered is dithered, varied, or presented at multiple frequencies during the heating or reaction process (or intermittently cycled on and off) to achieve a desired heating or reaction profile. After processing, the bulk volume of particles exits the reactor (700) (arrow 97) through a gate door (246), discharging through the opening at the bottom of the semicylindrical sections (247) of the bottom half (222) of the housing system (42). Once the process chamber (200) has discharged its contents, the actuator closes the gate (246) securely, either against the semicylindrical sections (247) or against seals positioned between the gate (246) and the housing sections (247).

EM Reactor (700) exemplifies the advanced capabilities and versatility of the EM Reactor system, delivering precise, variable-frequency RF and microwave energy within a counter-rotating twin-shaft fluidized mixer. The EM applicator system (702), comprising subsystems (710, 711, 712), works in concert to optimize energy coupling by dynamically adjusting EM applicator positioning, frequency, and phase. This configuration ensures effective control over the uniform distribution of EM fields across the transportation and/or fluidized zone. A computer system, integrated with real-time sensors, continuously monitors and adjusts operational parameters to maintain optimal processing conditions for heating, chemical reactions, and moisture removal.

Additional features of EM Reactor (700) include the positive and negative air/gas systems (716, 717), providing tailored airflow and particulate management through mechanisms like cyclones (753) and diverter valves (755). The fluid addition system (82) and deagglomeration system (84) further enhance processing, enabling uniform liquid distribution and effective particle separation during EM treatment.

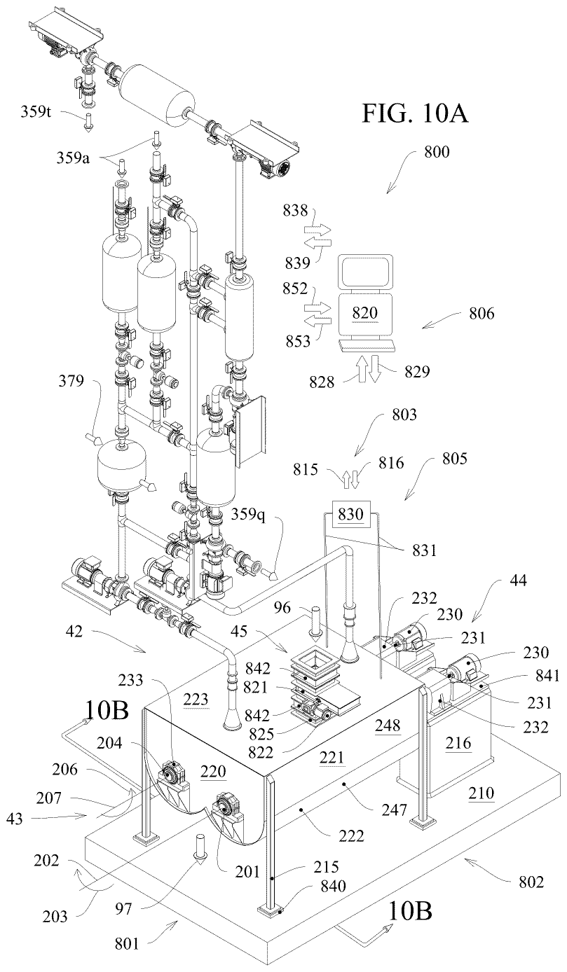

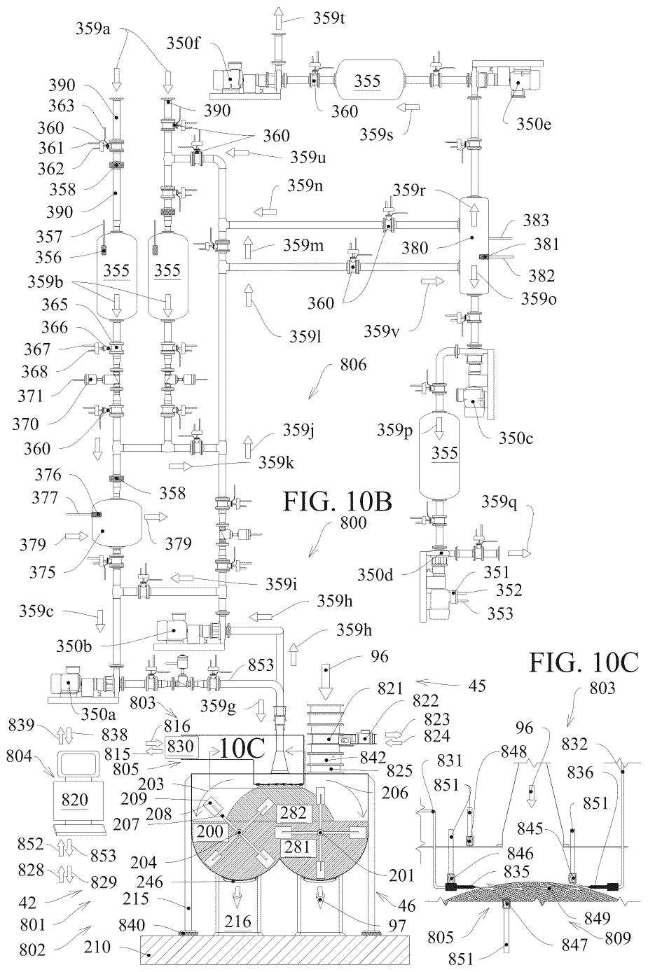

### Electromagnetic Reactor System 800 (FIGS. 10A-10C)

FIGS. 10A, 10B, and 10C illustrate an embodiment of the electromagnetic reactor (800), showcasing a Joule electromagnetic applicator system designed to flash arc energy into the transportation and/or fluidized zone of a counter-rotating twin-shaft mixer. The system includes a process fluid system that supplies gas or liquid into the process chamber to facilitate the flow of electromagnetic energy, promote heating, biological and/or chemical reactions, or form a plasma. An electrical isolation system, integrated as a subsystem of the support structure system, ensures isolation of the housing system, power transmission system, and electromagnetic applicator system from ground. The reactor also features a computer system responsible for controlling the Joule electromagnetic applicator, power transmission system, and the process fluid system, ensuring precise operation and optimal conditions within the reactor.

FIG. 10A is an isometric view of the electromagnetic reactor (EM Reactor) (800), which can incorporate various embodiments, including a Joule electromagnetic applicator (EM applicator) (803). Alternatively, the process chamber (200) can be filled with an ionizable gas and energized into a plasma using an EM applicator system (805), which may be similar to or different from the Joule EM applicator (803). Additionally, the reactor (800) integrates auxiliary systems such as an electrical isolation system (802) and a process fluid system (806) that manages the fluid environment and adjusts conditions within the process chamber (200). These systems are coordinated by a computer system (804), ensuring precise control over the reactor's operations.

FIG. 10B is a front elevational cross-sectional view of FIG. 10A, providing a clearer view of the internal components of the EM Reactor (800) and the process fluid system (806). FIG. 10C is an enlarged cutaway view focusing on the EM applicators (Joule electrodes) (835, 836) of the EM applicator systems (803, 805).

The EM Reactor (800), as illustrated in FIGS. 10A through 10C, includes a support structure system (801), positioned between the ground (210) and the housing system (42), electrical isolation system (802), mechanical movement system (43), power transmission system (44), and EM applicator systems (803, 805). The reactor is equipped with two types of EM applicator systems: a Joule flash arc system (803), which radiates energy into the transportation zone (281) and/or fluidized zone (282) of the process chamber (200), and an EM system (805), which provides ionization to form a plasma within the transportation zone (281) and/or fluidized zone (282) and process chamber (200). The electrical isolation system (802) electrically isolates various systems from ground (210). The housing system (42), mechanical movement system (43), power transmission system (44), and discharge system (46) have been described in detail earlier in this application. FIG. 10A illustrates a cover lid (223), which is omitted in previous figures to better highlight the internal features.

The EM Reactor also includes a computer system (804), which controls the Joule EM applicator system (803) and the ionizer circuitry system (805), as well as the process fluid system (806), inlet gate system (45), and discharge gate system (46). The process fluid system (806) supplies gas or liquid into the process chamber (200) to facilitate EM energy flow and adjusts the environmental conditions within the chamber (200). The inlet gate system (45) regulates the flow of materials into the process chamber, while the discharge gate system (46) controls the flow of materials out. A sensing system (809) is incorporated to measure various properties at one or more locations and transmit this data to the computer system (804) for real-time monitoring and control.

The support structure system (801) of reactor (800), as depicted in FIGS. 10A and 10B, is designed to provide stable structural support, ensuring proper alignment and reliable operation of the reactor. This system includes a ground or earth (210) and support structures (215, 216) positioned between the earth ground and the housing system (42). These supports consist of any necessary structures and materials to maintain stability between the housing system (42) and the earth (210). The support structure system (801) integrates as a subsystem an electrical isolation system (802).

The electrical isolation system (802) of reactor (800), as shown in FIGS. 10A and 10B, is integrated as a subsystem of the support structure system (801). It ensures the electrical isolation of the housing system (42), power transmission system (44), and EM applicator systems (803, 805) from earth ground (210) and other auxiliary systems. An electrical standoff (840) is positioned between structure (215) and earth ground (210). Additionally, an electrical standoff (841) is located between motor (230) or gear reducer (232) and structure (216) or earth ground (210). Another electrical standoff (842) is positioned between the housing system (42) and the incoming gate (821).

The purpose of the Joule EM applicator system (803) in reactor (800), as depicted in FIGS. 10A through 10C, is to efficiently deliver flash arc EM energy into the transportation (281) and/or fluidized zone (282). This system comprises at least one EM circuitry (high-voltage pulses) (830), with a forward EM circuit (831) connected to EM applicator (electrode) (835) and a reverse EM circuit (832) connected to EM applicator (electrode) (836) in a dipole configuration. The Joule applicator system (803) uses high-voltage electrical pulses to create a flash arc between the EM applicators (Joule electrodes) (835, 836), allowing for rapid heating of the particles within the transportation zone (281) and/or fluidized zone (282). This EM applicator system (803) operates in coordination with the mechanical movement system (43) to enhance the uniformity of particle exposure to the EM energy.

The computer system (804) in reactor (800), as depicted in FIGS. 10A and 10B, is designed for precise control and optimization of the EM energy applicator systems and other operational components within the reactor. The computer system includes one or more computers (820), which are connected with multiple input buses (815, 823, 828, 838, 852) and output buses (816, 824, 829, 839, 853), or combinations thereof. The computer (820) stores property measurements, analyzes data, and determines relationships to generate control signals for systems such as the EM energy applicator systems (803, 805), fluid addition system (806) or the power system (44). These signals regulate the reactor's operating parameters, including, but not limited to, temperature, heating rate, biological or chemical reaction rate, and moisture content based on stored relationships, preprogrammed algorithms, or real-time sensor data. The computer system (804) communicates with the sensing system (809) and can autonomously execute predefined algorithms to manage various reactor components, including systems (44, 45, 46, 803, 805, 806).

The purpose of the ionizer circuitry system (805) in reactor (800), as depicted in FIGS. 10A through 10C, is to generate and control a plasma within the transportation (281) and/or fluidized zone (282) and process chamber (200). The ionizer circuitry system (805) comprises EM circuitry (830) (typically microwave/RF signal generating, which may be distinct from that used in the Joule applicator system), EM circuits (831, 832), and EM applicators (electrodes) (835, 836), which are responsible for igniting the gas within the process chamber (200), thereby forming a plasma. This plasma transmits EM energy into the fluidized zone (282), facilitating enhanced energy transfer and particle interaction. The ionizer circuitry system (805) is designed to adjust its power output or frequency, allowing for fine control of the plasma's characteristics, such as ionization depth and energy density, to optimize processing conditions.

The process fluid system (806), as depicted in FIGS. 10A and 10B, comprises mechanical piping (390), valves (358, 360, 365), and sensors (351, 356, 366, 370, 376, 381). The process fluid system (806) is designed to receive fluid at point (359a), store it in at least one container (355), mix and condition it via heat exchanger (375), and pump (arrow 359c) it using pump (350a) into the (arrow 359g) process chamber (200). This system is capable of creating and maintaining vacuum, negative, or positive pressure within the process chamber (200). It can reclaim fluid (arrow 359h) from the process chamber (200), condition it through heat exchanger (375), and recycle it (arrow 359i) back. Alternatively, it can direct (arrows 359j, 359l, 359v) the fluid to storage or send it to separator (380) to be divided into at least two fractions. Each fraction can then be stored and pumped out of the system through points (359q, 359t). In another embodiment, the system (806) can supply cool or hot air or gas to the process chamber (200) via heat exchanger (375). Additionally, the system can provide the necessary gas and environment to form a plasma within the chamber (200). Input bus (838) transmits data signals (357) from gas storage sensor (356), data signals (361) from fluid flow control sensor (360), data signals (367) from pressure control sensor (366) in pressure valve (365), data signals (371) from fluid pressure control sensor (370), and/or data signals (377) from gas conditioner sensor (376) to computer system (804). Computer system (804) produces output control signals (362, 368, 378, 383) transmitted by output bus (839) to pump (350), flow control valve (360), and/or pressure control valve (365).

The Process Fluid System (806) of Reactor (800), depicted in FIGS. 10A and 10B, enables the EM Reactor to function as an efficient and controlled pyrolysis chamber. By precisely regulating the flow and composition of gases or liquids within the process chamber, the system can create the oxygen-deficient or inert environment required for pyrolysis. The system's pumps and valves allow for the introduction of process fluids, such as nitrogen or other inert gases, to displace oxygen, ensuring a controlled atmosphere for the thermal decomposition of organic materials. Unlike traditional pyrolysis systems that rely on convection or direct heating, the EM Reactor (800) uses EM energy to uniformly heat particles within the transportation zone (281) and/or fluidized zone (282) or process chamber (200). This method eliminates the need for high airflows and external heat sources, significantly improving energy efficiency and heat transfer to the material. The EM Reactor's (800) ability to precisely control energy delivery and chamber conditions results in enhanced reaction rates, reduced processing times, and consistent quality of pyrolyzed products. These benefits make the EM Reactor (800) an ideal platform for applications such as biochar production, waste-to-energy conversion, and advanced material synthesis, while minimizing energy consumption and emissions.

The sensing system (809) of Reactor (800), as depicted in FIGS. 10A, 10B, and 10C, is designed to monitor and measure a wide range of parameters at multiple locations associated with the EM Reactor (800), transmitting the collected data to the computer system (804) for real-time analysis and control. All sensors (845, 846, 847, 848), along with circuits (851), are typically (but not necessarily) connected to computer (820) via input bus (852). The sensing system (809) can measure a comprehensive range of parameters, including thermal properties such as temperature and thermal conductivity; electrical properties including radio-frequency characteristics, electrical conductivity, voltage, current, electrical permittivity, electric field intensity, and electrostatic charge; magnetic properties such as magnetic permeability, magnetic field intensity, magnetic flux density, and magnetic susceptibility; mechanical properties including pressure and viscosity; optical and radiation parameters such as infrared radiation and visible and/or invisible light; chemical properties including chemical composition, pH level, moisture content, and ion concentration; and physical properties such as particle size distribution, dielectric properties, resonance frequency, electron density, and optical properties.

The EM Reactor (800) may incorporate sensors located on or near EM applicators (835, 836), connected via EM circuit (851) (not illustrated), as well as sensors positioned on or near the housing system (42), mechanical movement system (43), power transmission system (44), and process fluid system (806). The gathered data enables real-time adjustments to reactor operation, ensuring precise control over the EM applicator systems (803, 805) and other reactor functions. This integration allows for dynamic optimization of heating processes, biological and chemical reactions, and overall reactor performance based on continuously monitored conditions.

Sensor (845) of sensing system (809) in EM Reactor (800), situated near the Joule flash arc, measures the EM energy radiated into the transportation (281) and/or fluidized zone (282), ensuring proper energy distribution for optimal process efficiency. Sensor (846) of sensing system (809) in EM Reactor (800), positioned on or near EM applicator (835), monitors its performance and ensures consistent energy delivery. Sensor (847) of sensing system (809) in EM Reactor (800), located in or near the process chamber (200), measures environmental conditions such as temperature, pressure, pH, and moisture levels within the chamber. Sensor (848) of sensing system (809) in EM Reactor (800), located outside the housing system (42), is designed to automatically shut down the reactor if electromagnetic energy levels detected outside the reactor exceed predefined safety thresholds.

### Operation of the EM Reactor System 800 (FIGS. 10A-10C)

To effectively operate the Electromagnetic Reactor System (800), as illustrated in FIGS. 10A through 10C, it is essential to understand the dielectric properties and the energy interaction behavior of the particles within the process chamber. The system employs Joule flash arc heating, where high-voltage pulses create rapid, high-energy arcs that interact directly with the bulk material. Detailed knowledge of the dielectric characteristics, particularly under varying frequencies and temperatures, supports the precise control required for effective arc heating, minimizing potential losses while ensuring even energy distribution across the bulk volume of particles cycling in-and-out of the fluidized zone and/or transportation zone.

EM Reactor System (800) advanced process fluid control further enhances this capability by allowing for precise regulation of the chamber's environment. This auxiliary system can introduce various gases or fluids to the chamber, which not only aids in controlling the reaction atmosphere but also supports plasma generation within the transportation (281) and/or fluidized zone (282) and/or process chamber (200). By adjusting environmental conditions—such as gas composition, pressure, and plasma density—the system creates a highly tunable processing environment, enabling the Joule flash arc to reach desired energy transfer rates and interaction effects on a range of materials.

System Initialization and Calibration: Begin by initializing the reactor's control system via the computer system (804). Ensure that the electrical isolation system (802) is properly engaged to isolate the housing system (42), mechanical system (43), power system (44), and EM applicator systems (803, 805) from ground, providing a safe operating environment. The computer system (804) analyzes the properties of the particulate materials and the desired processing conditions to select the optimal EM energy parameters.

Process Chamber Preparation: Use the process fluid system (806) to adjust the environmental conditions within the process chamber (200). Depending on the processing requirements, introduce the appropriate gas or liquid into the chamber to facilitate EM energy flow, promote chemical reactions, or prepare for plasma generation. The system can create vacuum, negative, or positive pressure conditions as needed.

Mechanical Mixing Activation: Activate the power transmission system (44) to initiate the mechanical movement system (43). The counter-rotation (203, 206) of the shafts (201, 204), support bars (207), and mixing (vanes) paddles (208) mixes the particles, creating a transportation zone (281) and/or a fluidized zone (282) within the process chamber (200). The zones (281, 282) ensures that the bulk volume of particles are uniformly exposed to EM energy.

Material Loading: Open the inlet gate system (45) to load the bulk volume of particulate materials into the process chamber (200). Ensure that the discharge gate (246) is closed.

Electromagnetic Energy Application with Joule Flash Arc System: Engage the Joule EM applicator system (803). The EM circuitry (830) delivers high-voltage electrical pulses through the forward EM circuit (831) to EM applicator (Joule electrode) (835) and the reverse EM circuit (832) to EM applicator (Joule electrode) (836), creating a flash arc across the transportation zone (281) and/or fluidized zone (282). This EM applicator system (803) operates in coordination with the mechanical movement system to enhance the uniformity of particle exposure to the EM energy. The computer system (804) monitors and adjusts the energy input to maintain the desired temperature and processing conditions.

Plasma Generation (Optional): If plasma processing is required, activate the ionizer circuitry system (805). Utilize the process fluid system (806) to introduce the necessary ionizable gas into the process chamber (200). The ionizer circuitry (830), through EM applicators (Joule electrode) (835, 836), ignites the gas to form a plasma within the transportation (281) and/or fluidized zone (282), or the entire process chamber (200). The plasma enhances energy transfer and promotes specific chemical reactions. The computer system (804) adjusts the plasma characteristics, such as ionization depth and energy density, by controlling the power output and frequency of the ionizer circuitry system (805). Many of the previous examples of EM applicators, such as the laser system (68) or RF applicator (71), can emit their signal(s) into the plasma formed in the transportation zone (281) and/or fluidized zone (282) and/or process chamber (200) to add energy and frequencies to all of the particles in contact with the formed plasma. EM applicator systems (803, 805) can be used standalone or combined with other EM applicator systems (47, 48, 51, 52, 53, 56, 57, 58, 61, 67, 68, 71, 89, 702, 710, 711, 712) to increase EM energy into a formed plasma in the zones (281, 282) or process chamber (200).

Process Monitoring and Control: Throughout the operation, the sensing system (809) continuously measures various parameters within the reactor, including temperature, pressure, moisture, chemical composition, dielectric properties, and EM field characteristics. This data is transmitted to the computer system (804) via input bus (852). The computer system analyzes the data in real-time and adjusts the operational parameters of the EM energy applicator systems (803, 805), mechanical movement system (43), and process fluid system (806) to maintain optimal processing conditions.

Material Processing: As the particles are mixed within the transportation (281) and/or fluidized zone (282) and exposed to the EM energy or plasma, they undergo the desired physical or chemical transformations. This could include heating, drying, biological or chemical reactions, or material modifications. The uniform exposure ensures consistent processing across all particles.

Environmental Control and Fluid Management: The process fluid system (806) manages the introduction and removal of gases or liquids from the process chamber (200). It can reclaim fluid from the chamber, condition it via heat exchanger (375), and recycle it back into the system. The system can also separate fluids into fractions using separator (380), allowing for efficient resource utilization and environmental control.

Completion of Processing: Once the desired processing conditions are achieved, as determined by the computer system (804) analyzing data from the sensing system (809), deactivate the EM energy applicator systems (803, 805).

Material Discharge: Open the discharge gate system (46) to allow the processed materials to exit the process chamber (200). Ensure that the discharge is controlled to prevent any sudden release of particles or gases. If necessary, the process fluid system (806) can adjust the chamber pressure to facilitate smooth discharge.

EM Reactor (800) exemplifies the advanced capabilities of the EM Reactor system, featuring a unique Joule EM applicator system that enables flash arc energy delivery into the transportation (281) and/or fluidized zone (282) of a counter-rotating twin-shaft mixer. This design allows for rapid heating and enhanced energy transfer, optimizing the processing of particles within the transportation (281) and/or fluidized zone (282). The reactor's ability to generate plasma using an alternative EM applicator system, coupled with a versatile process fluid system, provides flexibility in creating controlled gas or liquid environments to facilitate diverse heating, biological, or chemical reactions.

The EM Reactor's (800) computer system (804) precisely controls all primary systems (44, 45, 46, 803, 805) and subsystems, including the Joule applicator system (803), plasma formation, and process fluid management (82), using real-time data from a comprehensive sensing system (809). This setup ensures that each particle within the transportation (281) and/or fluidized zone (282) receives consistent energy exposure, enabling efficient and uniform processing. The EM Reactor (800) robust electrical isolation system and advanced control over vacuum, pressure, and fluid recirculation further enhance operational efficiency and safety, making it an ideal solution for high-precision applications across various industrial, biological, and chemical processing needs.

### Electromagnetic Reactor System 85 (FIGS. 11A-11C)

FIGS. 11A, 11B, and 11C provide a detailed example of an electromagnetic reactor (85), illustrating a specific embodiment of an electromagnetic applicator system. This system employs a permanent magnet to emit a magnetic field into the fluidized zone of a counter-rotating twin-shaft mixer. Additionally, electromagnetic reactor (85) features an integrated optical sensing system for enhanced monitoring and control.

FIG. 11A is an isometric view of the electromagnetic reactor (EM Reactor) system (85), showing a cover lid (223) and an outer sidewall (upper half) section (225) of the upper half (248) of the housing system (86), featuring an inwardly curved section. FIG. 11B illustrates an electromagnetic applicator (EM applicator) system (89), which radiates a magnetic field between two counter-rotating shafts (211, 271) with support bars (226) attached to mixing vanes (214, 219, 227, 228). The cover lid (223) and outer sidewall section (225) of the upper half (248) are omitted for clarity, providing an unobstructed view of the internal components. The front elevation cut view in FIG. 11C shows the positioning of the electromagnetic applicator (236) and optical sensor (243) above and between the two shafts (211, 271), along with mixing vanes (214, 219, 227, 228).

The EM Reactor (85) includes a ground and support structure system (41) to provide stable structural support for the housing, mechanical, and power systems; a housing system (86) to define and enclose the process chamber (238); a mechanical movement system (87) for moving a volume of flowable or semi-flowable particles; a power transmission system (88) to provide rotational movement (213, 273) to the mechanical movement system (87); a bottom gate discharge system (46) for releasing materials from the process chamber; an optical sensing system (98) for particle characterization; a computer system (99) that receives sensing data (815) from the optical sensor and sends control signals (816) to operate the reactor (85); and an EM applicator system (89), designed to radiate a magnetic field between two counter-rotating shafts (211, 271) equipped with mixing vanes (214, 219, 227, 228). This configuration enables effective EM energy without requiring a fluidized zone or overlapping vanes, illustrating that emitting EM energy in the bulk volume of particles moving back-and-forth between two shafts (211, 271), even without perfect fluidization, significantly improves exposure over single-shaft mixers by targeting particle movement in the inter-shaft region, previously referred to as the transportation zone (281).

The support structure system (41) of reactor (85), as illustrated in FIGS. 11A through 11C, is designed to provide stable structural support that ensures proper alignment and reliable operation of the reactor. This system comprises a ground or earth (210), along with support structures (215) positioned between the earth ground and the housing system (86) as well as the power transmission system (88). Supports (215) may include any suitable materials and structural configurations necessary to maintain stability between the housing system (86) and the earth (210). Additionally, this system can be configured to electrically isolate the reactor from the ground (210) when isolation is required for optimal functionality.

The housing system (86) of reactor (85), as shown in FIGS. 11A through 11C, is designed to contain and protect internal components while facilitating controlled movement and processing of materials within the reactor. This system includes a bottom section (222) comprising two rounded-bottom semicylindrical sections (247) or troughs, shaped to align with the path of the outer mixing vane (ribbon) tips (239), creating a W-shaped trough. The top section (248) comprises outer walls (225) adjoining each semicylindrical section (247) of the bottom half (222), which may be configured as either vertical or rounded walls; in this example, they are rounded. In FIGS. 11B and 11C, the inlet opening (229), outer walls (225), and cover lid (223) are omitted to provide a clearer view of the internal systems, though they are displayed in a subsequent figure. The housing system (86) also includes end plates (224) positioned at each end of the housing sections (222, 248), fully enclosing the process chamber (237). Additionally, the end plates (224) can support externally mounted bearings (233) via integrated supports (217).

The purpose of the mechanical movement system (87) in reactor (85), as illustrated in FIGS. 11A through 11C, is to transform a non-uniform bulk volume of particles into a uniform mixture. This system comprises two counter-rotating shafts (211, 271), each equipped with mixing vanes (214, 219, 227, 228), which are connected via support arms (226). The shafts are mounted on bearings (233) and connected to the power transmission system (88) through couplings, allowing them to rotate about their lengthwise axes (212, 272) within the semicylindrical section (247) of the bottom half (222) of the housing system (86), specifically in the lower portion of the housing. Positioned near the inner surface of the semicylindrical sections (247), the outer periphery (239) of the mixing vanes (219, 228) is designed to optimize efficient mixing by facing the process chamber (237).

The mixing vanes (214, 219, 227, 228) are angled relative to the axial dimension of the housing to promote movement, agitation, and uniform mixing within the chamber. Typically, the ribbon mixing vanes are arranged in left-hand and right-hand spiral pairs. This configuration enables the outer ribbon mixing vanes (219, 228) to move the product laterally across the chamber while also propelling it forward, whereas the inner ribbon mixing vanes (214, 227) direct the product in the opposite direction along the center of their ribbon vanes. Together, these coordinated actions establish continuous and efficient material movement within the process chamber (237).

The shafts (211, 271) rotate in opposite directions—shaft (211) rotates clockwise (CW) while shaft (271) rotates counterclockwise (CCW) around their respective axes (212, 272). This counter-rotation directs the outer mixing vanes (219, 228) downward along the outer walls (247) of the lower housing (222) and, to a lesser extent, along the upper wall (225). As a result, the outer mixing vanes (219, 228) effectively transport particles between the two shafts (211, 271) or troughs (247), establishing and maintaining a transportation zone that is optimally positioned for the application of EM energy.

The power transmission system (88) of reactor (85), as depicted in FIGS. 11A through 11C, drives the rotational movement of the mechanical movement system (87). This system includes a motor (235) directly integrated with either shaft (211 or 271), allowing precise control of rotational speed. FIG. 11B shows the rotational directions of the shafts, with arrow (273) indicating clockwise rotation of the right shaft (271) and counterclockwise rotation of the left shaft (211) within the mechanical movement system (87). Mounted on bearings (233), the shafts (211, 271) rotate under the power transmission system (88), generating movement that promotes near-uniform particle distribution within the process chamber (238).

Although an electric motor is depicted and described, the motor could be any device capable of providing rotational power to the shafts. This may include, but is not limited to, pneumatic or hydraulic motors, or any other suitable power source designed to achieve the desired rotational effect.

The purpose of the bottom gate discharge system (46) of reactor (85), as depicted in FIG. 11C, is to enable the controlled release of the bulk volume of particles from the process chamber (238). This system includes a gate door (246) that, when opened, allows the discharge (arrow 97) of product through an opening at the bottom of the semicylindrical sections (247) of the bottom half (222) of the housing system (86). Although not shown, the discharge system (46) typically incorporates an actuator system for opening and closing the gate door. This actuator is generally powered by air or electricity and can be activated by a computer system for automated control.

The purpose of the electromagnetic applicator (EM applicator) system (89) of reactor (85), as depicted in FIGS. 11A through 11C, is to efficiently radiate EM energy (magnetic field) into the area between the two shafts (211, 271) with mixing vanes (214, 219, 227, 228), ensuring uniform exposure of particles within the process chamber (237). This EM applicator system works in synchronization with the rotation of the mechanical movement system (87) to enhance the uniformity of particle exposure to the EM energy. The EM applicator system (89) accomplishes this by utilizing a permanent magnet (236), such as a powerful rare-earth magnet, to emit magnetic fields into the fluidized zone, as described for previous reactors in this application, or specifically between the two shafts (211, 271) with mixing vanes (214, 219, 227, 228), known as the transportation zone, as shown in this embodiment.

In this embodiment, the permanent magnet (236) of the EM Reactor (800) is strategically positioned above the transportation zone. In other embodiments, the permanent magnet (236) will be strategically positioned above a fluidization zone. In both instances the magnetic field continuously interacts with the bulk volume of particles as they cycle through one or both zones within the process chamber (237). Unlike conventional metal object magnetic removal systems that rely on single-pass separation, this batch mixer design enables repeated exposure to the magnetic field within minutes, significantly enhancing the removal efficiency of ferrous contaminants, including minute metal fragments and slivers often missed by traditional methods.

Using high-strength rare-earth magnets (236), the system can also optimize the separation of materials with low magnetic properties, such as high-intensity fields or inducing eddy currents. The EM Reactor (800) enhances the magnetic response of these materials, broadening the range of contaminates that can be effectively captured. The turbulent motion within the transportation zone (and fluidization zone) ensures mixing and redistribution of particles, maximizing their contact with the magnetic field. This feature is particularly advantageous for fine, cohesive materials like sugar or flour, where traditional techniques struggle to achieve consistent contaminant removal. The system's unique design not only ensures cleaner processing but also supports a safer and more versatile operating environment.

The integration of RGB, near-infrared (NIR), and hyperspectral cameras (243) of the optical sensing system (98) within the EM Reactor system (85), as depicted in FIGS. 11B and 11C, unlocks a wide range of possibilities for real-time analysis and control of particles within the process chamber (237). These advanced imaging technologies, in combination with multi-spectral light sources capable of inducing fluorescence, provide unparalleled capabilities for detecting pathogens, contaminants, material compositions, and monitoring chemical reactions. RGB cameras capture high-resolution color information, which is instrumental in identifying discoloration, surface defects, pathogens, or changes in appearance that may indicate contamination, spoilage, or reaction progress.

Near-infrared cameras extend detection capabilities beyond visible light, enabling the identification of materials based on their absorption and reflection properties within the NIR spectrum. This is particularly effective for detecting organic and inorganic compounds, moisture content, and structural variations within particles. Hyperspectral cameras offer even greater precision by capturing a full spectrum of data for each pixel, allowing the identification of specific chemical signatures, molecular compositions, and reaction intermediates. When paired with multi-spectral light shown in previous EM applicator systems, the reactor is capable of inducing fluorescence—the excitation of specific compounds to emit light at unique wavelengths, enhancing the detection of pathogens, toxins, or hazardous materials. This combination provides a robust, non-invasive method for real-time monitoring of particle characteristics, ensuring quality control, and optimizing EM energy efficiency.

The computer system (804) in reactor (85), as depicted in FIG. 11A, is designed for precise control and optimization of the EM energy applicator system and other operational components within the reactor. The computer system (804) includes one or more computers (240), which are connected with input bus (815) and output bus (816), or combinations thereof. The computer (240) stores property measurements, analyzes data, and determines relationships to generate control signals for systems such as the power system (88). These signals regulate the reactor's operating parameters, including, but not limited to, temperature, heating rate, biological or chemical reaction rate, and moisture content based on stored relationships, preprogrammed algorithms, or real-time sensor data. The computer system (804) communicates with the sensing system (809) and can autonomously execute predefined algorithms to manage various reactor components, including systems (46, 88, 98).

In the EM Reactor systems shown in this disclosure, overlapping of the mixing vanes is not essential for achieving effective particle processing. While the preferred embodiment features overlapping vanes that create a fluidized or near-weightless zone, the system's core functionality—near-uniform exposure of particles to EM energy—remains effective even without overlapping vanes or the preferred fluidized zone, provided that factors such as speed and particle size are properly accounted for. Configuring the mixing vanes without overlap or at different angles still promotes adequate particle movement and redistribution between the shafts, ensuring that each particle cycles through the EM energy field. This flexibility enables the system to accommodate various materials, mixer geometries, and processing requirements without compromising the uniformity of EM exposure. Additionally, locating the EM applicator to emit between two counter-rotating shafts offers significant advantages over a single-shaft design, as it ensures consistent energy exposure across a broader volume, thereby optimizing the reactor's performance.

### Operation of the EM Reactor System 85 (FIGS. 11A-11C)

To effectively operate the electromagnetic reactor system (85), as depicted in FIGS. 11A through 11C, a thorough understanding of the dielectric and magnetic properties of the bulk volume of particles is essential. This understanding informs key operational choices, such as the optimal speed of the mixing vanes (ribbon) (214, 219, 227, 228), which ensures proper mixing and transportation of material between the shafts (211, 271). Additionally, knowledge of these physical characteristics aids in selecting appropriately sized components, including motor (235) and bearings (233), to maintain both efficiency and durability of the system under varying load conditions.

The power transmission system (88) engages the mechanical movement system (87), causing shafts (211, 271) to rotate—shaft (271) in a clockwise direction (273) and shaft (211) in a counterclockwise direction (213)—around their respective rotational axes (212, 272). As the bulk volume of particles enters the process chamber (237) (arrow 96), the permanent magnet (236) exposes the product transported back and forth between the two mixing shafts (211, 271) to a magnetic field. This EM applicator (permanent magnet) (236) emits a magnetic field, producing a reactive field focused either on the fluidized zone, as in previous reactor designs, or, in this embodiment, within the space between the two counter-rotating shafts with mixing vanes, referred to as the transportation zone. This arrangement enhances the magnetic field's interaction with the particles, promoting uniform exposure.

EM Reactor (85) showcases the core advantages and capabilities of the EM Reactor system, adaptable as an apparatus, means, or method. This reactor is designed to precisely emit magnetic fields via one or more permanent or rare-earth magnets, strategically positioned between the mixing shafts to optimize magnetic field coupling and ensure uniform energy distribution. By containing EM signals within the process chamber (237), Reactor (85) provides safe, efficient, and near-uniform magnetic field exposure to all particles within the bulk volume. This configuration is engineered to process substantial volumes effectively, maintaining a uniform material state under optimal EM conditions. EM Reactor (85) fully exemplifies the operational efficiency and innovative design features that define the EM Reactor system.

While the foregoing description presents specific embodiments of the invention, it should be understood that the invention is not limited to these examples. Variations and modifications can be made without departing from the spirit and scope of the invention. For instance, the dipole systems shown along the fluidized zone and/or transportation zone may instead be configured in a perpendicular orientation to optimize energy distribution for specific materials or reactions. Such an arrangement may allow for enhanced EM coupling with smaller particle sizes. Plasma EM applicators may be nested to operate at different frequencies simultaneously, allowing the system to target multiple material properties or reactions. For example, one frequency band may be used for heating, while another is tuned to promote specific chemical reactions within the same bulk volume. In certain embodiments, the EM field applied to the fluidized zone may be dynamically modulated in response to real-time sensor data. This could include adjusting the field's phase, amplitude, or frequency to optimize energy transfer and process efficiency, particularly in applications involving chemical or biological reactions. Additionally, the EM Reactor may be adapted for various industrial applications such as waste treatment, high-efficiency drying, or material synthesis. For instance, in one embodiment, a plasma EM applicator could be used to achieve high-energy reactions for transforming waste into usable materials, while a secondary EM applicator focuses on driving moisture removal.

The various embodiments of the EM Reactor system described in this application are not limited to standalone configurations; they can be combined to create hybrid systems that integrate the advantages of multiple designs. For example, EM applicator systems from one embodiment may be paired with an EM applicator system, auxiliary systems or mechanical movement configurations from another embodiment to achieve enhanced functionality, efficiency, or adaptability. Such combinations allow for tailored solutions that address specific operational requirements or material characteristics, further expanding the versatility and applicability of the EM Reactor system.

The invention is intended to encompass a wide variety of embodiments and modifications, as understood by those skilled in the art. It is therefore intended that the appended claims be interpreted as covering all such variations, adaptations, and modifications that fall within the true scope of the invention. The invention may be implemented in various forms, including as a system, apparatus, method, or device, and all such variations should be understood as within the scope of the following claims and their equivalents.

1. An electromagnetic reactor for emitting electromagnetic energy into a bulk volume of particles, comprising:
a support structure system positioned between the ground and a housing system, configured to provide stable structural support for the reactor, wherein the support structure system maintains stability during operation;
a housing system comprising a bottom section with two adjoining semicylindrical sections forming a W-shaped configuration, a top section with outer walls adjoining the semicylindrical sections, end plates enclosing the top and bottom sections at both ends, an inlet in the top section for introducing a bulk volume of particles, and a discharge outlet in the bottom section for removing the bulk volume of particles, wherein the housing system defines a process chamber for containing, mixing, and exposing the bulk volume of particles to electromagnetic energy;
a process chamber comprising a transportation zone defined as the area between the counter-rotating shafts where the bulk volume of particles is redistributed by mechanical agitation, wherein the transportation zone facilitates the back-and-forth movement of the bulk volume of particles between the semicylindrical sections;
a mechanical movement system comprising two shafts, each centrally positioned within one semicylindrical section, each shaft equipped with mixing vanes configured to facilitate movement of the bulk volume of particles between the shafts, wherein the mechanical movement system provides counter-rotational movement of the shafts to redistribute the particles through the transportation zone;
a power transmission system comprising at least one motor coupled to at least one of the shafts, configured to provide counter-rotational movement to the mechanical movement system; and
an electromagnetic applicator system comprising at least one electromagnetic applicator configured to emit electromagnetic energy between 30 Hz and 30 PHz into the transportation zone, wherein the electromagnetic applicator system emits an electric field, magnetic field, infrared, invisible, visible, and/or ultraviolet electromagnetic energy into the transportation zone;
wherein the reactor integrates the support structure system, housing system, process chamber, mechanical movement system, power transmission system, and electromagnetic applicator system to uniformly expose the bulk volume of particles to electromagnetic energy in the transportation zone, facilitating heating, biological, or chemical reactions within the bulk volume of particles.

2. The electromagnetic reactor of claim 1, further comprising a process chamber including a fluidized zone positioned above the transportation zone, wherein particles achieve a near-weightless state due to mechanical agitation, and the electromagnetic applicator is configured to emit electromagnetic energy into the fluidized zone, exposing the bulk volume of particles as they cycle in and out of near-weightlessness.

3. The electromagnetic reactor of claim 1, further comprising an electrical standoff in the support structure and/or housing system configured to electrically isolate at least one electromagnetic applicator, wherein the electromagnetic applicator is electrically isolated from the process chamber housing and other components to prevent interference and ensure precise emission of electromagnetic energy into the transportation zone.

4. The electromagnetic reactor of claim 1, further comprising sensors configured to detect material properties within the process chamber and adjust the frequency, phase, amplitude, and/or power of the electromagnetic applicator, wherein the sensed information is utilized to optimize the delivery of electromagnetic energy into the the transportation zone.

5. The electromagnetic reactor of claim 1, further comprising one or more sensor positioned outside the housing system and configured to detect electromagnetic energy and/or environmental conditions, wherein the detected information facilitates adjustments to the frequency, phase, amplitude, and/or power source parameters of the electromagnetic applicator emitting energy into the transportation zone.

6. The electromagnetic reactor of claim 1, further comprising a computer system with artificial intelligence algorithms and an output bus operatively connected to the electromagnetic applicator system, power transmission system, and/or discharge system, wherein the artificial intelligence algorithms control the operation of the electromagnetic applicator system to emit electromagnetic energy into the transportation zone.

7. The electromagnetic reactor of claim 1, further comprising at least one electromagnetic applicator configured to emit electromagnetic energy within a frequency range of 30 Hz to 300 GHz into the transportation zone, wherein the emitted radio frequency or microwave electric and/or magnetic fields facilitate dielectric heating of a bulk volume of flowable or semi-flowable materials within the process chamber.

8. The electromagnetic reactor of claim 1, further comprising at least one electromagnetic applicator configured to emit electromagnetic energy within the infrared spectrum, corresponding to a frequency range between 300 GHz and 430 THz, into the transportation zone, wherein the emitted infrared energy facilitates targeted thermal processing of the bulk volume of flowable or semi-flowable materials within the process chamber.

9. The electromagnetic reactor of claim 1, further comprising at least one electromagnetic applicator configured to emit electromagnetic energy between 300 GHz and 30 PHz into the transportation zone, wherein the emitted energy includes frequencies within the visible, invisible, and/or ultraviolet light spectra for processing a bulk volume of flowable or semi-flowable particles within the transportation zone.

10. The electromagnetic reactor of claim 1, further comprising a fluid system configured to inject a gas or liquid into the transportation zone, wherein the fluid system is configured to interact with a bulk volume of flowable or semi-flowable particles within the transportation zone.

11. The electromagnetic reactor of claim 1, further comprising a variable frequency electromagnetic applicator constructed from metallic or plasma materials and configured to emit electromagnetic energy into the transportation zone, the distance between the electromagnetic applicator is adjustable, and the electromagnetic circuitry modifies the frequency, phase, and/or amplitude of the emitted energy, wherein by adjusting the distance between two or more electromagnetic applicators to correspond with the frequency, phase, and/or amplitude of the electromagnetic energy emitted into the transportation zone.

12. The electromagnetic reactor of claim 1, further comprising a vacuum system connected to the process chamber, wherein the vacuum system is configured to maintain a negative pressure within the bulk volume of flowable or semi-flowable materials in the process chamber.

13. The electromagnetic reactor of claim 1, further comprising a system configured to purge the process chamber of oxygen, wherein the system is configured to introduce a gas or create a vacuum to establish a pyrolysis chamber.

14. The electromagnetic reactor of claim 1, further comprising a Joule electromagnetic applicator configured to create flash arcs within the transportation zone, wherein the flash arcs rapidly heat the particles.

15. The electromagnetic reactor of claim 1, further comprising a plasma generation system configured to form plasma in the transportation zone, and at least one radio frequency or microwave electromagnetic applicator configured to couple electromagnetic energy into the plasma, wherein the plasma electromagnetic applicators emit electromagnetic energy through the formed plasma acting as an antenna.

16. The electromagnetic reactor of claim 1, further comprising a cooling system attached to or positioned near an electromagnetic applicator, the cooling system configured to regulate the temperature of the electromagnetic applicator, wherein the temperature of the electromagnetic applicator is maintained within a controlled range.

17. The electromagnetic reactor of claim 1, further comprising a permanent magnet or rare-earth magnet configured to emit a magnetic field into the transportation zone, wherein the magnetic field facilitates the processing of materials within the process chamber.

18. The electromagnetic reactor of claim 1, further comprising a radome material positioned between an electromagnetic applicator and the process chamber, wherein the radome material protects the electromagnetic applicator from the materials being processed within the process chamber.

19. The electromagnetic reactor of claim 1, further comprising at least one positive air system and/or a negative air system configured to circulate air or gas through the process chamber, the electromagnetic applicators emitting electromagnetic energy into particles within the process chamber having a high dielectric constant relative to the transmitted electromagnetic frequency, causing the particles to absorb the electromagnetic energy and convert it into thermal energy, wherein the generated thermal energy is transferred to the circulating air or gas to produce a source of flameless heat for applications requiring superheated air or controlled high-temperature environments.

20. The electromagnetic reactor of claim 1, further comprising a computer system configured to control the electromagnetic applicator system, the mechanical movement system, the power transmission system, and other operational components within the reactor, wherein the computer system adjusts the frequency, phase, and/or power level of the electromagnetic applicator system, as well as the power and/or speed of the power transmission system, to operate the electromagnetic reactor.

21. The electromagnetic reactor of claim 1, further comprising at least one high-gain antenna within the electromagnetic applicator system, wherein the high-gain antenna provides an isotropic gain of at least 5 dBi and emits electromagnetic energy in the frequency range of 300 MHz to 300 GHz into the transportation zone, enabling dielectric heating of the bulk volume of particles within the process chamber.

22. The electromagnetic reactor of claim 1, further comprising an air circulation system configured to regulate airflow within the process chamber, wherein the air circulation system includes at least one of the following: a positive air system configured to introduce air or gas into the process chamber to facilitate the control of temperature, moisture, or material flow; a negative air system configured to extract air or gas from the process chamber to remove heat, moisture, or particulates; or a combination of the positive air system and the negative air system, wherein the combined system maintains controlled airflow for temperature regulation, moisture removal, and particulate management, whereas the air circulation system ensures effective environmental control within the process chamber.
